(19) United States
(12) Patent Application Publication
(10) Pub. No.: US 2026/0225505 A1
(43) Pub. Date: Aug. 6, 2026

(54) LATCH AND ADJUSTMENT SYSTEM FOR INFANT CHILD SEATS

(71) Applicant: WONDERLAND SWITZERLAND AG, Steinhausen (CH)

(72) Inventors: Colin F. EGGERT-CROWE, Morgantown, PA (US); Samuel GEARHART, Morgantown, PA (US)

(21) Appl. No.: 19/150,656

(22) PCT Filed: Jan. 24, 2024
(86) PCT No.: PCT/US2024/012746

§ 371 Date: Jul. 24, 2025

Related U.S. Application Data
(60) Provisional application No. 63/481,889, filed on Jan. 27, 2023.
(60) Provisional application No. 63/489,282, filed on Mar. 9, 2023.
(60) Provisional application No. 63/508,552, filed on Jun. 16, 2023.
(60) Provisional application No. 63/511,037, filed on Jun. 29, 2023.
(60) Provisional application No. 63/586,147, filed on Sep. 28, 2023.

(51) Int. Cl. B60N 2/28

(52) U.S. Cl. CPC B60N 2/2845

(57) ABSTRACT

Infant car seat systems for installation on a vehicle seat include an infant car seat having a seat shell and an anchor system connected to the seat shell. The anchor system includes a latch arm having a latch on an end thereof, the latch configured to releasably engage with a vehicle anchor system, wherein the latch arm is movably mounted to the seat shell and selectively fixable in two or more angles relative to the seat shell.

### CROSS REFERENCE TO RELATED APPLICATIONS

This application claims the benefit of U.S. Application Nos. 63/481,889, filed on Jan. 27, 2023, 63/489,282, filed on Mar. 9, 2023, 63/508,552, filed on Jun. 16, 2023, 63/511,037, filed on Jun. 29, 2023, 63/586,147, filed on Sep. 29, 2023, which are incorporated herein by reference in its entirety.

### BACKGROUND

Automobiles, busses, airplanes, boats, trains, and the like are common forms of transportation (hereinafter “vehicle”) for many parents, guardians, and caregivers (hereinafter “caregiver”) of children worldwide. Many conventional vehicles, often include restraints (e.g., seat belts) that are designed to protect adults and/or children of a certain age (e.g., at least 9 years old) and/or size (e.g., at least 57 inches in height). For relatively younger and/or smaller children and particularly infants, however, the restraints in various vehicles do not generally provide adequate protection. In view of the foregoing, to provide adequate protection for children during travel, caregivers often utilize a child safety seat or infant car seat when transporting a child in a vehicle.

Because children grow and experience substantial physical development during their first five years of life, different types of child safety seats are used to ensure that the child remains sufficiently restrained and protected during transport in a vehicle. More specifically, a given child safety seat generally is selected, and installed in the vehicle in a certain manner, based on the size, weight, and/or age of the child. An “infant car seat” is a type of child safety seat tailored specifically for infants being transported in a vehicle. An “infant” generally refers to a child who has not yet learned how to walk and typically corresponds to children who are 0 to about 12 months in age and/or weigh up to about 20 to 30 pounds. The infant car seat may be used more generally to carry and hold an infant beyond a vehicle or stroller. Once a child outgrows the infant car seat, the infant car seat system in the vehicle is generally replaced by a “convertible” car seat. In contrast to the infant car seat system, the convertible car seat is larger in size and generally supports both rear-facing and forward-facing configurations to accommodate the physical development of the child. Additionally, unlike the infant car seat, the convertible car seat is typically not portable and rather is a stationary device that remains within the vehicle, i.e., the child is placed into and/or taken out of the convertible car seat at the beginning and end of a vehicle journey. Because it is not intended to carry a child outside of a vehicle, a conventional convertible car seat does not include a carrying handle as found on infant car seats; similarly, the convertible car seat would not include a curved rocker bottom for rocking an infant. Once the child outgrows the convertible car seat, the convertible car seat may then be replaced by an even larger seat, or ultimately a booster seat. The child may continue to use the booster seat until they are able to safely use the vehicle's seats and restraints without the aid of the booster seat.

With respect to installation in a vehicle, child safety seats may utilize existing seat belts in a vehicle to secure the child safety seat in the vehicle. To this end, various child safety seats include a vehicle belt path through which the vehicle's existing seat belt can pass to hold the child safety seat to the vehicle's seat. Alternatives to using existing vehicle seat belts include, for example, “vehicle lower anchors” located in the bight of vehicle seats in passenger cars and/or other vehicle attachment points.

National Child Passenger Safety (CPS) Certification program provides a standard for child passenger safety certification. According to the CPS, a child safety seat when properly installed in a vehicle should pass an “inch test,” i.e., a properly installed child safety seat should not move more than one inch front to back or side to side when pulled at the seat belt path. This rule applies for forward-facing child safety seats and rear-facing child safety seats, such as an infant car seat, and when the child safety seat is secured to the vehicle seat using either an existing vehicle seat belt or a standardized anchor system including vehicle lower anchors.

### SUMMARY

According to some embodiments, infant car seat systems for installation on vehicle seats are provided. The infant car seat systems include an infant car seat having a seat shell and an anchor system connected to the seat shell. The anchor system includes a latch arm having a latch on an end thereof, the latch configured to releasably engage with a vehicle anchor system, wherein the latch arm is movably mounted to the seat shell and selectively fixable in two or more angles relative to the seat shell.

In addition to one or more of the features described herein, or as an alternative, further embodiments of the infant car seat systems may include that the latch arm is rotatably mounted to the seat shell.

In addition to one or more of the features described herein, or as an alternative, further embodiments of the infant car seat systems may include that the latch arm is configured to be locked at the two or more angles and to hold and support the infant car seat at a respective one of the two or more angles when locked at such respective one of the two or more angles.

In addition to one or more of the features described herein, or as an alternative, further embodiments of the infant car seat systems may include that the anchor system includes a memory hub configured to set an angle of recline of the infant car seat based on each of the two or more angles, wherein the latch arm is operably coupled to the memory hub.

In addition to one or more of the features described herein, or as an alternative, further embodiments of the infant car seat systems may include that the anchor system includes a latch arm hub, the latch arm extending from the latch arm hub, a recline hub, a recline gear, and one or more ramp hubs. A hub shaft extends from the latch arm hub and through the recline hub, the recline gear, and the one or more ramp hubs, and defining a rotational axis therethrough.

In addition to one or more of the features described herein, or as an alternative, further embodiments of the infant car seat systems may include that the one or more ramp hubs comprises a first ramp hub and a second ramp hub, wherein rotation of the first ramp hub relative to the second ramp hub causes axial movement of the recline gear to selectively engage or disengage from the memory hub.

In addition to one or more of the features described herein, or as an alternative, further embodiments of the infant car seat systems may include that, in response to the recline gear being engaged with the recline hub and disengaged from the memory hub, the latch arm is free to rotate relative to the memory hub.

In addition to one or more of the features described herein, or as an alternative, further embodiments of the infant car seat systems may include that, in response to the recline gear being engaged with the recline hub and engaged with the memory hub, the latch arm is locked in rotational relationship with the memory hub.

In addition to one or more of the features described herein, or as an alternative, further embodiments of the infant car seat systems may include an incline switch arranged on the seat shell and operably coupled to the first ramp hub, wherein operation of the incline switch cases rotation of the first ramp hub and urge the second ramp hub axially along the hub shaft.

In addition to one or more of the features described herein, or as an alternative, further embodiments of the infant car seat systems may include a locking plate pivotably coupled to the seat shell and selectively operable to engage with the memory hub to lock the memory hub at one of the two or more angles.

In addition to one or more of the features described herein, or as an alternative, further embodiments of the infant car seat systems may include that the locking plate comprises a locking tooth and the memory hub comprises a first locking recess associated with a first angle of the two or more angles and a second locking recess associated with a second angle of the two or more angles, wherein the locking tooth is configured to selectively engage with the first locking recess and the second locking recess.

In addition to one or more of the features described herein, or as an alternative, further embodiments of the infant car seat systems may include a first release connector operably coupled to the locking plate and configured to selectively operate the locking plate.

In addition to one or more of the features described herein, or as an alternative, further embodiments of the infant car seat systems may include a second release connector operably coupled to the latch and configured to selectively operate the latch.

In addition to one or more of the features described herein, or as an alternative, further embodiments of the infant car seat systems may include a carry handle rotatably coupled to the seat shell by an attachment mechanism. The anchor system is operably coupled to the attachment mechanism and rotation of the carry handle is configured to cause operation of the anchor system.

In addition to one or more of the features described herein, or as an alternative, further embodiments of the infant car seat systems may include that the anchor system comprises a handle linkage, a connecting linkage, and a locking linkage. The handle linkage is coupled to the attachment mechanism at one end and the connecting linkage at an opposite end, the connecting linkage is coupled between the handle linkage and the locking linkage, the locking linkage is coupled to the latch arm, and rotation of the carry handle locks the latch arm in at least one of two or more angles.

In addition to one or more of the features described herein, or as an alternative, further embodiments of the infant car seat systems may include a rear linkage pivotably connected between the seat shell and a connection point between the connecting linkage and the locking linkage.

17. The infant car seat system of claim 15, wherein the locking linkage comprises a recline rack, the recline rack having a number of locking positions corresponding to the two or more angles.

In addition to one or more of the features described herein, or as an alternative, further embodiments of the infant car seat systems may include that a first locking position of the recline rack defines a maximum recline of the infant car seat and a second locking position of the recline rack defines an upright position of the infant car seat.

In addition to one or more of the features described herein, or as an alternative, further embodiments of the infant car seat systems may include a forward linkage pivotably connected between the seat shell and a connection point between the locking linkage and the latch arm.

In addition to one or more of the features described herein, or as an alternative, further embodiments of the infant car seat systems may include that in a carry position of the carry handle, the latch arm is free to be adjusted between the two or more angles, and in an anti-rebound position, the latch arm is pulled toward the seat shell and locked in position.

In addition to one or more of the features described herein, or as an alternative, further embodiments of the infant car seat systems may include that the anchor system defines a first locking position associated with a first angle of the two or more angles and defining a maximum recline of the infant car seat and a second locking position of the anchor system defines an upright position of the infant car seat.

In addition to one or more of the features described herein, or as an alternative, further embodiments of the infant car seat systems may include that at least a portion of the anchor system is housed within the seat shell.

In addition to one or more of the features described herein, or as an alternative, further embodiments of the infant car seat systems may include a recline actuation handle arranged on the seat shell, operably coupled to the anchor system, and configured to selectively release the latch arm to adjust an incline angle of the infant car seat.

In addition to one or more of the features described herein, or as an alternative, further embodiments of the infant car seat systems may include a recline actuation connector that operably connects the recline actuation handle to a portion of the anchor system.

In addition to one or more of the features described herein, or as an alternative, further embodiments of the infant car seat systems may include that the portion of the anchor system is a driving ramp hub.

In addition to one or more of the features described herein, or as an alternative, further embodiments of the infant car seat systems may include a connector element arranged to connect the recline actuation handle and the recline actuation connector.

In addition to one or more of the features described herein, or as an alternative, further embodiments of the infant car seat systems may include that the recline actuation handle comprises a stowing lock extension configured to selectively secure the latch arm in a stowed state.

In addition to one or more of the features described herein, or as an alternative, further embodiments of the infant car seat systems may include a stowing lock arranged between the stowing lock extension of the recline actuation handle and the latch arm, the stowing lock selectively operable to lock and release the latch arm from the stowed state.

According to some embodiments, infant car seat systems for installation on vehicle seats are provided that include an infant car seat having a seat shell and an anchor system connected to the seat shell. The anchor system includes a latch arm having a latch configured to releasably engage with a vehicle anchor system, wherein the latch arm is movably mounted to the seat shell such that the latch arm is releasably fixable in a stowed position and a use position and a release handle operably connected to the latch arm, wherein activation of the release handle releases engagement between the latch and vehicle anchor system and releases the latch arm to allow the latch arm to move between the stowed position and the use position.

In addition to one or more of the features described herein, or as an alternative, further embodiments of the infant car seat systems may include that the use position of the latch arm, the latch arm is selectively fixable in two or more angles relative to the seat shell, the anchor system further comprising a memory hub configured to set an angle of recline of the infant car seat based on the two or more angles, wherein the latch arm is operably coupled to the memory hub.

In addition to one or more of the features described herein, or as an alternative, further embodiments of the infant car seat systems may include a locking plate pivotably coupled to the seat shell, the locking plate being operably connected between the release handle and the latch arm, and further operably connected between the release handle and the latch, wherein activation of the release handle causes the locking plate to pivot and release engagement between the latch and vehicle anchor system and release the latch arm to move between the stowed position and the use position.

In addition to one or more of the features described herein, or as an alternative, further embodiments of the infant car seat systems may include that the memory hub is configured to move with the latch arm between the stowed position and the use position.

In addition to one or more of the features described herein, or as an alternative, further embodiments of the infant car seat systems may include that the anchor system further comprises an incline actuator, the incline actuator being operably coupled to the memory hub and the latch arm such that actuation of the incline actuator allows the latch arm to rotate relative to the memory hub to set an angle of inclination of the latch arm relative to the seat shell.

In addition to one or more of the features described herein, or as an alternative, further embodiments of the infant car seat systems may include a first release connector, a sliding connector, and a second release connector. The release handle is connected to the first release connector, the first release connector is connected to the sliding connector, and the sliding connector is connected to the second release connector.

In addition to one or more of the features described herein, or as an alternative, further embodiments of the infant car seat systems may include that the second release connector extends through the latch arm to operate a latch thereof.

In addition to one or more of the features described herein, or as an alternative, further embodiments of the infant car seat systems may include a locking plate connector connected to the sliding connector and configured to selectively operate a locking mechanism of the anchor system.

In addition to one or more of the features described herein, or as an alternative, further embodiments of the infant car seat systems may include a connection element arranged to selectively extend outward from the seat shell for engagement with a stroller frame.

In addition to one or more of the features described herein, or as an alternative, further embodiments of the infant car seat systems may include that the connection element comprises a first actuation tab and the first release connector comprises a second actuation tab, wherein operation of the first release connector causes the second actuation tab to interact with the first actuation tab to cause the connection element to retract into the seat shell.

According to some embodiments, infant car seat systems for installation on vehicle seats include an infant car seat having a seat shell and an anchor system having a latch attachment mechanism connected to the seat shell and a latch arm extending from the latch attachment mechanism to a latch, the latch being configured to releasably engage with a vehicle anchor system. The latch attachment mechanism is configured to transition the latch arm between a stowed position, a first use position, and a second use position, and wherein the latch attachment mechanism is further configured to transition to either one of the first and second use positions from the stowed position based on a recent previous use position.

In addition to one or more of the features described herein, or as an alternative, further embodiments of the infant car seat systems may include that the recent previous use position is the first use position, such that when the latch arm transitions from the stowed position, the latch arm transitions to the first use position.

According to some embodiments, infant car seat systems for installation on vehicle seats are provided that include an infant car seat having a seat shell, a latch arm movably mounted to the seat shell, the latch arm having a latch configured to releasably engage with a vehicle anchor system, and a carry handle movably coupled to the seat shell. The carry handle is operably coupled to the latch arm by a connecting member, and movement of the carry handle causes movement of the latch arm relative to the seat shell.

In addition to one or more of the features described herein, or as an alternative, further embodiments of the infant car seat systems may include that the latch arm is selectively fixable in two or more angles relative to the seat shell.

In addition to one or more of the features described herein, or as an alternative, further embodiments of the infant car seat systems may include that the carry handle is rotatably coupled to the shell by an attachment mechanism, wherein rotation of the carry handle causes the movement of the latch arm relative to the seat shell.

In addition to one or more of the features described herein, or as an alternative, further embodiments of the infant car seat systems may include that the connecting member is operably connected between the attachment mechanism and the latch arm.

In addition to one or more of the features described herein, or as an alternative, further embodiments of the infant car seat systems may include a handle linkage coupled to the attachment mechanism at one end and a connecting linkage at an opposite end, the connecting linkage coupled between the handle linkage and a locking linkage, and the locking linkage coupled to the latch arm. Rotation of the carry handle is configured to retract the latch arm toward the seat shell.

In addition to one or more of the features described herein, or as an alternative, further embodiments of the infant car seat systems may include a rear linkage pivotably connected between the seat shell and a connection point between the connecting linkage and the locking linkage.

In addition to one or more of the features described herein, or as an alternative, further embodiments of the infant car seat systems may include that the locking linkage comprises a recline rack, the recline rack having a number of locking positions corresponding to the two or more angles.

In addition to one or more of the features described herein, or as an alternative, further embodiments of the infant car seat systems may include that a first locking position of the recline rack defines a maximum recline of the infant car seat and a second locking position of the recline rack defines an upright position of the infant car seat.

In addition to one or more of the features described herein, or as an alternative, further embodiments of the infant car seat systems may include a forward linkage pivotably connected between the seat shell and a connection point between the locking linkage and the latch arm.

In addition to one or more of the features described herein, or as an alternative, further embodiments of the infant car seat systems may include that in a carry position of the carry handle, the latch arm is free to be adjusted between the two or more angles, and in an anti-rebound position, the latch arm is pulled toward the seat shell and locked in position.

According to some embodiments, infant car seat systems are provided that include an infant car seat having a seat shell, an anchor system arranged on the seat shell and configured to selectively connect to a vehicle seat, and a connection element arranged on the seat shell, the connection element configured to selectively engage and secure the seat shell to an external structure.

In addition to one or more of the features described herein, or as an alternative, further embodiments of the infant car seat systems may include that the connection element is configured to be selectively retracted into the seat shell.

In addition to one or more of the features described herein, or as an alternative, further embodiments of the infant car seat systems may include a release handle arranged on the seat shell and operably connected to the anchor system, the release handle configured to operate at least a portion of the anchor system.

In addition to one or more of the features described herein, or as an alternative, further embodiments of the infant car seat systems may include a release connector extending between the release handle and the anchor system, the release connector configured to cause retraction of the connection element during actuation of the release handle.

In addition to one or more of the features described herein, or as an alternative, further embodiments of the infant car seat systems may include that the external structure is a stroller frame.

In addition to one or more of the features described herein, or as an alternative, further embodiments of the infant car seat systems may include a stroller frame, wherein the connection element is configured to selectively secure the seat shell to the stroller frame.

In addition to one or more of the features described herein, or as an alternative, further embodiments of the infant car seat systems may include that the connection element comprises a first actuation tab and the release connector comprises a second actuation tab, wherein the second actuation tab is configured to contact the first actuation tab when the release handle is operated to retract the connection element into the seat shell.

In addition to one or more of the features described herein, or as an alternative, further embodiments of the infant car seat systems may include that the anchor system comprises a sliding connector and a second release connector, wherein the release handle is operably connected to the anchor system through the release connector, the sliding connector, and the second release connector.

In addition to one or more of the features described herein, or as an alternative, further embodiments of the infant car seat systems may include that the second release connector is configured to operate a latch on a latch arm of the anchor system.

In addition to one or more of the features described herein, or as an alternative, further embodiments of the infant car seat systems may include that the release connector is configured to travel in a first direction when the release handle is actuated and the sliding connector is configured to travel in a second direction different from the first direction when the release handle is actuated.

In addition to one or more of the features described herein, or as an alternative, further embodiments of the infant car seat systems may include that the release handle is arranged at a back side of the seat shell.

In addition to one or more of the features described herein, or as an alternative, further embodiments of the infant car seat systems may include that the anchor system is arranged a front side of the seat shell.

In addition to one or more of the features described herein, or as an alternative, further embodiments of the infant car seat systems may include that the anchor system includes a latch arm having a latch configured to releasably engage with a vehicle anchor system, wherein the latch arm is movably mounted to the seat shell such that the latch arm is releasably fixable in a stowed position and a use position, and a release handle operably connected to the latch arm, wherein activation of the release handle releases engagement between the latch and vehicle anchor system and releases the latch arm to allow the latch arm to move between the stowed position and the use position.

According to some embodiments, infant car seat systems for installation on vehicle seats are provided that include an infant car seat having a seat shell, a latch arm movably mounted to the seat shell, the latch arm having a latch configured to releasably engage with a vehicle anchor system, and a carry handle movably coupled to the seat shell, the carry handle being moveable between an unlock position and a lock position. The carry handle is operably coupled to the latch arm by a connecting member, wherein when the carry handle is transitioned to the lock position, the latch arm is locked in position such that movement of the latch arm relative to the seat shell is substantially prevented.

According to some embodiments, infant car seat systems are provided that include an infant car seat having a seat shell, the infant car seat configured for installation on a vehicle seat, an anchor system arranged on the seat shell and configured to selectively connector to a vehicle seat, and a base configured to selectively connect to a vehicle seat, the base further being configured to selectively received and connector to the infant car seat.

In addition to one or more of the features described herein, or as an alternative, further embodiments of the infant car seat systems may include that the seat shell comprises at least one connecting tube, wherein the base is configured to receive and engage with the at least one connecting tube to connect the infant car seat to the base.

In addition to one or more of the features described herein, or as an alternative, further embodiments of the infant car seat systems may include that the base includes at least one base connector configured to selectively receive and secure a portion of the seat shell to the base and a release handle operably coupled to the at least one base connector to selectively operate the at least one base connector between a lock state and a release state.

In addition to one or more of the features described herein, or as an alternative, further embodiments of the infant car seat systems may include that the base includes two base connector actuators operably connected to the release handle and four base connectors, wherein a first two base connectors are operably connected to a first base connector actuator of the two base connector actuators and a second two base connectors are operably connected to a second base connector actuator.

According to some embodiments, infant car seat systems for use with vehicle seats are provided that include an infant car seat having a seat shell, the seat shell including at least one seat connector and a base installable on the vehicle seat and configured to selectively receive and support the infant car seat. The base includes at least one base connector configured to selectively secure the at least one seat connector to the base and a release handle disposed on the base and operably coupled to the at least one base connector to selectively operate the at least one base connector between a lock state and a release state at a plurality of attachment points on the at least one seat connector.

In addition to one or more of the features described herein, or as an alternative, further embodiments of the infant car seat systems may include that the at least one seat connector is at least one seat rod.

In addition to one or more of the features described herein, or as an alternative, further embodiments of the infant car seat systems may include that the at least one base connector is at least one latch.

In addition to one or more of the features described herein, or as an alternative, further embodiments of the infant car seat systems may include that the at least one seat connector is a first seat rod and a second seat rod.

In addition to one or more of the features described herein, or as an alternative, further embodiments of the infant car seat systems may include that the at least one base connector is a first latch, a second latch, a third latch, and a fourth latch, wherein the first latch and the second latch selectively receive the first seat rod at a first attachment point and a second attachment point of the plurality of attachment points, and wherein the third latch and the fourth latch selectively receive the second seat rod at a third attachment point and a fourth attachment point of the plurality of attachment points.

In addition to one or more of the features described herein, or as an alternative, further embodiments of the infant car seat systems may include that the base includes a first latch actuator and a second latch actuator operably connected to the release handle; and wherein the first latch and the second latch are operably connected to a first latch actuator and the third latch and the fourth latch are operably connected to the second latch actuator.

In addition to one or more of the features described herein, or as an alternative, further embodiments of the infant car seat systems may include that the release handle is a single handle that selectively operates the at least one base connector between the lock state and the release state at all of the plurality of attachment points on the at least one seat connector.

In addition to one or more of the features described herein, or as an alternative, further embodiments of the infant car seat systems may include that the infant car seat is also installable directly on the vehicle seat absent the base.

According to some embodiments, an infant car seat system for installation on a vehicle seat including a vehicle anchor system includes an infant car seat having a seat shell and an anchor system connected to the seat shell. The anchor system includes a latch attachment mechanism connected to the seat shell and a latch arm extending from the latch attachment mechanism and including a latch. The latch arm is movable between a stowed position and a use position. The latch is releasably engageable with the vehicle anchor system. When in the use position, the latch attachment mechanism imparts a biasing force on the latch arm toward the stowed position.

In addition to one or more of the features described herein, or as an alternative, further embodiments a release actuator is operably coupled to the latch attachment mechanism and to the latch. Operation of the release actuator disengages the latch from the vehicle anchor system.

In addition to one or more of the features described herein, or as an alternative, further embodiments the release actuator is disposed on the seat shell.

In addition to one or more of the features described herein, or as an alternative, further embodiments a locking mechanism is operable to lock the latch arm in the use position against a biasing force imparted by the latch attachment mechanism.

In addition to one or more of the features described herein, or as an alternative, further embodiments the release actuator is operably coupled to the locking mechanism. Operation of the release actuator unlocks the locking mechanism such that the biasing force moves the latch arm toward the stowed position.

In addition to one or more of the features described herein, or as an alternative, further embodiments the latch attachment mechanism further includes a memory hub movable relative to the seat shell between a first position and a second position and a biasing mechanism operably coupled to the memory hub. The biasing force of the biasing mechanism biases the memory hub from the first position to the second position.

In addition to one or more of the features described herein, or as an alternative, further embodiments the locking mechanism is operably coupled to the memory hub. The locking mechanism is selectively operable to lock the memory hub in the second position.

In addition to one or more of the features described herein, or as an alternative, further embodiments the locking mechanism includes a locking plate and a locking plate biasing mechanism. The memory hub includes a locking recess. The locking plate is receivable within the locking recess when the memory hub is in the second position.

In addition to one or more of the features described herein, or as an alternative, further embodiments the release actuator is operably coupled to the locking mechanism to selectively disengage the locking plate from the locking recess.

In addition to one or more of the features described herein, or as an alternative, further embodiments the latch arm is movably mounted to the latch attachment mechanism and is and selectively fixable at two or more angles relative to the latch attachment mechanism.

In addition to one or more of the features described herein, or as an alternative, further embodiments the latch arm is rotatably mounted to the latch attachment mechanism.

In addition to one or more of the features described herein, or as an alternative, further embodiments the latch attachment mechanism includes a recline hub coupled to the latch arm, a recline gear, and one or more ramp hubs. A hub shaft extends from the latch arm through the recline hub, the recline gear, and the one or more ramp hubs, and defines a hub axis therethrough.

In addition to one or more of the features described herein, or as an alternative, further embodiments the one or more ramp hubs includes a first ramp hub and a second ramp hub. Rotation of the second ramp hub relative to the first ramp hub causes axial movement of the recline gear to selectively engage or disengage from the memory hub.

In addition to one or more of the features described herein, or as an alternative, further embodiments in response to the recline gear being engaged with the recline hub and disengaged from the memory hub, the latch arm is freely rotatable relative to the memory hub.

In addition to one or more of the features described herein, or as an alternative, further embodiments in response to the recline gear being engaged with the recline hub and engaged with the memory hub, the latch arm is rotationally locked with the memory hub.

In addition to one or more of the features described herein, or as an alternative, further embodiments including an incline actuator operably coupled to the second ramp hub. Operation of the incline actuator rotates the second ramp hub.

According to some embodiments, an infant car seat system for installation on a vehicle seat including a vehicle anchor system includes an infant car seat having a seat shell and at least one seat connector and a base having a seat retention assembly including at least one base connector configured to selectively receive and secure the at least one seat connector to the base. A first release actuator is operably coupled to the at least one base connector to selectively operate the at least one base connector between a locked state and an unlocked state. The first release actuator is located at the base. A second release actuator is operably coupled to the at least one base connector to selectively operate the at least one base connector between the locked state and the unlocked state. The second release actuator is located at the infant car seat.

In addition to one or more of the features described herein, or as an alternative, in further embodiments the at least one base connector includes a base connector housing mounted to the base and a locking plate mounted to the base connector housing. The locking plate is pivotable between a locked position and an unlocked positioned.

In addition to one or more of the features described herein, or as an alternative, in further embodiments the seat retention assembly includes a base connector actuator operably coupled to the locking plate of the at least one base connector.

In addition to one or more of the features described herein, or as an alternative, in further embodiments both the first release actuator and the second release actuator are selectively operable to move the locking plate to the unlocked position via movement of the base connector actuator.

In addition to one or more of the features described herein, or as an alternative, in further embodiments the at least one base connector includes an infant car seat release assembly operably coupled to the base connector actuator.

In addition to one or more of the features described herein, or as an alternative, in further embodiments the second release actuator is operably coupled to the base connector actuator via the infant car seat release assembly.

In addition to one or more of the features described herein, or as an alternative, in further embodiments the infant car seat release assembly includes a driving toggle rotatably mounted to the base connector housing. The driving toggle is movable to engage and transmit a force to the base connector actuator. An actuation toggle is operably coupled to the driving toggle and is operable to move the driving toggle into engagement with the base connector actuator.

In addition to one or more of the features described herein, or as an alternative, in further embodiments the actuation toggle is movable between an extended position and a retracted position and a portion of the actuation toggle is arranged at an exterior of the base when in the extended position.

In addition to one or more of the features described herein, or as an alternative, in further embodiments the infant car seat includes a driver movable relative to the seat shell to selectively engage the actuation toggle in response to operation of the second release actuator when the infant car seat is secured to the base.

In addition to one or more of the features described herein, or as an alternative, in further embodiments the driver is movable relative to the seat shell by a slider. The slider is operably coupled to the second release actuator.

In addition to one or more of the features described herein, or as an alternative, in further embodiments the at least one base connector further comprises a first base connector and a second base connector associated with the base connector actuator and only the first base connector includes the infant car seat release assembly.

In addition to one or more of the features described herein, or as an alternative, in further embodiments the infant car seat includes an anchor system having at least one child seat anchor including a latch configured to releasably engage a vehicle anchor of the vehicle seat. The at least one child seat anchor is movable between a use position and a stowed position.

In addition to one or more of the features described herein, or as an alternative, in further embodiments the second release actuator is operably coupled to the anchor system to selectively move the at least one child seat anchor from the use position to the stowed position.

In addition to one or more of the features described herein, or as an alternative, in further embodiments the second release actuator is operably coupled to the latch to selectively disengage the latch from the vehicle anchor.

In addition to one or more of the features described herein, or as an alternative, in further embodiments the infant car seat further includes a stroller mechanism configured to selectively engage and secure the seat shell to an external structure.

In addition to one or more of the features described herein, or as an alternative, in further embodiments the second release actuator is operably coupled to the stroller mechanism to selectively release the stroller mechanism from the external structure.

According to some embodiments, an infant car seat installable onto a base includes a body having a seat shell and at least one seat connector receivable within a seat retention assembly of the base. A release actuator is located at the seat shell and is operably couplable to the seat retention assembly of the base to release the infant car seat from the base.

In addition to one or more of the features described herein, or as an alternative, in further embodiments a driver is arranged at the seat shell. The driver is movable to selectively engage a portion of the seat retention assembly to release the infant car seat from the base.

In addition to one or more of the features described herein, or as an alternative, in further embodiments the release actuator is operable to move the driver into engagement with the seat retention assembly.

In addition to one or more of the features described herein, or as an alternative, in further embodiments a slider is connected to the release actuator via a connection member.

In addition to one or more of the features described herein, or as an alternative, in further embodiments the driver includes a slot and the driver includes a boss arranged within the slot.

In addition to one or more of the features described herein, or as an alternative, in further embodiments an anchor system is arranged on the seat shell and configured to selectively connect to a vehicle seat and a stroller mechanism is arranged on the seat shell. The stroller mechanism is configured to selectively engage and secure the seat shell to an external structure.

In addition to one or more of the features described herein, or as an alternative, in further embodiments the release actuator is operably coupled to the anchor system to selectively move the anchor system from a use position to a stowed position.

In addition to one or more of the features described herein, or as an alternative, in further embodiments the anchor system includes at least one latch configured to releasably engage a vehicle anchor of the vehicle seat. The release actuator being operably coupled to the at least one latch to selectively disengage the at least one latch from the vehicle anchor.

In addition to one or more of the features described herein, or as an alternative, in further embodiments the release actuator is operably coupled to the stroller mechanism to selectively release the stroller mechanism from the external structure.

In addition to one or more of the features described herein, or as an alternative, in further embodiments the anchor system includes at least one latch configured to releasably engage a vehicle anchor of the vehicle seat. The release actuator is operably coupled to the anchor system to selectively move the anchor system from a use position to a stowed position. The release actuator is operably coupled to the at least one latch to selectively disengage the at least one latch from the vehicle anchor. The release actuator is operably coupled to the stroller mechanism to selectively release the stroller mechanism from the external structure.

The foregoing features and elements may be combined in various combinations without exclusivity, unless expressly indicated otherwise. Features which are described in the context of separate aspects and embodiments may be used together and/or be interchangeable. Similarly, features described in the context of a single embodiment may also be provided separately or in any suitable subcombination. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is an illustrative schematic of a vehicle in which an infant car seat system according to embodiments of the present disclosure may be installed;

FIG. 1B is a schematic illustration of an infant car seat system coupled to the vehicle seat of the vehicle of FIG. 1A;

FIG. 2A is a schematic diagram of a typical vehicle seat and vehicle lower anchors to which an infant car seat system in accordance with the present disclosure may be installed;

FIG. 2B shows a diagram of a typical vehicle seat lower anchor in the vehicle seat of FIG. 2A;

FIG. 3A is a schematic illustration of an infant car seat system in accordance with an embodiment of the present disclosure in a first position;

FIG. 3B is a schematic illustration of the infant car seat system of FIG. 3A in a second position;

FIG. 4 is a schematic illustration of components of an anchor system for an infant car seat in accordance with an embodiment of the present disclosure;

FIG. 5A is a schematic illustration an anchor system for an infant car seat in accordance with an embodiment of the present disclosure in a first state;

FIG. 5B is an alternative view of the anchor system of FIG. 5A in the first state;

FIG. 5C is another alternative view of the anchor system of FIG. 5A in the first state;

FIG. 5D is a schematic illustration the anchor system of FIG. 5A shown in a second state;

FIG. 5E is an alternative view of the anchor system of FIG. 5A in the second

FIG. 5F is another alternative view of the anchor system of FIG. 5A in the second state;

FIG. 6A is a schematic illustration of an anchor system in accordance with an embodiment of the present disclosure;

FIG. 6B illustrates the anchor system of FIG. 6A in a first state of operation;

FIG. 6C illustrates the anchor system of FIG. 6B in a second state of operation;

FIG. 7 is a schematic illustration of an infant car seat system in accordance with an embodiment of the present disclosure;

FIG. 8A is a schematic illustration of an anchor system in accordance with an embodiment of the present disclosure, shown in a first locked state;

FIG. 8B illustrates the anchor system of FIG. 8A in an unlocked state;

FIG. 8C illustrates the anchor system of FIG. 8A in a second locked state;

FIG. 9A is a schematic illustration of an infant car seat system in accordance with an embodiment of the present disclosure;

FIG. 9B illustrates the infant car seat system of FIG. 9A in a maximum recline orientation;

FIG. 9C illustrates the infant car seat system of FIG. 9A in a fully upright orientation;

FIG. 9D illustrates the infant car seat system of FIG. 9A in a locked and tensioned state;

FIG. 10A illustrates an infant car seat system in accordance with an embodiment of the present disclosure, as installed to a vehicle seat;

FIG. 10B illustrates the infant car seat system of FIG. 10A in a tensioned state;

FIG. 11A is a schematic illustration of a portion of an infant car seat and anchor system in accordance with an embodiment of the present disclosure;

FIG. 11B is a side view illustration of the infant car seat of FIG. 11A in a first state of recline/incline;

FIG. 11C is a side view illustration of the infant car seat of FIG. 11A in a second state of recline/incline;

FIG. 12A is a schematic illustration of a portion of an infant car seat and anchor system in accordance with an embodiment of the present disclosure;

FIG. 12B is a schematic illustration of a part of the anchor system of FIG. 12A;

FIG. 12C is a schematic illustration of the anchor system of FIG. 12B shown in

FIG. 12D is a schematic illustration of the anchor system of FIG. 12B shown in a recline unlocked state;

FIG. 13A is a schematic illustration of a portion of an infant car seat having a recline actuation handle, shown in an unactuated state;

FIG. 13B is a schematic illustration of the recline actuation handle shown in an actuated state;

FIG. 13C is a schematic illustration of the infant car seat of FIG. 13A illustrating a connection between the recline actuation handle and an anchor system of the infant car seat;

FIG. 13D is a schematic, first-side illustration of a portion of the connection between recline actuation handle and an anchor system of the infant car seat;

FIG. 13E is a schematic, second-side illustration of the portion of the connection between recline actuation handle and an anchor system of the infant car seat;

FIG. 14A is a schematic illustration of a recline actuation handle of an infant car seat in accordance with an embodiment of the present disclosure;

FIG. 14B is a side schematic illustration of the recline actuation handle of FIG. 14A as arranged on an infant car seat and illustrating a first state of operation relative to a latch arm of an anchor system;

FIG. 14C is a side schematic illustration of the recline actuation handle of FIG. 14B as arranged on the infant car seat and illustrating a second state of operation relative to the latch arm of the anchor system;

FIG. 15A is a schematic illustration of an infant car seat and anchor system in accordance with an embodiment of the present disclosure, shown in a lock state;

FIG. 15B is a schematic illustration of the infant car seat and anchor system of FIG. 15A shown in an unlock state;

FIG. 15C is a schematic illustration of a portion of the anchor system of FIGS. 15A-15B;

FIG. 15D is a schematic illustration of another portion of the anchor system of FIGS. 15A-15B;

FIG. 16A is a schematic illustration of an anchor system and infant car seat in accordance with an embodiment of the present disclosure, shown in a stowed state;

FIG. 16B is a schematic illustration of the anchor system and infant car seat of FIG. 16A shown in a released state;

FIG. 16C is a schematic illustration of the anchor system and infant car seat of FIG. 16A shown in another released state;

FIG. 16D is a schematic illustration of the anchor system and infant car seat of FIG. 16A shown in a fully extended state;

FIG. 16E is a schematic illustration of a component of the anchor system of FIGS. 16A-16D;

FIG. 17A is schematic illustration of an infant car seat and anchor system in accordance with an embodiment of the present disclosure;

FIG. 17B is a schematic illustration of a portion of the anchor system of FIG. 17A shown in a lock state;

FIG. 17C is a schematic illustration of a portion of the anchor system of FIG. 17A shown in an unlock state;

FIG. 17D is a schematic illustration of a component of the anchor system of FIGS. 17A-17C;

FIG. 17E is a schematic illustration of another component of the anchor system of FIGS. 17A-17C;

FIG. 18A is a schematic illustration of an infant car seat and stroller frame in accordance with an embodiment of the present disclosure;

FIG. 18B is a detailed illustration of a connection between the infant car seat and stroller frame of FIG. 18A;

FIG. 19A is a schematic illustration of an infant car seat and base in accordance with an embodiment of the present disclosure;

FIG. 19B is a bottom view of the infant car seat of FIG. 19A;

FIG. 19C is a schematic illustration of the base of FIG. 19A;

FIG. 19D is a side, sectional view of the infant car seat and base of FIG. 19A;

FIG. 20A is a schematic illustration of a base for receiving an infant car seat in accordance with an embodiment of the present disclosure;

FIG. 20B is a schematic illustration of a portion of the base of FIG. 20A shown in a lock state;

FIG. 20C is a schematic illustration of a portion of the base of FIG. 20A shown in a release state;

FIG. 21 is a partially exploded schematic illustration of a portion of an anchor system in accordance with an embodiment of the present disclosure;

FIG. 22A is a perspective view of a portion of a latch attachment mechanism of the anchor system of FIG. 21 in a stowed position in accordance with an embodiment of the present disclosure;

FIG. 22B is an exploded view of the portion of a latch attachment mechanism of FIG. 22A in accordance with an embodiment of the present disclosure;

FIG. 23A is a side view of an infant car seat having an anchor system in a stowed position in accordance with an embodiment of the present disclosure;

FIG. 23B is a cross-sectional view of a portion of the anchor system of FIG. 23A in accordance with an embodiment of the present disclosure;

FIG. 23C is a perspective view of a portion of the anchor system of FIG. 23A in accordance with an embodiment of the present disclosure;

FIG. 24A is a side view of an infant car seat having an anchor system in a use position in accordance with an embodiment of the present disclosure;

FIG. 24B is a cross-sectional view of a portion of the anchor system of FIG. 24A in accordance with an embodiment of the present disclosure;

FIG. 24C is a perspective view of a portion of the anchor system of FIG. 24A in accordance with an embodiment of the present disclosure;

FIG. 25 is a side view of an infant car seat mounted to a vehicle seat in accordance with an embodiment of the present disclosure;

FIG. 26A is a perspective view of a base in accordance with an embodiment of the present disclosure;

FIG. 26B is a detailed perspective view of a portion of the base of FIG. 26A in accordance with an embodiment of the present disclosure;

FIG. 27 is a perspective view of a portion of a seat retention assembly in accordance with an embodiment of the present disclosure;

FIG. 28A is a side view of a base connector and base connector actuator of a seat retention assembly in a latched configuration in accordance with an embodiment of the present disclosure;

FIG. 28B is a side view of the base connector and base connector actuator of FIG. 28A in an unlatched configuration in accordance with an embodiment of the present disclosure;

FIG. 29A is a perspective view of a base connector and base connector actuator of a seat retention assembly in a latched configuration in accordance with another embodiment of the present disclosure;

FIG. 29B is a perspective view of a base connector and base connector actuator of a seat retention assembly in an unlatched configuration in accordance with another embodiment of the present disclosure;

FIG. 30A is a side view of the base connector and base connector actuator of FIG. 29A in accordance with another embodiment of the present disclosure;

FIG. 30B is a side view of the base connector and base connector actuator of FIG. 29B in accordance with another embodiment of the present disclosure;

FIG. 31A is a perspective view of a rear of an infant car seat having a driver in a stowed position in accordance with an embodiment of the present disclosure;

FIG. 31B is a perspective view of a rear of an infant car seat having a driver in a deployed position in accordance with an embodiment of the present disclosure;

FIG. 32A is an end view of an interface between an infant car seat and a base when the driver is in a stowed position in accordance with an embodiment of the present disclosure;

FIG. 32B is an end view of an interface between an infant car seat and a base when the driver is in a deployed position in accordance with an embodiment of the present disclosure;

FIG. 33A is a top view of a driver in a stowed position in accordance with another embodiment of the present disclosure;

FIG. 33B is a top view of a driver in a deployed position in accordance with another embodiment of the present disclosure;

FIG. 34A is a bottom view of the driver of FIG. 33A in accordance with an embodiment of the present disclosure;

FIG. 34B is a bottom view of the driver of FIG. 33A in accordance with an embodiment of the present disclosure;

FIG. 35 is a side view of an infant car seat having a release actuator in accordance with an embodiment of the present disclosure;

FIG. 36A is a top view of several components operably coupled to a release actuator of an infant car seat in an unactuated position in accordance with an embodiment of the present disclosure;

FIG. 36B is a top view of several components operably coupled to a release actuator of an infant car seat in an actuated position in accordance with an embodiment of the present disclosure;

FIG. 37 is a perspective view of a recline actuator mechanism in accordance with an embodiment of the present disclosure;

FIG. 38A is a perspective view of a recline actuator mechanism in an unactuated position in accordance with an embodiment of the present disclosure;

FIG. 38B is a perspective view of the recline actuator mechanism of FIG. 38A in an actuated position in accordance with an embodiment of the present disclosure;

FIG. 39 is a partial, exploded view of a recline actuator mechanism in accordance with an embodiment of the present disclosure;

FIG. 40 is a plan view of a portion of an anchor system of an infant car seat in accordance with an embodiment of the present disclosure;

FIG. 41 is a front view of a portion of an anchor system of an infant car seat in accordance with an embodiment of the present disclosure;

FIG. 42A is a rear view of the portion of an anchor system of an infant car seat of FIG. 41 in a stored position in accordance with an embodiment of the present disclosure; and

FIG. 42B is a rear view of the portion of an anchor system of an infant car seat of FIG. 41 in a use position in accordance with an embodiment of the present disclosure.

### DETAILED DESCRIPTION

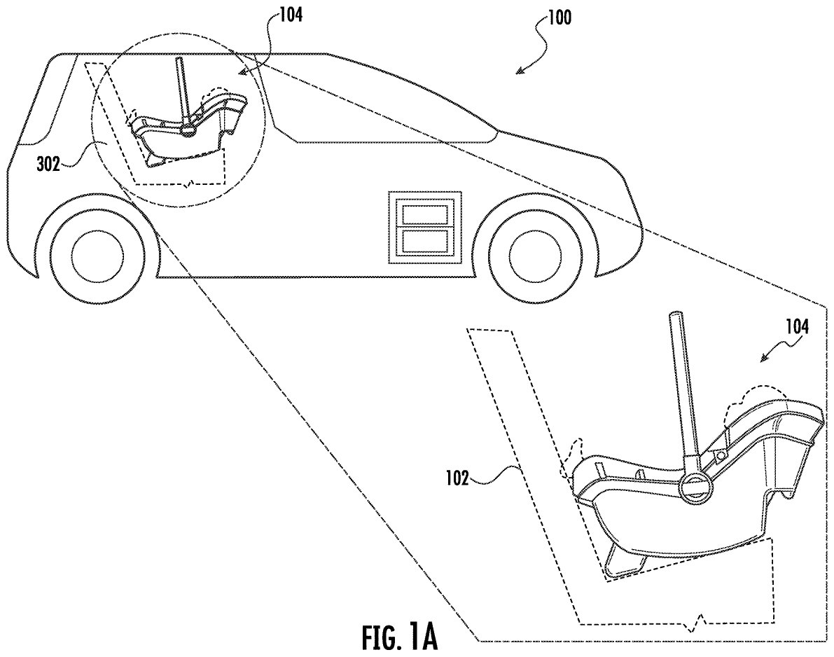

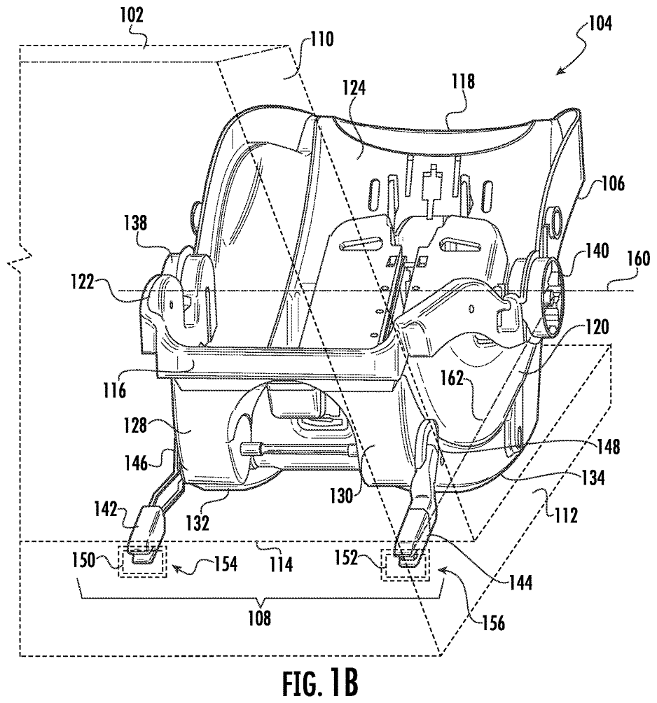

Referring to FIGS. 1A-1B, schematic illustrations of a vehicle 100 and infant car seat system 104 that may incorporate embodiments of the present disclosure are shown. FIG. 1A illustrates the vehicle 100 (e.g., a personal vehicle, a ride-hail or rideshare vehicle, or the like) including a vehicle seat 102 to which an infant car seat system 104 according to various embodiments disclosed herein is installed. FIG. 1A also shows a magnified view of the infant car seat system 104 as installed on the vehicle seat 102 of the vehicle 100, as an inset. FIG. 1B illustrates enlarged detail of the infant car seat system 104 as on the vehicle seat 102 of the vehicle 100.

The infant car seat system 104 includes an infant car seat 106 that is secured, via an integrated anchor system 108, to the vehicle seat 102 of the vehicle 100. The vehicle seat 102 has a vehicle seat back 110, a vehicle seat pan 112, and a seat bight 114 (i.e., the region of intersection of the vehicle seat back 110 and the vehicle seat pan 112). The anchor system 108 is configured to secure the infant car seat 106 to the vehicle seat 102 without using a detachable vehicle installation base and without using a vehicle seat belt (e.g., passing over the top of the legs, lap, or pelvis of the infant when the infant is in the infant car seat for transport in the vehicle). The anchor system 108 may help ensure that installation of the infant car seat 106 (e.g., without using a detachable base and/or without using a vehicle seat belt) provides a tight fit to the vehicle seat 102 such that when installed, the infant car seat system 104 will pass the CPS “inch test.” The anchor system 108 may be arranged to facilitate alignment with standard arrangements of vehicle lower anchors (e.g., as shown in FIG. 1B).

As shown in FIGS. 1A-1B, the infant car seat 106 is secured to the vehicle seat 102 in a rear-facing orientation, in which a front 116 of the infant car seat 106 faces the vehicle seat back 110 and a back 118 of the infant car seat 106 faces away from the vehicle seat back 110. As such, when a child is seated in the infant car seat 106, the child's feet will be at the front 116 of the infant car seat 106 and the child's head will be at the back 118 of the infant car seat 106. Accordingly, the infant car seat 106 is a rear-facing child car seat.

As shown, the infant car seat 106 includes a seat shell 120 and a seat shell rim 122 that together define a child seat back 124 and a child seat pan (not shown). A seat pad, cushion, or the like (not shown) may be disposed on the child seat back 124 and the child seat pan to support an infant that is placed in the infant car seat 106. In some embodiments, the seat shell 120 may be a single, substantially solid or partially hollow structure defining the child seat back 124 and child seat pan and supporting a seat pad for the infant. In some embodiments, and as shown in FIG. 1B, the seat shell 120 may include a first seat shell rail 128 and a second seat shell rail 130 on respective opposing sides of the infant car seat 106. The seat shell rails 128, 130 may be placed in contact with the vehicle seat pan 112 when the infant car seat system 104 is installed to the vehicle seat 102 (e.g., as shown in FIG. 1B). In some configurations, the seat shell rails 128, 130 may have respective curved rocker bottoms 132, 134 to enable a rocking motion to comfort an infant when the infant car seat system 104 is used outside of a vehicle (e.g., in a home environment, restaurant, etc.).

The infant car seat 106 may include a carrying handle (not shown) coupled to opposing sides of the seat shell 120 (e.g., to the seat shell rails 128, 130) via respective attachment mechanisms 138, 140. In some configurations, the attachment mechanisms 138, 140 may allow the carrying handle to rotate with respect to the seat shell 120 to provide for access to the infant and/or to adjust an angle of the carrying handle and/or for storage thereof. In some embodiments, the attachment mechanisms 138, 140 may include integrated locking mechanisms to maintain the carrying handle at a desired orientation with respect to the seat shell 120.

As shown, the anchor system 108 of the infant car seat system 104 is mounted generally to a front lower portion of the seat shell 120. That is, the anchor system 108 is arranged at a forward end or side of the infant car seat system 104. In the illustrated example, the anchor system 108 is a rigid anchor system or is formed of various rigid components. This is in contrast to other embodiments, where the anchor system may be a belted or flexible anchor system and/or a combination of both rigid and belted/flexible anchor systems. However, as shown in the non-limiting embodiment of FIG. 1B, the anchor system 108 includes a pair of child seat anchors 142, 144 that are part of the infant car seat 106. Each child seat anchor 142, 144 is pivotably coupled to respective mechanical constraining points 146, 148 on the seat shell rails 128, 130 of the seat shell 120. Although two mechanical constraining points 146, 148 are shown on respective sides of the infant car seat 106, in other example implementations, the anchor system more generally may be coupled to the infant car seat at one or more mechanical constraining points that are not necessarily positioned on the side(s) of the infant car seat, and the illustrative configuration is only provided for illustrative and explanatory purposes.

The child seat anchors 142, 144 of the anchor system 108 may have an elongated shape (e.g., an oblong rectangle) and include a locking mechanism (e.g., a latch) that engages with corresponding vehicle lower seat anchors 150, 152 in or proximate to the seat bight 114 of the vehicle seat 102 at anchor points 154, 156, respectively. In this manner, the anchor system 108 may directly couple the infant car seat 106 to the vehicle seat 102 without using a detachable vehicle installation base and without using a vehicle seat belt. Additionally, the child seat anchors 142, 144 may include (or be coupled to) a release mechanism (e.g., a button, a knob, a slidable tab) to unlatch the child seat anchors 142, 144 from the vehicle lower seat anchors 150, 152 for removal of the infant car seat system 104 from the vehicle 100. In various implementations, the child seat anchors 142, 144 and the vehicle lower seat anchors 150, 152 may be configured to meet well-established safety standards and/or regulations, examples of which include, but not limited to, LATCH, ISOFIX, LUAS, and UCSS standards.

In accordance with some embodiments of the present disclosure, the child seat anchors 142, 144 may be configured and arranged, and the mechanical constraining point(s) 146, 148 for the anchor system 108 may be positioned for relatively easy engagement with the vehicle lower seat anchors 150, 152 located in or proximate to the seat bight 114 so as to facilitate installation of the infant car seat system 104 in the vehicle 100. Furthermore, the child seat anchors 142, 144 may be configured and arranged, and the mechanical constraining point(s) 146, 148 may be positioned, such that upon engagement of the child seat anchors 142, 144 with the vehicle lower seat anchors 150, 152, there is a tight fit between the infant car seat system 104 and the vehicle seat 102 (e.g., the installed infant car seat system passes the CPS “inch test”).

As shown in FIG. 1B, a center of gravity of the infant car seat 106 is located near an intersection of the seat back 124 and the seat pan of the infant car seat 106. The center of gravity of the infant car seat 106 approximately coincides with an axis 160 passing through the respective attachment mechanisms 138, 140 of the carry handle. As would be readily appreciated by one of skill in the art, the center of gravity of an object is a point from which the weight of a body or system may be considered to act (in uniform gravity, the center of gravity is the same as the center of mass of an object/system). In FIG. 1B, the axis 160 is taken to suitably approximate a projection of the center of gravity toward the respective sides of the infant car seat 106.

As shown in FIG. 1B, the first constraining point 146 for the first child seat anchor 142 and the second constraining point 148 for the second child seat anchor 144 are positioned closer to the front 116 of the infant car seat 106 than to the backside 118 of the infant car seat 106. In some embodiments, and as shown, the first constraining point 146 is positioned between the front 116 of the infant car seat 106 and the position of the first carrying handle attachment mechanism 138. Similarly, the second constraining point 148 is positioned between the front 116 of the infant car seat 106 and a position of the second carrying handle attachment mechanism 140. As shown, the first child seat anchor 142 has the first connection end 154 that is configured to mechanically engage with the first vehicle lower seat anchor 150 and defines a first anchor point when the infant car seat system 104 is installed in the vehicle 100, and the second child seat anchor 144 has a second connection end 156 that is configured to mechanically engage with the second vehicle lower seat anchor 152 and defines a second anchor point when the infant car seat system 104 is installed in the vehicle 100.

As shown in FIG. 1B, a line 162 is drawn to extend from the second carrying handle attachment mechanism 140, passing through the axis 160, and the second connection end 156 of the second child seat anchor 144, to the vehicle lower seat anchor 152. In accordance with some embodiments, the second constraining point 148 is positioned above the line 162. While not visible in the perspective view of FIG. 1B, a similar line may be drawn on the opposite side of the infant car seat 106 (i.e., to extend from the first carrying handle attachment mechanism 138, passing through the axis 160, and the first connection end 154 of the first child seat anchor 142, to the vehicle lower seat anchor 150), and the first constraining point 146 may be positioned above this line. The placement of the mechanical constraining points 146, 148 above these lines is based in part on improving crash performance and reducing injury criteria in consideration of the center of gravity 158, as well as ensuring a tight fit between the infant car seat system 104 and the vehicle seat 102.

As shown in FIG. 1B, the child seat anchors 142, 144 are operably coupled together by a rigid cross-member, similar to the configuration shown in FIG. 1D. This connection and coupling allow for the child seat anchors 142, 144 to be operated together, such that a rotation of the rigid cross-member may cause a rotation of both child seat anchors 142, 144. In other embodiments, the two child seat anchors 142, 144 may be connected by a rigid cross-member but may be independently rotatable relative to an axis passes through the rigid cross-member. These child seat anchors 142, 144 may be considered substantially rigid anchors, as they are not arranged on a webbing or belt and are fixed in position and relationship to the seat shell 120 and particularly with respect to the respective first seat shell rail 128 and second seat shell rail 130. Rigid connections may provide relatively simple and strong connections between the infant car seat system 104 and the vehicle seat 102. Further, as shown in FIG. 1B, the anchor system 108 is integrated into and/or attached directly to the infant car seat 106, rather than using a separate base, as may be present in other configurations.

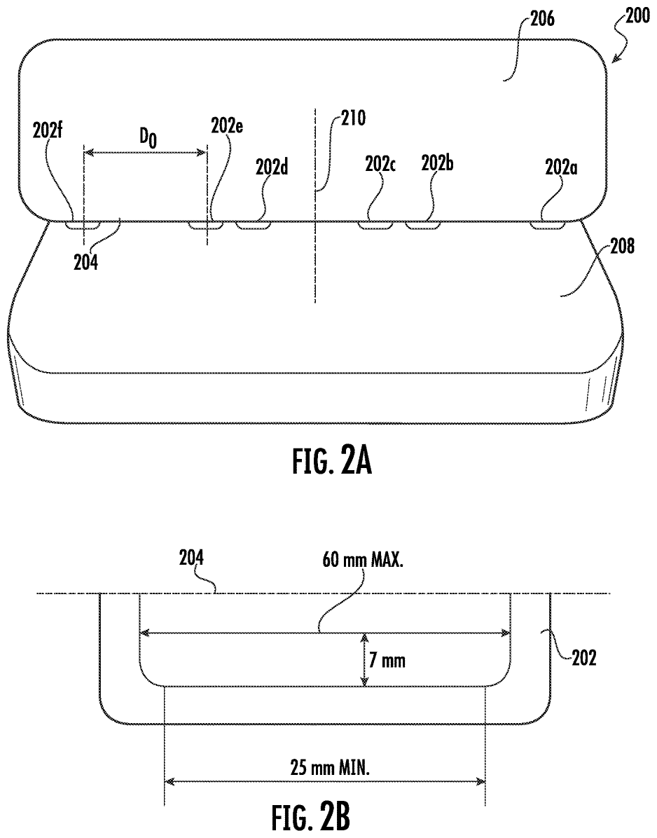

As noted, the seat anchors of an infant car seat system may be arranged to facilitate alignment with standard arrangements of vehicle lower seat anchor. For example, referring now to FIGS. 2A-2B, schematic illustrations of a vehicle seat 200 for receiving a child seat (e.g., infant child seat, convertible child seat) are shown. The vehicle seat 200 includes multiple vehicle lower anchors 202a-f. Although six vehicle lower seat anchor 202a-f are shown in this illustrative example, various other configurations can include more or fewer vehicle lower anchors without departing from the scope of the present disclosure.

In this illustrative example, the vehicle seat 200 includes three sets (pairs) of vehicle lower seat anchor 202a-b, 202c-d, and 202e-f. As shown, the respective pairs of vehicle lower seat anchor 202a-f are disposed in or proximate to a seat bight 204 of the vehicle seat 200 between a vehicle seat back 206 and a vehicle seat pan 208. Because the location of the vehicle lower seat anchor 202a-f is in or proximate to the seat bight 204 of the vehicle seat 200, an anchor system of an infant car seat system may be positioned on a front lower portion of the seat shell to facilitate a convenient connection with a pair of the vehicle lower seat anchor 202a-f.

In FIG. 2A, each pair of vehicle lower seat anchor 202a-b, 202c-d, and 202e-f corresponds to a particular seating position on the vehicle seat 200 (i.e., left (202a-b), center (202c-d), and right (202e-f) seating positions relative to a forward direction of a vehicle). The relative positions of the respective vehicle lower seat anchor 202a-f may be defined with respect to a centerline 210 of the vehicle seat 200. The centerline 210 may be defined as a seating reference point (SgRP) according to 49 CFR § 571.3. As shown, a nominal center-to-center distance Do between a pair of vehicle lower seat anchor left (202a-b), center (202c-d), and right (202e-f), at a given seating position is about 280 mm (i.e., D₀≈280 mm). Thus, the seat anchors in the anchor system of the infant child seat may be similarly arranged to have a center-to-center distance of about 280 mm.

FIG. 2B illustrates a magnified view of an individual vehicle lower seat anchor 202. As shown, the vehicle lower seat anchor 202 may be a U-shaped rail with a nominal width that ranges between about 25 mm and about 60 mm. The seat anchors of the anchor system of the infant child seat may be configured to attach to the smallest-sized vehicle lower seat anchor 202 to ensure compatibility across different vehicle seats 200 for different makes and/or models of vehicles.

In accordance with embodiments of the present disclosure, infant child seats and related systems are provided with improved anchoring mechanisms for securing the infant child seat to a vehicle seat. In accordance with some embodiments of the present disclosure, a rigid anchor system is integrated to an infant car seat and is integrated in a way that allows the infant child seat to be set to different recline positions or angles after installing into the vehicle. The anchor system, in accordance with some embodiments, is connected to a carry handle by a connecting link which may enable operation of the anchor system through movement or actuation of the carry handle. For example, in accordance with some embodiments, when a carry handle is rotated from a carry position to an anti-rebound position, the carry handle operation can draw the anchor connectors into the shell of the infant child seat, thus pulling the shell tighter to the vehicle seat. In other embodiments, operation or actuation of the anchor may be operated through direct manual operation and/or a handle or the like, as shown and described herein.

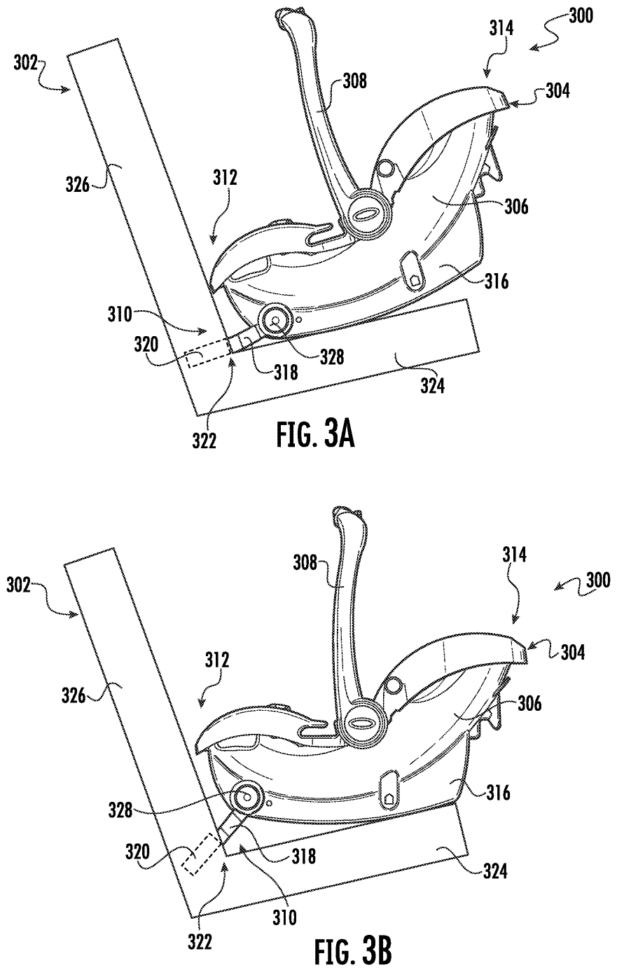

Referring now to FIGS. 3A-3B, schematic illustrations of an infant car seat system 300 in accordance with an embodiment of the present disclosure as installed on a vehicle seat 302 of a vehicle. The infant car seat system 300 includes an infant car seat 304 having a seat shell 306, a carry handle 308, and an anchor system 310. The infant car seat 304 has a front 312 and a back 314 arranged such that the infant car seat 304 is a rear-facing car seat. The seat shell 306 includes a seat shell rail 316 having a curved bottom with a second seat shell rail having a curved bottom being arranged opposite from the illustrated seat shell rail 316 (e.g., as shown in FIG. 3B). It will be appreciated that the seat shell rails can have a flat or linear bottom. The anchor system 310 includes a latch arm 318 with a latching or anchoring mechanism at a distal end for engagement with a vehicle lower anchor 320. The vehicle lower anchor 320 is arranged in a seat bight 322 of the vehicle seat 302. The seat bight 322 is defined at an intersection or connection between a vehicle seat pan 324 and a vehicle seat back 326.

As shown in FIGS. 3A-3B, the infant car seat system 300 is adjustable with respect to an orientation relative to the vehicle seat pan 324 and vehicle seat back 326. In FIG. 3A, the infant car seat 304 has a forward tilt or inclination and in FIG. 3B, the infant car seat 304 has a rearward tilt or inclination. This tilting, inclining, reclining, and adjustment of relative angle and orientation may be adjustable and selectively fixed at a desired angle of inclination. This adjustability, in accordance with the non-limiting example embodiment of FIGS. 3A-3B, is provided by the anchor system 310. The anchor system 310 includes the latch arms 318 that are rotatably coupled to the infant car seat 304 by respective latch attachment mechanisms 328. The latch attachment mechanisms 328 may be configured to connect the latch arms 318 to the infant car seat 304, while permitting selective rotation of the latch arms 318. For example, the latch attachment mechanisms 328 may be lockable and unlockable in one or more positions/orientations. In FIG. 3A, the infant car seat system 300 is shown in a first position or orientation, with the infant car seat 304 arranged in the most upright orientation, whereas in FIG. 3B, the infant car seat system 300 is shown in a second position or orientation, with the infant car seat 304 arranged in the most reclined orientation.

The latch attachment mechanism 328, in accordance with embodiments of the present disclosure, may include one or more elements to allow for rotation of the respective latch arm 318. In some configurations, in an unlocked state, the latch arm 318 may be freely rotatable (e.g., 360-degree rotation). In other embodiments, in the unlocked state, the latch arm 318 may have a limited range of rotation (e.g., less than 360-degree rotation, such as, for example, 120-degree rotation). The rotation is defined about an axis through the latch attachment mechanism 328 (e.g., in to-out of the page of FIGS. 3A-3B). In this configuration, although rotatable about the axis through the latch attachment mechanism 328, the latch attachment mechanism 328 is otherwise fixed in position relative to the seat shell 306 and/or the seat shell rail 316. In this illustrative configuration, the latch attachment mechanism 328 is attached to the infant car seat 304 on the seat shell rail 316, however, in other embodiments, the latch attachment mechanism 328 may be fixed to a portion of the seat shell 306 that is not a seat shell rail (e.g., higher up than the position shown in FIGS. 3A-3B relative to a bottom of the infant car seat 304).

In the unlocked state, the latch attachment mechanism 328 may permit free or relatively free rotation and orientation angle adjustment of the latch arm 318 (relative to the seat shell 306). However, when a desired angle or orientation is selective, such as by adjusting the angle of the latch arm 318, the latch attachment mechanism 328 may be locked into position and enter a locked state where the latch arm 318 is no longer rotatable relative to the infant car seat 304. Various types of locking mechanisms may be employed without departing from the scope of the present disclosure. For example, and without limitation, locking mechanisms may include toothed or geared configurations, detent pins, clamps, quick release mechanisms, lockable angle adapters, or the like.

When a latch of the latch arm 318 is connected to the vehicle lower anchor 320, the latch arm 318 becomes fixed in place, but may be pivotable about the connection with the vehicle lower anchor 320. When the latch attachment mechanisms 328 is fixed at a particular angle (e.g., locked), the infant car seat 304 may be locked and secured to the vehicle seat 302. That is, when the anchors of the latch arm 318 lock in position with the vehicle lower anchor 320, the infant car seat 304 is held and supported by the latch 318 and the vehicle lower anchor 320, in the various incline and recline positions discussed above. Stated another way, by locking the latch attachment mechanisms 328 at a desired angle, the infant car seat 304 may be secured in such a desired angle when installed to the vehicle seat 302 and held in such place due to the latch arm 318 be fixed in angular position relative to the seat shell 306.

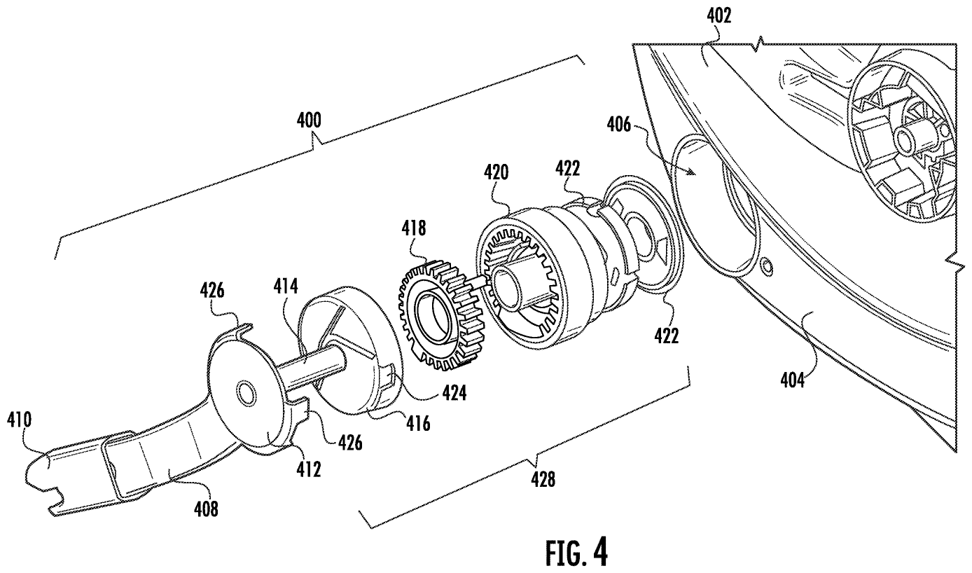

Referring now to FIG. 4, a schematic illustration of components of an anchor system 400 in accordance with an embodiment of the present disclosure are shown. In FIG. 4, the components and elements of the anchor system 400 are shown in separated or exploded illustration. The anchor system 400 is configured to be mounted to a seat shell 402 and/or a seat shell rail 404 of an infant car seat. In this illustrative configuration, the anchor system 400 is configured to be installed into a mounting aperture 406 that is formed in the seat shell rail 404, although the location of such mounting aperture 406 is not limited to the illustrative location and may be formed in the seat shell 402 or other locations along the seat shell rail 404.

The anchor system 400 includes a latch arm 408 having a latch 410 arranged at a distal end thereof. The latch 410 may be configured to releasably connect or attach to a vehicle anchor system, such as described above. The latch arm 408 includes a latch arm hub 412 that is rotatably mounted to a hub shaft 414. In some embodiments, the hub shaft 414 may be integrally formed with the latch arm hub 412. The anchor system 400 further includes, as shown in FIG. 4, a recline hub 416, a recline gear 418, a memory hub 420, and one or more ramp hubs 422. A latch attachment mechanism 428 of this configuration, includes the recline hub 416, the recline gear 418, the memory hub 420, and the one or more ramp hubs 422. Each of the recline hub 416, the recline gear 418, the memory hub 420, and the one or more ramp hubs 422 may have a central aperture or through hole through which the hub shaft 414 may extend. As such, in some embodiments, the recline hub 416, the recline gear 418, the memory hub 420, and the one or more ramp hubs 422 may be mounted to or supported on the hub shaft 414. In other embodiments, one or more of these components may be arranged to permit the hub shaft 414 to pass therethrough, without direct contact or engagement, and in some such configurations, the hub shaft 414 may operate to secure alignment of components but may not provide other operational functionality.

The arrangement of the anchor system 400 is configured such that the latch arm 408 is rotatable or pivotable about an axis (e.g., defined by the hub shaft 414). Further, the arrangement of the anchor system 400 secures or mounts the components of the anchor system 400 within the mounting aperture 406 on the infant car seat (on the seat shell 402 and/or the seat shell rail 404). The recline gear 418 is configurated as a sliding gear that locks the position of the latch arm 408 in one or more positions (e.g., four positions). As the angular position of the latch arm 408 changes, the recline of the back of the infant car seat will change relative to a vehicle seat. That is, the anchor system 400 is configured to allow adjustment of a recline angle or orientation of an associated infant car seat. For example, the anchor system 400 may be configured to permit rotation about the axis defined by the hub shaft 414 to change an angle of orientation of the latch arm 408, to achieve, at least, the first position (e.g., FIG. 3A) and the second position (e.g., FIG. 3B) and lock the system in such orientations. In some embodiments, other positions, such as between the first position and the second position may be selected and locked into position to secure a desired angle of inclination or recline. Further, in some embodiments, the rotation of the latch arm 408 may be greater or beyond the angles of the first position and the second position.

As shown in FIG. 4, the recline hub 416 includes one or more recesses 424. Further, the latch arm hub 412 includes one or more corresponding protrusions 426. The recesses 424 and the protrusions 426 may engage or interact with each other such that a rotational force may be applied from the latch arm 408 to the recline gear 418 and/or the ramp hubs 422 (or vice versa). For example, in a manual operation, a user (e.g., caregiver) may manually rotate the latch arm 408 which will cause the components of the anchor system 400 to interact with each other, such as slide along inclines/ramps, to impart a force on the infant car seat and thus adjust an angle of orientation of the latch arm 408 relative to the infant car seat.

As noted above, the latch attachment mechanism 428 includes the recline hub 416, the recline gear 418, the memory hub 420, and the one or more ramp hubs 422. The latch attachment mechanism 428 may be configured to transition the latch arm 408 between, at least, a stowed position, a first use position, and a second use position. Further, the latch attachment mechanism 428 may be configured to transition to either one of the first use position and the second use position from the stowed position based on a recent previous use position. That is, the memory hub 420 may be configured to retain the recent previous use position such that switching from the stowed position to a use position will result in the recent previous use position being transitioned into (i.e., return to the first or second use position, based on a last used use position).

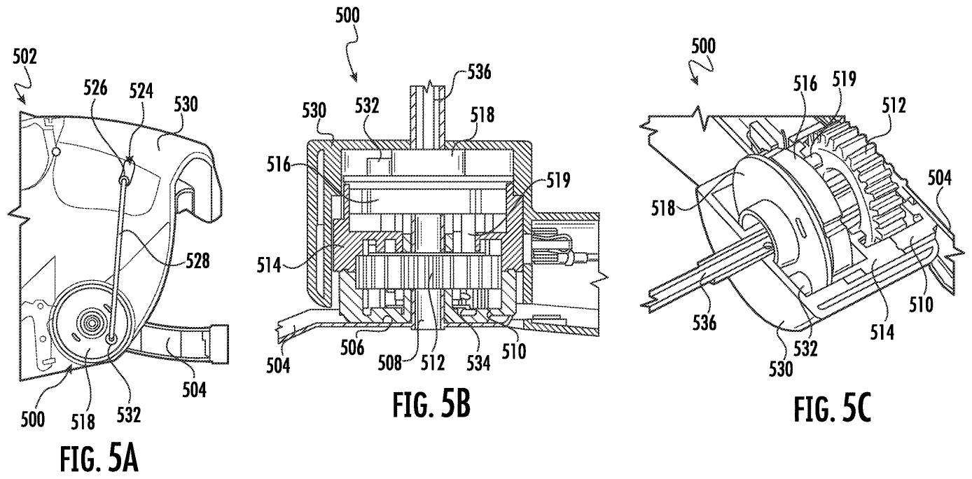

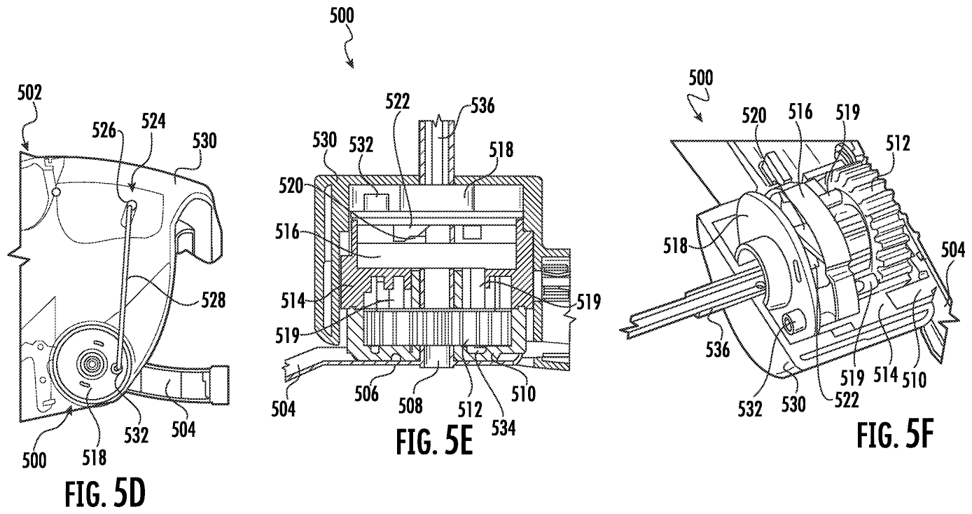

Referring now to FIGS. 5A-5F, schematic illustrations of a locked state (FIGS. 5A-5C) and an unlocked state (FIGS. 5D-5F) of an anchor system 500 in accordance with an embodiment of the present disclosure are shown. The anchor system 500 is similar to that shown and described with respect to FIG. 4. The anchor system 500 is arranged within and operably coupled to an infant car seat 502 (FIGS. 5A, 5D). The infant car seat 502 may be arranged and configured as shown and described above or may take other shapes, configurations, or arrangements, without departing from the scope of the present disclosure.

The anchor system 500 includes a latch arm 504 having a latch arranged at a distal end thereof to releasably connect or attach to a vehicle anchor system. The latch arm 504 includes a latch arm hub 506 that is rotatably mounted to a hub shaft 508. In some embodiments, the hub shaft 508 may be integrally formed with the latch arm hub 506. The anchor system 500 further includes a recline hub 510 that is configured to engage with a portion of the latch arm hub 506 to impart rotational force between the two elements (e.g., by means of engagement of protrusions with recesses, such as shown and described with respect to FIG. 4). The recline hub 510 is configured to freely rotate. A recline gear 512 is arranged to fit within the recline hub 510 and may cause rotation of the recline hub 510 (or may receive rotational force from a rotation of the recline hub 510). The recline gear 512 is configured to move axially relative to the recline hub 510 (e.g., along the hub shaft 508) and the recline gear 512 is configured to selectively engage with the recline hub 510. In an engaged state, the recline gear 512 is engaged with the recline hub 510 and rotation of one will cause rotation of the other. In a disengaged state, the recline gear 512 is engaged with the recline hub 510 and also a memory hub 514. The memory hub 514 may be fixed relative to the infant car seat (e.g., not rotatable about the hub shaft 508). Because of the fixed position or state of the memory hub 514, when the recline gear 512 is in the disengaged state from the recline hub 510, the recline gear 512 will engage, at least partially, with the memory hub and lock rotation of the recline gear 512, which in turn prevents rotation of the recline hub 510 and in turn prevents rotation of the latch arm 504. That is, in the disengaged state of the recline gear 512 relative to the recline hub 510, the angle of orientation of the latch arm 504 is locked or fixed. FIGS. 5A-5C illustrate the locked state of the anchor system 500, with the recline gear 512 engaged with both the recline hub 510 and the memory hub 514, thus resulting in a locked state of the latch arm 504. FIGS. 5D-5F illustrated the unlocked state of the anchor system 500, with the recline gear 512 engaged only with the recline hub 510 and not the memory hub 514, and thus the latch arm 504 is in an unlocked state and is free to rotate relative to the infant car seat.

The recline gear 512 is axially movable by application of axial force applied to the recline gear 512. The axial force, in this illustrative configuration, is applied through the operation of a first ramp hub 516 and a second ramp hub 518. The first ramp hub 516 may be fixedly coupled to the recline gear 512 by one or more posts 519. As such, when the first ramp hub 516 is moved axially (e.g., relative to the hub shaft 508), the first ramp hub 516 will urge the recline gear 512 to also move axially therewith. The axial movement of the first ramp hub 516 is caused by rotation of and interaction with the second ramp hub 518. To cause the axial movement, the first ramp hub 516 includes one or more respective first ramps 520 and the second ramp hub 518 includes one or more respective second ramps 522 (e.g., as shown in FIGS. 5E-5F). When the second ramp hub 518 is rotated, the second ramps 522 will interact with the first ramps 520 of the first ramp hub 516 and cause the first ramp hub 516 to axially move away from the second ramp hub 518 (e.g., along the hub shaft 508 and/or an axis defined thereby). As the first ramp hub 516 moves axially away from the second ramp hub 518, the first ramp hub 516 will urge the recline gear 512 to also move axially by applying an axial force to the posts 519. This axial movement will urge the recline gear 512 into engagement with the recline hub 510 and out of (partial) engagement with the memory hub 514, and thus permit rotation of the recline gear 512, the recline hub 510, and the latch arm 504.

As such, it is the rotation of the second ramp hub 518 that causes actuation or operation of the anchor system 500. The rotation of the second ramp hub 518 may be caused by an incline actuator 524. The incline actuator 524, in this illustrative configuration, includes an incline switch 526 and a switch link 528 that operably connects and couples the incline switch 526 to the second ramp hub 518. The incline switch 526 may be movably mounted to a seat shell 530. Similarly, the switch link 528 may be arranged within the seat shell 530 to provide protection thereto. The switch link 528 connects to the second ramp hub 518 at a hub connector 532.

As shown, the recline gear 512 may be biased toward the locked state (FIGS. 5A-5C) by means of a hub biasing element 534. As shown in FIG. 5B, the hub biasing element 534 is extended such that the recline gear 512 is positioned in engagement with both the memory hub 514 and the recline hub 510. When the incline switch 526 is operated or actuator, the switch link 528 will apply a force to the second ramp hub 518 and cause rotation thereof. The rotation of the second ramp hub 518 will urge the first ramp hub 516 axially toward the recline hub 510 and cause the recline gear 512 by means of the posts 519 out of engagement with the memory hub 514 and into full engagement with the recline hub 510, as shown in FIG. 5E. During this transition, the hub biasing element 534 will be compressed between the recline gear 512 and the recline hub 510. As such, the latch arm 504 may be freely rotated relative to the seat shell 530. When the latch arm 504 is positioned as desired, the hub biasing element 534 may urge the recline gear 512 back into engagement with the memory hub 514 (FIG. 5B), thus locking the latch arm 504 in the desired position.

Also shown in FIGS. 5A-5F, is a linking shaft 536. The linking shaft 536 may extend through the seat shell 530 and operably connect to a second anchor system on the opposite side of the seat shell 530 (e.g., similar in configuration to that shown in FIG. 1B). In some embodiments, a single incline actuator 524 may be provided on one side of the seat shell 530, with operation or actuation of the single incline actuator 524 causing operation (locking and/or unlocking) of the two connected anchor systems. In other embodiments, each side of the seat shell 530 may include a respective incline actuator 524 that is coupled to a respective anchor system 500, with independent operation and/or simultaneous operation of the two anchor systems.

In operation, when the recline gear 512 is engaged with the recline hub 510 and disengaged from the memory hub 514, the free rotation of the latch arm 504 is possible. The latch arm 504 and the seat shell 530 are thus rotationally decoupled. As a result, if the latch arm 504 is arranged in contact with a vehicle seat and/or engaged with a vehicle seat latch (e.g., as shown in FIGS. 3A-3B), then relative rotation between the latch arm 504 and the seat shell 530 will cause the seat shell 530 to adjust the relative relationship with a vehicle seat (e.g., transitioning from position in FIG. 3A to position in FIG. 3B). That is, the latch arm 504, when connected to a vehicle seat latch, will define a fixed connection, and thus the angle adjustment at the respective anchor system 500 will cause adjustment of the orientation of the seat shell 530 relative to the vehicle seat.

In accordance with some embodiments of the present disclosure, the recline mechanism may be split into two layers of freedom. For example, with reference against to FIGS. 5A-5F, in accordance with another configuration, the recline gear mechanism (e.g., recline gear 512) may be configured to lock an angular position of the recline hub 510 and latch arm 504 relative to the memory hub 514. In this alternative embodiment, the memory hub 514 may be configured to freely rotate relative to the seat shell 530 (rather than being fixed thereto). Because the recline hub 510 can be positionally locked to the memory hub 514 by the recline gear 512 (axial movement as described above), when the memory hub 514 rotates, the recline hub 510 will rotate with it, and when the memory hub 514 is locked, the recline hub 510 is locked with it. In such a configuration, the memory hub 514 can be locked to the seat shell 530 in different angular positions. In some embodiments, the memory hub 514 may be configured to be locked to the seat shell 530 in a stowed position, a first use position, and a second use position.

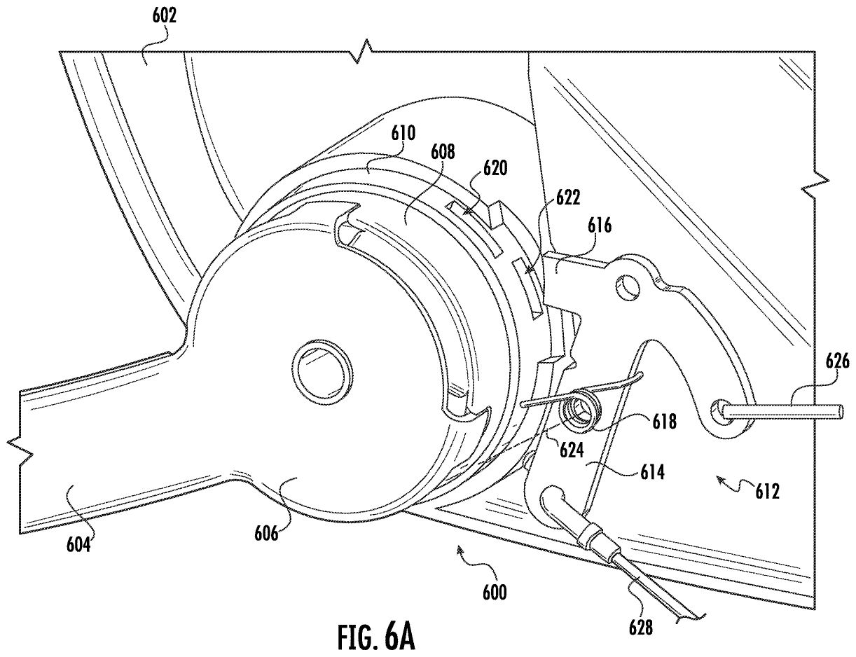

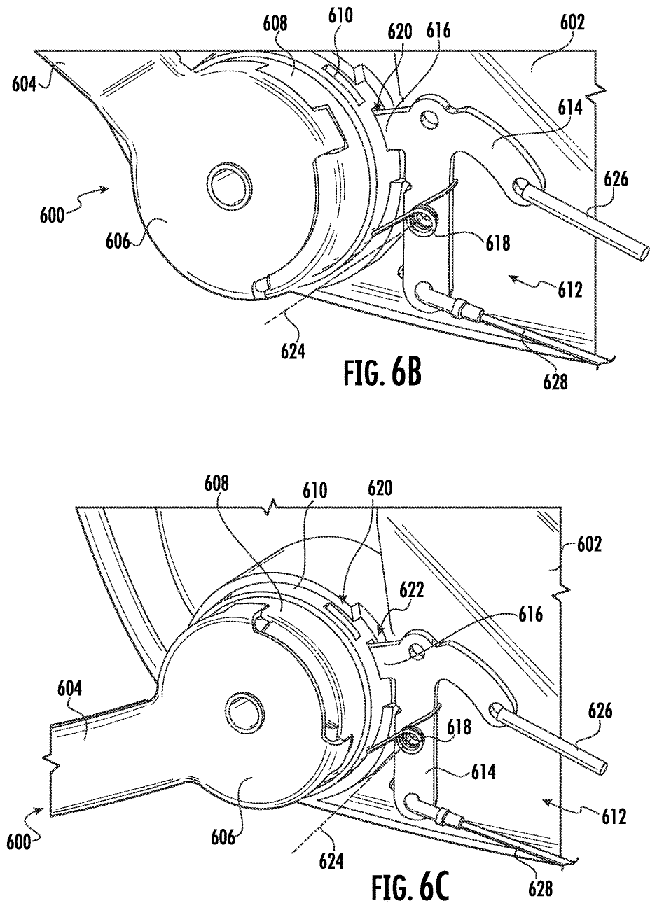

Referring now to FIGS. 6A-6C, schematic illustrations of an anchor system 600 in accordance with an embodiment of the present disclosure are shown. FIG. 6A illustrates the anchor system 600 in an unlocked state, FIG. 6B illustrates the anchor system 600 in a first locked state (e.g., stowed position), and FIG. 6C illustrates the anchor system 600 in a second locked state (e.g., use position). The anchor system 600 may be similar to that shown and described with respect to FIGS. 3, 4, and 5A-5F, with additional or alternative features and/or operation as described herein. The anchor system 600 is arranged within and operably coupled to a seat shell 602 of an infant car seat. The infant car seat may be arranged and configured as shown and described above or may take other shapes, configurations, or arrangements, without departing from the scope of the present disclosure. The anchor system 600 includes a latch arm 604 extending from a latch arm hub 606. Similar to the above-described embodiments, the anchor system 600 includes a recline hub 608 and a memory hub 610. A recline gear may be arranged within and/or between the recline hub 608 and the memory hub 610. In this configuration, the memory hub 610 is arranged to be rotatable relative to the seat shell 602. The anchor system 600 may further include various elements not shown, such as ramp hubs, actuators, switches, connectors, links, and the like.

As described above, the latch arm 604 is rotatable about a shaft or axis, that passes through the anchor system 600. FIG. 6B illustrates the latch arm 604 rotated and locked into a stowed position and FIG. 6C illustrates the latch arm 604 rotated and locked into a use position. Each of these positions (stowed and use) may be fixed or locked when it is desired to not have the latch arm 604 rotate (e.g., when the infant car seat is in use in a vehicle or when the infant car seat is removed from the vehicle). As noted, FIG. 6A illustrates the anchor system 600 in an unlocked state, which allows for free movement of the latch arm 604 (e.g., between the stowed and use positions). That is, it may be desirable to have the latch arm 604 movable or rotatable during installation and adjustment of the infant car seat in a vehicle, but once a desired position or orientation is set, it may be desirable to secure and lock the latch arm 604 in the desired position or orientation.

The anchor system 600, shown in FIGS. 6A-6C, is split into two degrees of freedom. The first degree of freedom is similar to that described above with respect to FIGS. 5A-5F, where a recline gear is configured to axially move within the anchor system 600 and lock the angular position of the recline hub 608 and latch arm 604 relative to the memory hub 610. In this embodiment, the memory hub 610 is arranged to freely rotate relative to the seat shell 602. Because the recline hub 608 can be positionally locked to the memory hub 610 by the recline gear, when the memory hub 610 rotates, the recline hub 608 rotates with it, and when the memory hub 610 is locked, the recline hub 608 is locked with it. The memory hub 610 can be locked to the seat shell 602 in different angular positions. In this embodiment, the memory hub 610 is configured to be locked to the seat shell 602 in a use position (FIG. 6B) and a stowed position (FIG. 6A). The memory hub 610 is locked to the seat shell 602 by means of a locking mechanism 612.

In this illustrative embodiment, the locking mechanism 612 includes a locking plate 614 having a locking tooth 616 and a locking biasing element 618. The locking biasing element 618 is configured to bias the locking plate 614 toward a locking position (shown in FIGS. 6B-6C). In the locking position, the locking tooth 616 engages with a part of the memory hub 610 to rotationally fix the position of the memory hub 610. For example, as shown, the memory hub 610 has a first locking recess 620 corresponding to the stowed position (FIG. 6B) and a second locking recess 622 corresponding to the use position (FIG. 6C).

When the memory hub 610 is rotated to either position, the locking tooth 616 on the locking plate 614 will engage with one of the recesses 620, 622, locking the memory hub 610 in that angular position. The locking plate 614 is configured to rotate about a pivot 624 on an axis on the seat shell 602. The locking plate 614 is connected to a release handle (not shown) on a rear of the seat shell 602 (e.g., for manual operation). In some configurations, such a release handle may also be linked to a mechanism to release the anchor engagement of the latch arms from a vehicle anchor. When such a release handle is actuated, the release handle pulls the locking tooth 616 of the locking plate 614 out of a recess 620, 622 in the memory hub 610. With the locking plate 614 disengaged from the memory hub 610, the memory hub 610 is free to rotate (e.g., from one position to another). In the stowed position (FIG. 6B), the locking tooth 616 of the locking plate 614 engages with the first recess 620 on the memory hub 610, locking the memory hub 610 in the stowed position. In the use position (FIG. 6C), the locking tooth 616 of the locking plate 614 engages with the second recess 622 on the memory hub 610, locking the memory hub 610 in the use position.

A user or caregiver may release or deploy the latch arm 604 from the stowed position (FIG. 6B) to the use position (FIG. 6C) by actuating the release handle. Operation of the release handle will disengage the locking tooth 616 of the locking plate 614 from the memory hub 610, allowing the memory hub 610, recline hub 608, the latch arm hub 606, and the latch arm 604 (having a latch connector at an end thereof) to rotate to the use position (FIG. 6C). In accordance with some embodiments of the present disclosure, during such a transition from the stowed position to the use position, at no point does the angular position of the recline hub 608, relative to the memory hub 610, change. When the memory hub 610 locks back into the use position (FIG. 6C), for example, the recline hub 608, the latch arm hub 606, and the latch arm 604 are in the same recline position as a previous or last use.

As illustratively shown in FIGS. 6A-6C, the locking mechanism 612 may have one or more release connectors connected thereto. For example, a first release connector 626 may connect the locking plate 614 to a hub release handle (not shown) that is configured to allow manual operation of the locking mechanism 612 (e.g., engaging or disengaging the locking tooth 616 from a respective recess 620, 622). A second release connector 628 may be configured to operate a latch at a distal end of the latch arm 604 to allow for disengagement from connection to a vehicle seat.

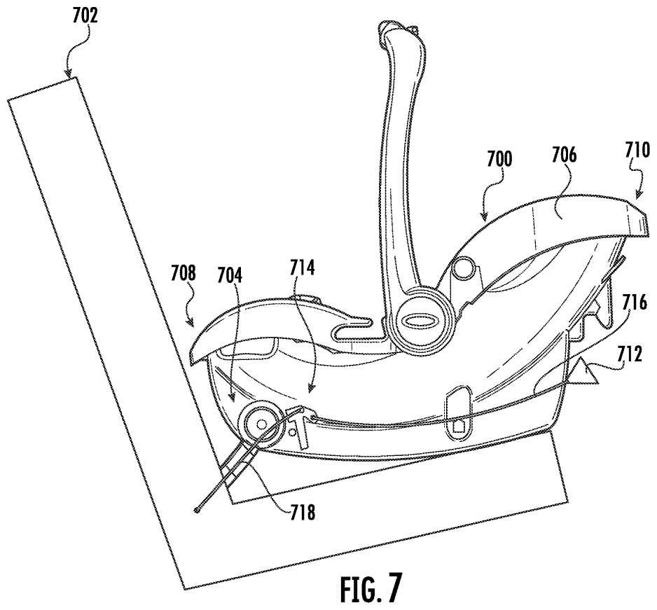

Referring now to FIG. 7, a schematic illustration of an infant car seat 700 in accordance with an embodiment of the present disclosure, as arranged on a vehicle seat 702, is shown. The infant car seat 700 may be configured substantially similar to the embodiments described herein, having an adjustable and lockable anchor system 704 mounted to a seat shell 706 of the infant car seat 700. The infant car seat 700 has a front 708 and a back 710 arranged such that the infant car seat 700 is a rear-facing car seat. In this illustrative configuration, the anchor system 704 includes a first release actuator, such as a release handle 712 (e.g., hub release handle) that is operably coupled to a locking mechanism 714 by a respective first release connector 716. Furthermore, in this embodiment, a second release connector 718 is provided to operably connect the locking mechanism 714 to a latch or similar structure at an end of the anchor system 704 (e.g., a portion that engages with a vehicle lower anchor) by a second release connector 718. In some embodiments, the second release connector 718 may be operated by actuation of the first release handle 712. In other embodiments, a second release handle may be provided (e.g., at the back 710 and/or along a side of the seat shell 706) for operating the second release connector 718.

Similar to the embodiment described with respect to FIGS. 6A-6C, the locking mechanism 714 may include one or more biased members that are biased toward a locking, locked, or engaged position (e.g., with a memory hub of the anchor system 704). By pulling on or otherwise actuating the first release handle 712, the locking mechanism 714 may be actuated out of the locked or engaged position, to thus allow the anchor system 704 to rotate relative to the seat shell 706. As shown, the first release handle 712 is arranged at the back 710 of the seat shell 706 opposite the location of the anchor system 704 and is connected thereto by the first release connector 716.

Such an arrangement of the release handle 712 may improve ease of use for a caregiver. For example, the infant car seat 700 may be positioned on the vehicle seat 702 and the anchor system 704 may be securely engaged with a vehicle latch system that is part of the vehicle seat 702. Once attached, the caregiver can adjust an angle of incline/recline by operating the first release handle 712 to allow for rotational movement between the seat shell 706 and the anchor system 704 and thus adjust the reclined angle of the seat shell 706 (e.g., comparing FIG. 3A and FIG. 3B). When the desired position is set, the caregiver may release the first release handle 712 to thus lock the anchor system 704 into the desired orientation. When the caregiver desires to remove the infant child seat 700 from the vehicle, the caregiver may operate the release handle 712 (or a second release handle) to disengage a latched connection with a vehicle lower anchor and thus allow removal of the infant car seat 700.

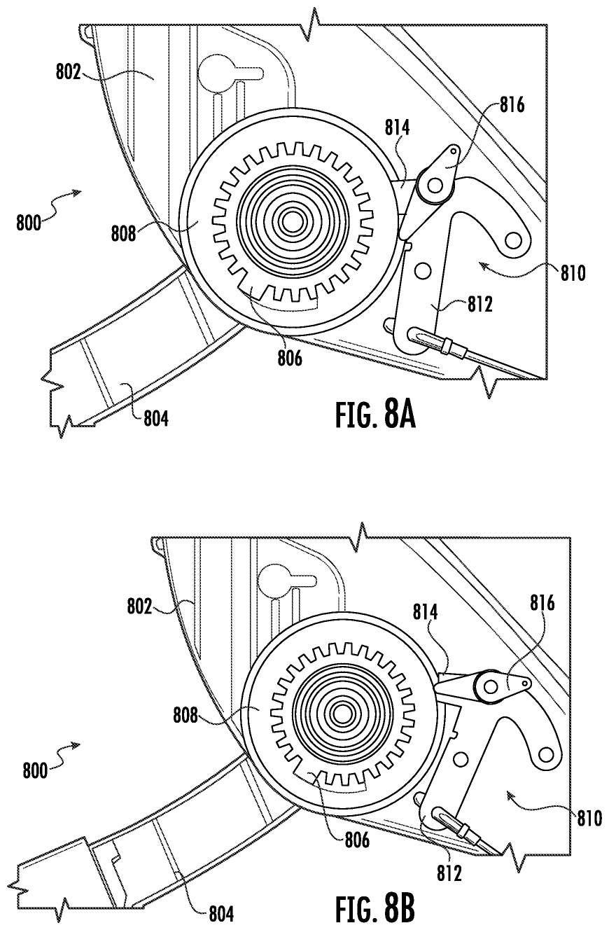

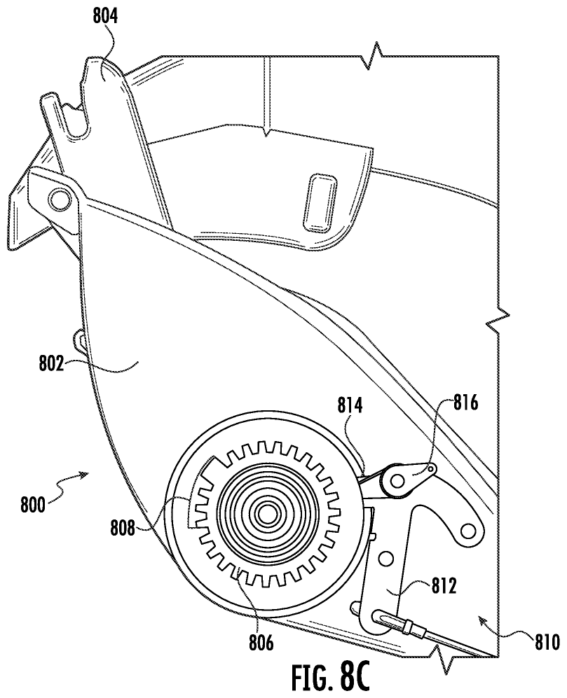

Referring now to FIGS. 8A-8C, schematic illustrations of an anchor system 800 in accordance with an embodiment of the present disclosure are shown. The anchor system 800 may be similar to that shown and described above. For example, the anchor system 800 is installed to a seat shell 802 and includes a latch arm 804 extending from a latch arm hub. Similar to the above-described embodiments, the anchor system 800 includes a recline gear 806 and a memory hub 808, along with other components as shown and described above but not shown for clarity in FIGS. 8A-8C. The recline gear 806 may be arranged within and/or between a recline hub and the memory hub 808, as shown and described above. In this configuration, the memory hub 808 is arranged to be rotatable relative to the seat shell 802. The anchor system 800 may further include various elements not shown, such as ramp hubs, actuators, switches, connectors, links, and the like. A locking mechanism 810 is provided to operate with the anchor system 800.

The locking mechanism 810 includes a locking plate 812 having a locking tooth 814 and a locking biasing element (not shown). The locking plate 812 is pivotably coupled to the seat shell 802. The locking plate 812 is operably connected between a release handle and the latch arm 804. In some configurations, activation of the release handle causes the locking plate 812 to pivot and release engagement between the latch (at the end of the latch arm 804) and a vehicle anchor system to thereby release a connection to a vehicle seat. The activation of the release handle may also provide a mechanism to release the latch arm 804 to move between the stowed position (FIG. 8C) and the use position(s) (FIGS. 8A-8B). When the latch arm 804 is moved between the stowed position and the use position, the memory hub 808 may be configured to move with the latch arm 804. Further, the anchor system 800 includes an incline actuator (e.g., recline gear 806), with the incline actuator being operably coupled to the memory hub 808 and the latch arm 804 such that actuation of the incline actuator allows the latch arm 804 to rotate relative to the memory hub 808 to set an angle of inclination of the latch arm 804 relative to the seat shell 802.

The locking biasing element (not shown) is configured to bias the locking plate 812 toward a locking position (shown in FIG. 8A). In the locking position, the locking tooth 814 engages with a part of the memory hub 808 to rotationally fix the position of the memory hub 808, as described above. In the locked state (FIG. 8A), the locking tooth 814 of the locking plate 812 will lock the memory hub 808 to the seat shell 802, such as in the deployed position as shown in FIG. 8A. When it is desired to move the latch arm 804 from the deployed state (e.g., FIG. 8A) to a stowed state (e.g., FIG. 8C), the locking mechanism 810 may be operated (e.g., as described with respect to FIG. 7), to disengage the locking tooth 814 from the memory hub 808 (e.g., FIG. 8B).

When the locking mechanism 810 is operated, and the locking tooth 814 disengages from the memory hub 808, the latch arm 804 will be free to rotate (e.g., from the deployed state to the stowed state). In this embodiment, to prevent the locking mechanism 810 to automatically re-engage with the memory hub 808, the locking mechanism 810 may include a toggle 816. For example, after a release handle is activated to operate the locking mechanism 810, the toggle 816 may rotate and block the locking tooth 814 from re-engaging with the memory hub 808, allowing the latch arms 804 to pivot to the stowed position without re-activating the release handle. When the latch arm 804 is rotated to the desired position (e.g., stowed position shown in FIG. 8C), a user may operate release handle and/or the toggle 816 to re-engage the locking tooth 814 with the memory hub 808 to lock the latch arm 804 in the stowed state. A similar operation may be performed to release the latch arm 804 from the stowed state and allows for transitioning to the deployed state. The memory hub 808 may be configured such that the specific orientation of the latch arm 804, in the deployed state, may be set and not adjusted during the transition from the deployed state to the stowed state, and thus the memory hub 808 may provide a memory or ability to return to the specific angle of the deployed state, without requiring adjustment each time the latch arms 804 are deployed.

As shown in FIGS. 8A-8B, the anchor system 800 is shown in a use position, where a latch of the anchor system 800 is moveable and/or operable for engagement with a vehicle seat anchor or the like. In contrast, FIG. 8C, for example, illustrates the anchor system 800 in a stowed position. The anchor system 800 is configured to be locked or fixed into the use or stowed positions, based on a user preference and the specific state or use of the infant car seat, as will be appreciated by those of skill in the art. A release handle maybe operably coupled to the locking mechanism 810 for selective operation of the anchor system 800, such as for locking the anchor system 800 in a use position (FIGS. 8A-8B) and/or a stowed position (FIG. 8C). In the use position of the latch arm 804, the latch arm 804 is selectively fixable in two or more angles relative to the seat shell 802. The anchor system 800 includes the memory hub 808 that is configured to set an angle of recline of the infant car seat based on two or more angles in which the memory hub 808 may be set.

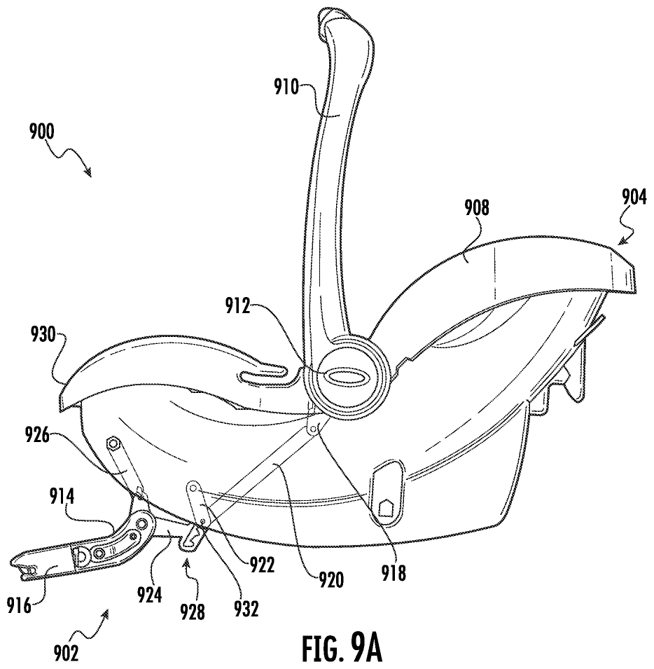

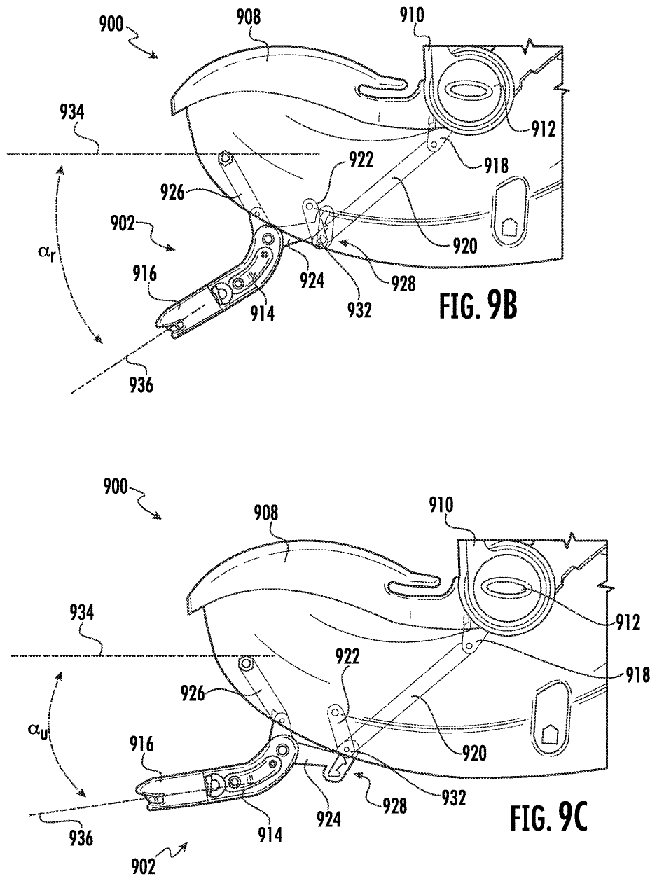

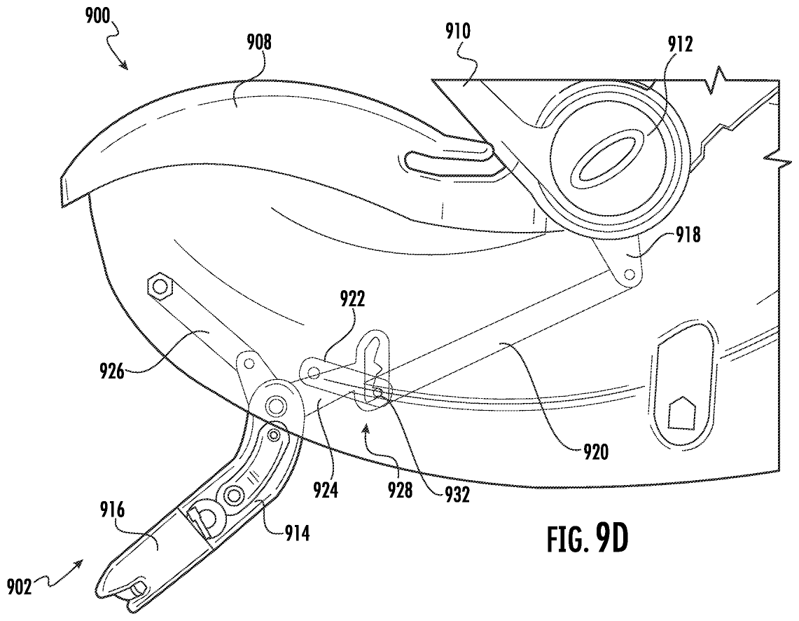

Referring now to FIGS. 9A-9D, schematic illustrations of an infant car seat system 900 in accordance with an embodiment of the present disclosure are shown. The infant car seat system 900 may be similar to that shown and described above and may have an anchor system 902 that is configured to enable adjustment of an infant car seat 904 even after the infant car seat 904 is installed on a vehicle seat. The infant car seat 904 includes a seat shell 908 and a carry handle 910 that is operably coupled to the seat shell 908 and is adjustable in angle relative to the seat shell 908 through an attachment mechanism 912 that rotationally couples the carry handle 910 to the seat shell 908.

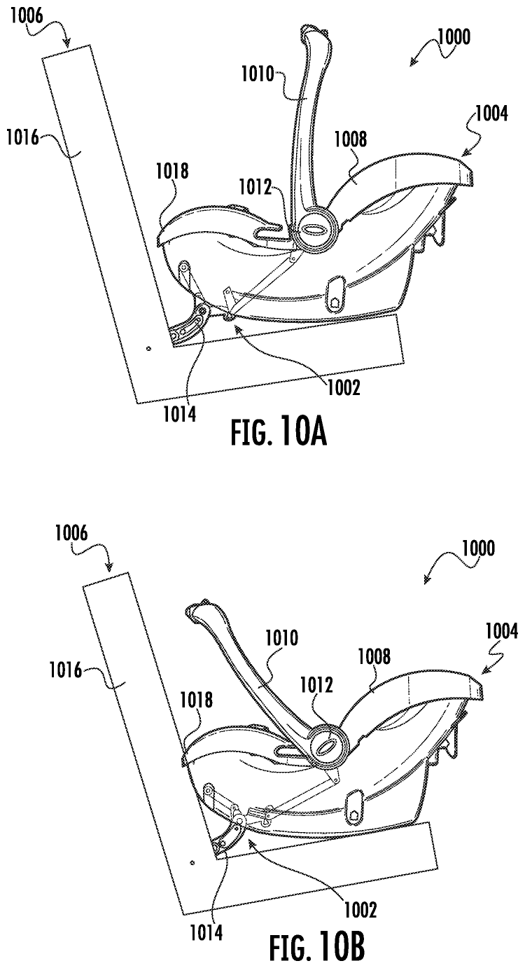

In this embodiment, the anchor system 902 is operably connected to the carry handle 910. The connection between the carry handle 910 and the anchor system 902 allows for movement of the carry handle 910 to cause movement and/or operation of the anchor system 902 (e.g., movement of the latch arm 914 and latch 916) relative to the seat shell 908. The anchor system 902 includes a latch arm 914 having a latch 916 arranged at a distal end thereof. The latch 916 may be configured to releasably connect or attach to a vehicle anchor system, such as described above (e.g., see FIGS. 10A-10B for a similar configuration as installed to a vehicle seat). The latch arm 914 is operably coupled to the carry handle 910 through a set of linkages that allow for operation of the carry handle 910 to cause movement and/or adjustment of the latch arm 914. For example, when the latch 916 is engaged and secured to a vehicle anchor system and locked in place, operation of the carry handle 910 will cause the seat shell 908 to move because of the fixed state of the latch 916. Additionally, or alternatively, the latch arm 914 can be operably coupled to the carry handle 910 through the set of linkages to lock the latch arm 914 in place and release the latch arm 914 to allow the latch arm 914 to move and/or rotate relatively to the seat shell 908.

As shown, the anchor system 902 includes a handle linkage 918, a connecting linkage 920, a rear linkage 922, a locking linkage 924, and a forward linkage 926. The handle linkage 918 connects between the attachment mechanism 912 of the carry handle 910 and the connecting linkage 920. The connecting linkage 920 connects between the handle linkage 918 and the rear linkage 922. The rear linkage 922 connects between the connecting linkage 920 and the locking linkage 924 at one end of the rear linkage 922 and provides a pivoting connection between the connecting linkage 920 and the rear linkage 922. An opposite end of the rear linkage 922 is pivotably connected to the seat shell 908. The locking linkage 924 connects between the rear linkage 922 and connecting linkage 920 at one end and the latch arm 914 at another end of the locking linkage 924. The forward linkage 926 connects at one end to the latch arm 914 and at another end is pivotably connected to the seat shell 908. The forward linkage 926 and the locking linkage 924 may pivotably connect to the latch arm 914 at the same position or about a same pivot connection. The linkages 918, 920, 922, 924 are configured to provide a functional connection between the carry handle 910 and the latch arm 914 and the forward linkage 926 provides a pivoting force to the latch arm 914 when the carry handle 910 is used to cause movement of the latch arm 914. The locking linkage 924 includes a recline rack 928 that is configured to provide two or more locking positions or angles of inclination that may be secured in place to set a recline of the infant car seat 904 and/or tight fit of the infant car seat 904 to the vehicle seat.

FIG. 9B illustrates the infant car seat system 900 in a reclined position and the anchor system 902 is in an unlocked and extended state. FIG. 9C illustrates the infant car seat system 900 in an upright position and the anchor system 902 is in an unlocked and extended state. FIG. 9D illustrates the infant car seat system 900 and the anchor system 902 in a locked and tensioned state. In operation, by rotating the carry handle 910, the attachment mechanism 912 may urge the handle linkage 918 to move, thus applying a force to the connecting linkage 920. For example, as the carry handle 910 is pushed toward a foot 930 of the seat shell 908, the handle linkage 918 may be rotated in a direction away from the foot 930. This rotation of the handle linkage 918, at the connection with the attachment mechanism 912, will cause the connecting linkage 920 to be moved in a direction away from the foot 930 of the seat shell 908. This motion, in turn, acts to urge the locking linkage 924 in a direction away from the foot 930. Because the locking linkage 924 is connected to the connecting linkage 920 and the rear linkage 922, the movement will cause the locking linkage 924 to be pulled away from the foot 930 and upward toward the seat shell 908 (e.g., as shown in FIGS. 9B-9D). As such, operation of the carry handle 910 may be configured to retract the latch arm 914 (and latch 916) toward the seat shell 908.

The recline rack 928 may include an opening having one or more ramps or recesses configured to receive a locking pin 932. The locking pin 932 is a pin that couples together the connecting linkage 920, the rear linkage 922, and the locking linkage 924. The locking pin 932 is fixedly and pivotably connected to ends of the connecting linkage 920 and the rear linkage 922 and is arranged within the opening of the recline rack 928 of the locking linkage 924. The locking pin 932 is moveable within the opening of the recline rack 928 between different positions that are selected to secure and lock a recline position of the seat shell 908 relative to the latch arm 914. The different positions of the recesses or ramps of the recline rack 928 may be configured to define a relative angle and relationship between the seat shell 908 and the latch arm 914, such that each recess or ramp may define a different angle of inclination (or angle of recline). The recline rack 928 may provide similar functionality of setting or pre-setting an angle of inclination as shown and described above.

As shown in FIGS. 9B-9C, the angle or positional relationship between the seat shell 908 and the latch arm 914 (or latch 916) may be adjusted. The changes in position, angle, or the like will be described with respect to a seat line 934 that is a horizontal line passing through the seat shell 908 and a latch line 936 that passes through the latch 916 and the latch arm 914 along a longitudinal axis thereof. FIG. 9B illustrates the seat shell 908 is in a fully reclined position, with a reclined angle ar defined between the seat line 934 and the latch line 936. FIG. 9C illustrates the seat shell 908 is in a fully upright position, with a reclined angle du defined between the seat line 934 and the latch line 936. The reclined angle ar is greater than the upright angle du. In some configurations, the upright angle du may be undefined, because the seat line 934 and the latch line 936 may be parallel. However, in non-parallel configurations, the upright angle du will be less than the reclined angle ar. Each of the reclined angle ar and the upright angle du may be defined by a respective recess or ramp of the recline rack 928. In some configurations, multiple different reclined angles may be preset based on the arrangement of the recline rack 928. For example, at one end of the recline rack 928 may be an upright recess for receiving the locking pin 932 and setting the seat shell 908 in the upright position. At an opposite end of the recline rack 928 may be a maximum recline recess for receiving the locking pin 932 and setting the seat shell 908 in the fully reclined position. Arranged between the upright recess and the maximum recline recess may be one or more additional recline recesses that define an angle of recline that is less than the fully reclined position but inclined greater than the upright position.

The recesses of the recline rack 928 may be temporarily fixed such that the angle of incline/recline of the seat shell 908 relative to a vehicle seat is fixed from one use to the next. As such, a caregiver can set a preferred level of recline of the seat shell 908 (and thus a child sitting thereon), and then install and remove the infant car seat system 900 to/from a vehicle. With the angle of the latch 916 and latch arm 914 set, the infant car seat system 900 may be installed with a predefined orientation. However, even once installed, further operation of the carry handle 910 may cause further action to secure the infant car seat system 900 to the vehicle.

For example, referring now to FIGS. 10A-10B, schematic illustrations of an infant car seat system 1000 in accordance with an embodiment of the present disclosure, as installed on a vehicle seat 1006. The infant car seat system 1000 is substantially similar to that shown and described above with respect to FIGS. 9A-9D, having an anchor system 1002 that is configured to enable adjustment of an infant car seat 1004 even after the infant car seat 1004 is installed on the vehicle seat 1006. The infant car seat 1004 includes a seat shell 1008 and a carry handle 1010 that is operably coupled to the seat shell 1008 and is adjustable in angle relative to the seat shell 1008 through an attachment mechanism 1012 that rotationally couples the carry handle 1010 to the seat shell 1008. The anchor system 1002 includes a latch arm 1014 that is adjustable, as described above, and may include a latch on an end thereof for connecting to a vehicle latch system, similar to that shown and described above.

FIG. 10A illustrates the infant car seat system 1000 in an installation position and FIG. 10B illustrates the infant car seat system 1000 in a tensioned position. The installation position shown in FIG. 10A may include any angle of recline (e.g., between upright shown in FIG. 9C to maximum recline shown in FIG. 9B). This angle of inclination may be preset, as noted above, and set by a caregiver to achieve a desired recline for the infant car seat system 1000. Once installed, the caregiver may then operate or pivot the carry handle 1010 to move the position of the carry handle 1010 from a carry position (FIG. 10A) to an anti-rebound position (FIG. 10B). As shown in FIG. 10B, when moved to the anti-rebound position, the carry handle 1010 is angled toward and extends toward a seat back 1016. In this position, the carry handle 1010 is arranged to contact the seat back 1016 in the event of a collision of the like and prevent substantial movement of the infant car seat system 1000 in such an event.

Additionally, because the carry handle 1010 is operably coupled to the latch arm 1014 through the anchor system 1002 (e.g., similar to the anchor system 1002 of FIGS. 9A-9D), by moving the carry handle 1010 toward a foot 1018 of the seat shell 1008, further functionality is provided. For example, by pushing the carry handle 1010 toward the foot 1018, the attachment mechanism 1012 will apply a force to a handle linkage, a connecting linkage, a rear linkage, a locking linkage, and a forward linkage, and thus apply a force on the latch arm 1014. When the infant car seat system 1000 is installed to the vehicle seat 1006, and the latch of the latch arm 1014 is secured to a vehicle latch, the operation of the linkages will cause the seat shell 1008 to be moved. That is, the latch arm 1014 is fixed at one end to the vehicle seat 1006 and pivotably coupled to the seat shell 1008, and thus pulling the linkages into the seat shell 1008 will cause the seat shell 1008 to be moved toward the seat back 1016 of the vehicle seat 1006.

In accordance with some non-limiting embodiments of the present disclosure, a rigid latch assembly or anchor system is integrated to an infant car seat. A recline rack and/or linkages of the anchor assembly may be integrated in a way that allows the infant child seat to be set to different recline positions after installing into the vehicle. The recline rack and linkages are also connected to the carry handle, as shown, and described above (e.g., linkages between latch arm and attachment mechanism of carry handle). When the carry handle is rotated from the carry position (FIG. 10A) to an anti-rebound position (FIG. 10B), the operation of the carry handle will draw the linkages in an opposing direction, and thus draw the latch arms into the seat shell. As the latch arms are pulled into the seat shell, it will cause pulling of the seat shell tighter to the vehicle seat (e.g., as shown in FIG. 10B). The recline mechanism of the linkages (e.g., locking linkage and recline rack) may allow the infant car seat to be set in one of several recline positions. In some embodiments, when the carry handle is in the carry position (FIG. 10A), the latch arms (1014) may be free to pivot through the full recline ranges possible (e.g., between upright and maximum recline). Once connected to the vehicle seat, the caregiver may rotate the infant car seat to a desired recline position. Then, when the carry handle is rotated to the locked position (transitioning from FIG. 10A to FIG. 10B), the connected linkages will draw a locking pin into the closest recline slot, locking the latch arm in the recline position. As the handle continues to rotate to the locked position (FIG. 10B), it draws the latch arm into the seat shell, thus tightening the connection to the vehicle seat.

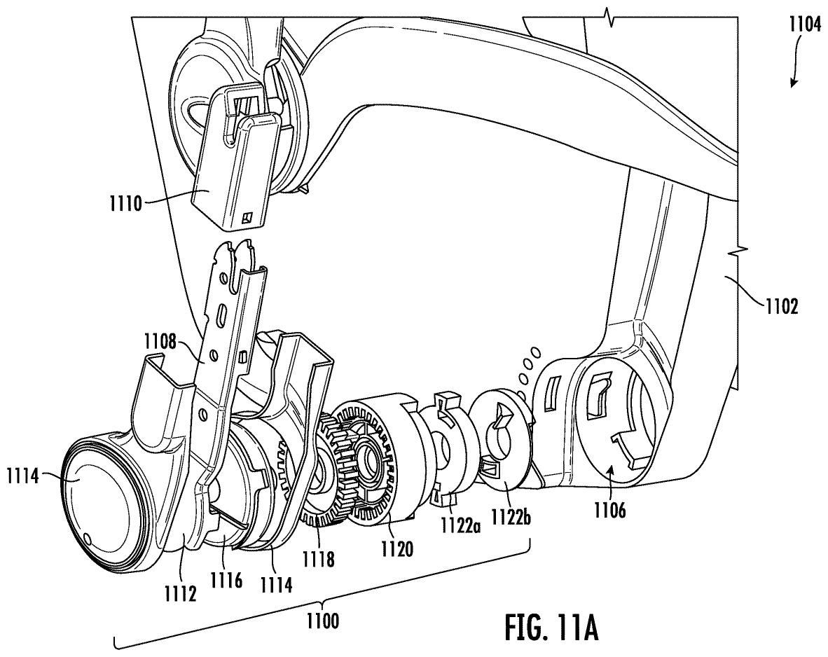

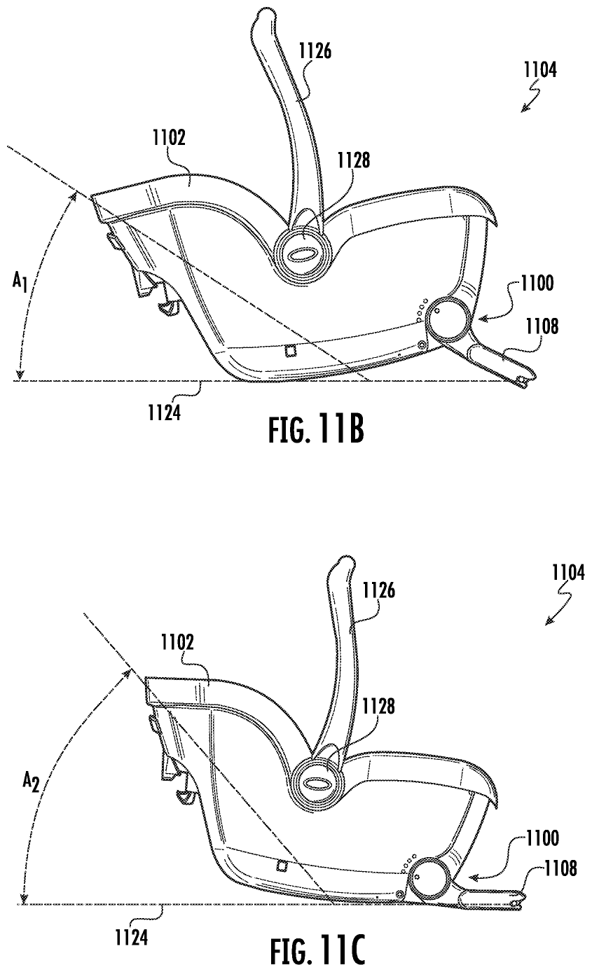

Referring now to FIGS. 11A-11C, schematic illustrations of components and operation of an anchor system 1100 installable to a seat shell 1102 of an infant car seat 1104 in accordance with an embodiment of the present disclosure are shown. In FIG. 11A, the components and elements of the anchor system 1100 are shown in separated or exploded illustration, and FIGS. 11B-11C illustrate the infant car seat 1104 as positioned in inclined angles that may be achieved through operation of the anchor system 1100. The anchor system 1100 is configured to be mounted or otherwise attached to the seat shell 1102 (and/or a seat shell rail thereof) of the infant car seat 1104. In this illustrative configuration, the anchor system 1100 is configured to be installed into a mounting aperture 1106 that is formed in the seat shell 1102. It will be appreciated that the location of such mounting aperture 1106 is not limited to the illustrative location and may be formed in other locations on the seat shell 1102.

The anchor system 1100 includes a latch arm 1108 having a latch 1110 arranged at a distal end thereof. The latch 1110 may be configured to releasably connect or attach to a vehicle anchor system, such as described above. The latch arm 1108 includes a latch arm hub 1112 that is rotatably mounted to a hub shaft (e.g., similar to that shown in FIG. 4). In some embodiments, the hub shaft may be integrally formed with the latch arm hub 1112. The latch arm 1108 may include or be housed within a latch arm housing 1114. Although shown as separate components and structures, one or more components of the latch arm 1108, latch 1110, and/or latch arm housing 1114 may be formed as a unitary or single component (or some other configuration thereof). That is, the illustrative structural configuration of the latch arm 1108 and associated elements is not intended to be limiting.

The anchor system 1100 further includes, as shown in FIG. 11A, a recline hub 1116, a recline gear 1118, a memory hub 1120, and one or more ramp hubs 1122a, 1122b. The ramp hubs may be arranged as a buffer ramp hub 1122a and a driving ramp hub 1122b. Although shown with two ramp hubs, it will be appreciated that other configurations of fewer or more ramp hubs may be employed without departing from the scope of the present disclosure.

A latch attachment mechanism, of this configuration and similar to that shown and described with respect to FIG. 4, includes the recline hub 1116, the recline gear 1118, the memory hub 1120, and the one or more ramp hubs 1122a, 1122b. Each of the recline hub 1116, the recline gear 1118, the memory hub 1120, and the one or more ramp hubs 1122a, 1122b may have a central aperture or through hole through which the hub shaft may extend. As such, in some embodiments, the recline hub 1116, the recline gear 1118, the memory hub 1120, and the one or more ramp hubs 1122a, 1122b may be mounted to or supported on the hub shaft. In other embodiments, one or more of these components may be arranged to permit the hub shaft to pass therethrough, without direct contact or engagement, and in some such configurations, the hub shaft may operate to secure alignment of components but may not provide other operational functionality.

The arrangement of the anchor system 1100 is configured such that the latch arm 1108 is rotatable or pivotable about an axis (e.g., defined by the hub shaft or a through-axis through the mounting aperture 1106). The arrangement of the anchor system 1100 is configured to secure or mount the components of the anchor system 1100 within the mounting aperture 1106 on the infant car seat 1104 (e.g., on the seat shell 1102 and/or an associated seat shell rail). The recline gear 1118 is configurated as a sliding gear that locks the position of the latch arm 1108 in one or more positions (e.g., four positions). As the angular position of the latch arm 1108 changes, the recline/incline of the infant car seat 1104 will change relative to a vehicle seat, such as shown in FIGS. 11B-11C. That is, the anchor system 1100 is configured to allow adjustment of a recline angle or orientation of the associated infant car seat 1104. For example, the anchor system 1100 may be configured to permit rotation about the axis defined by the hub shaft to change an angle of orientation of the latch arm 1108, to achieve, at least, a first position (e.g., FIG. 11B) and a second position (e.g., FIG. 11C) and lock the system in such orientations. As shown in FIG. 11B, the first position may be such that the infant car seat 1104 may be angled at a first angle A1. In FIG. 11B, the first angle A1 is illustrated as 33.3° relative to a plane 1124, which may represent a vehicle seat or the like. As shown in FIG. 11C, the second position may be such that the infant car seat 1104 may be angled at a second angle A₂. In FIG. 11C, the second angle A₂ is illustrated as 49.3° relative to the plane 1124. In some embodiments, other positions, such as between the first position and the second position may be selected and locked into position to secure a desired angle of inclination or recline. Further, in some embodiments, the rotation of the latch arm 1108 may be greater or beyond the angles of the first position and the second position.

As shown in FIGS. 11B-11C, the infant car seat 1104 includes the seat shell 1102 in or on which a child may be supported and carried. The infant car seat 1104 includes a carry handle 1128 that is operably coupled to the seat shell 1102 and is adjustable in angle relative to the seat shell 1102 through an attachment mechanism 1128 that rotationally couples the carry handle 1126 to the seat shell 1102, as described above.

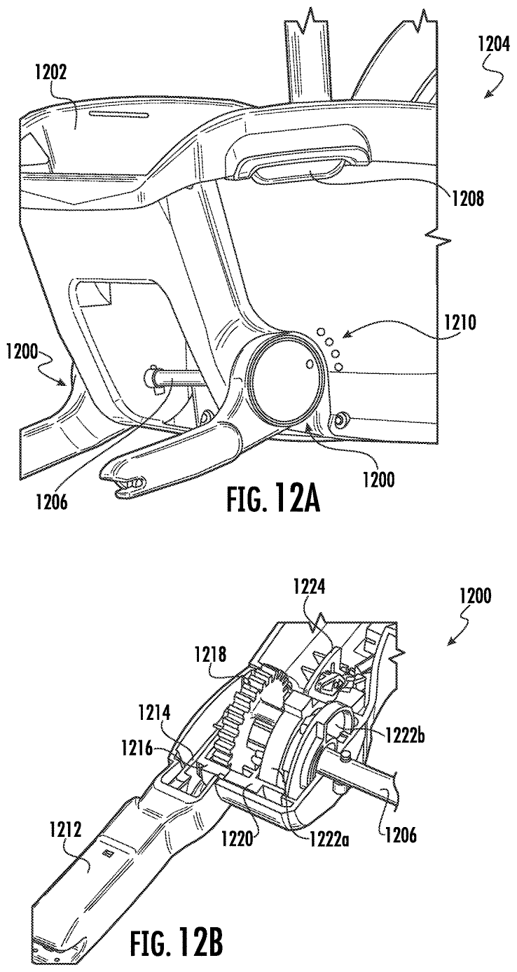

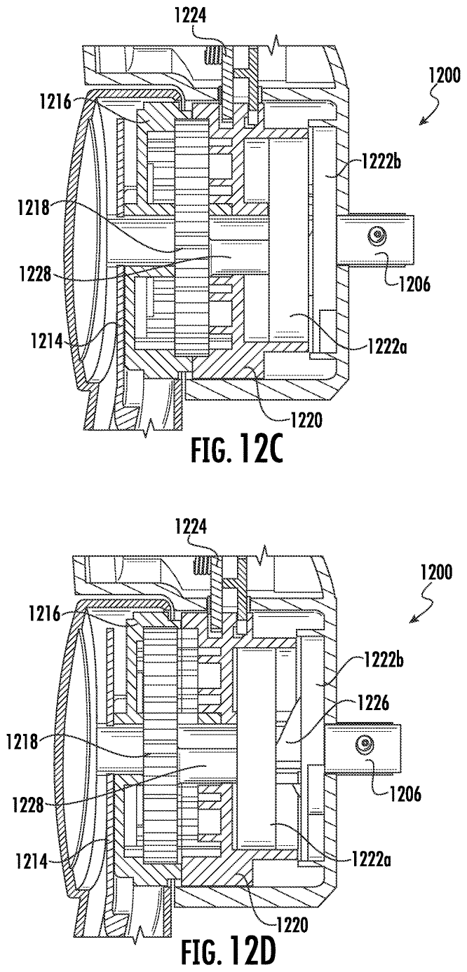

Referring now to FIGS. 12A-12D, schematic illustrations of components and operation of an anchor system 1200 installable to a seat shell 1202 of an infant car seat 1204 in accordance with an embodiment of the present disclosure are shown. FIG. 12A illustrates a portion of the infant car seat 1204 having two anchor systems 1200 that are operably coupled together by a linking shaft 1206. The linking shaft 1206 may be configured such that movement of one anchor system 1200 will cause similar or matching movement of the other anchor system 1200. As such, the two anchor systems 1200 are configured to operate simultaneously by the connection provided by the linking shaft 1206. The operation of the anchor systems 1200 may be, at least partially, operated through a recline actuation handle 1208. The recline actuation handle 1208 may be positioned remote from the anchor systems and operably connected thereto through one or more connections, as described herein. The position of the reclined actuation handle 1208 may be at any location on the infant car seat 1204 (e.g., on the seat shell 1202 and/or rails and/or seat shell rim of the seat shell 1202). The infant car seat 1204 may include one or more indicators 1210 to provide indication of various different angles at which the infant car seat 1204 may be inclined/reclined, through operation of the recline actuation handle 1208 and changing orientation of the anchor systems 1200, such as shown and described above. The indicators 1210 may be markings, pips, indents, protrusions, writing, or the like.

The components and elements of one anchor system 1200 are shown in FIGS. 12B-12D. The anchor systems 1200 each include, respectively, a latch arm 1212 having a latch arranged at a distal end thereof. The latch of the latch arm 1212 may be configured to releasably connect or attach to a vehicle anchor system, such as described above. The latch arm 1212 includes a latch arm hub 1214 that is rotatably mounted to a hub shaft, which, in this configuration, is attached to or part of the linking shaft 1206. The anchor systems 1200 further include, as shown in FIG. 12B, a recline hub 1216, a recline gear 1218, a memory hub 1220, and one or more ramp hubs 1222a, 1222b. The ramp hubs may be arranged as a buffer ramp hub 1222a and a driving ramp hub 1222b. Although shown with two ramp hubs, it will be appreciated that other configurations of fewer or more ramp hubs may be employed without departing from the scope of the present disclosure.

A latch attachment mechanism, of this configuration and similar to that shown and described above, includes the recline hub 1216, the recline gear 1218, the memory hub 1220, and the one or more ramp hubs 1222a, 1222b. Each of the recline hub 1216, the recline gear 1218, the memory hub 1220, and the one or more ramp hubs 1222a, 1222b may have a central aperture or through hole through which the linking shaft 1206 may extend. As such, in some embodiments, the recline hub 1216, the recline gear 1218, the memory hub 1220, and the one or more ramp hubs 1222a, 1222b may be mounted to or supported on the linking shaft 1206. In other embodiments, one or more of these components may be arranged to permit the linking shaft 1206 to pass therethrough, without direct contact or engagement, and in some such configurations, the linking shaft 1206 may operate to secure alignment of components but may not provide other operational functionality. The anchor systems 1200 may also include or be operably configured to function with a locking mechanism 1224 (e.g., similar to that shown and described above with respect to FIGS. 6A-6C, 7, 8A-8C). In this configuration, the locking mechanism 1224 may be operably connected to the recline actuation handle 1208 and/or the recline actuation handle 1208 may be operably connected to the driving ramp hub 1222b to enable selective operation of a recline/incline functionality of the infant car seat 1204. In some configurations, the locking mechanism 1224 may be operated using a first handle or actuator (e.g., as shown in FIG. 7) and the operation of the driving ramp hub 1222b may be provided by a second handle or actuator (e.g., recline actuation handle 1208).

FIGS. 12C-12D illustrate cross-sections of one of the anchor systems 1200 in a recline locked state (FIG. 12C) and in a recline unlocked state (FIG. 12D). As shown in FIG. 12C, in the recline locked state, the recline gear 1218 is engaged with both the recline hub 1216 and the memory hub 1220. In this state, the angle of inclination or recline is fixed and not adjustable. In order to adjust an angle (recline/incline) of the infant car seat 1204, the anchor system(s) 1200 are operated, such as by the recline actuation handle 1208, which causes the recline gear 1218 to move out of engagement with the memory hub 1220, and may be rotationally driven by (or rotationally drive) the recline hub 1216, and thus the angle of inclination/recline of the infant car seat 1204 may be adjusted.

As shown in FIG. 12C, in the locked state, the driving ramp hub 1222b is in a first state, and the buffer ramp hub 1222a is substantially in contact with the driving ramp hub 1222b. When changed to the unlocked state, shown in FIG. 12D, the driving ramp hub 1222b is rotated such that one or more ramps 1226 will urge the buffer ramp hub 1222a away from the driving ramp hub 1222b, which in turn urges the recline gear 1218 out of engagement with the memory hub 1220. As shown, the buffer ramp hub 1222a may urge movement of the recline gear 1218 by contact with a post 1228 of the recline gear 1218. It will be appreciated that, in other configurations, the post 1228 may be part of the buffer ramp hub 1222a and not the recline gear 1218. Further, in some embodiments, the buffer ramp hub 1222a may include one or more ramps that correspond with the ramps 1226 of the driving ramp hub 1222b (e.g., as shown in FIGS. 5A-5F).

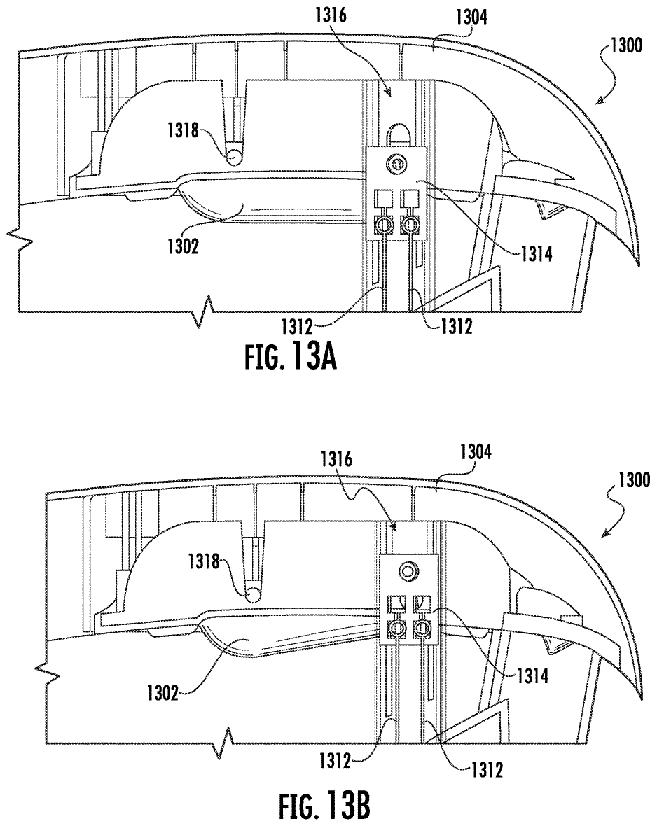

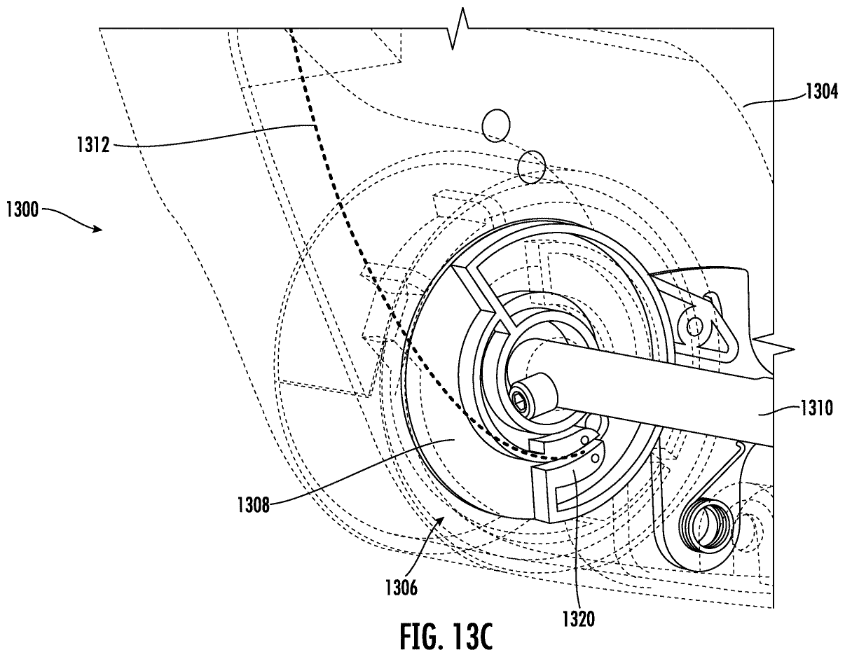

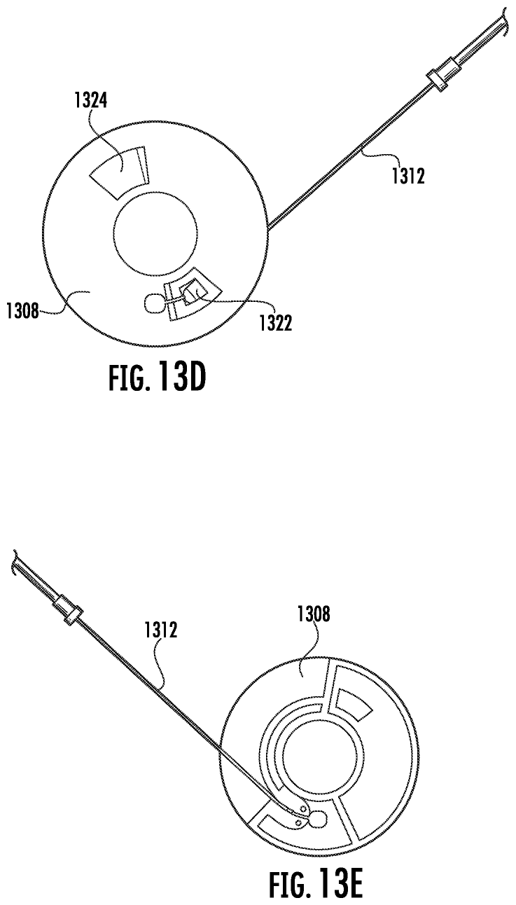

Referring now to FIGS. 13A-13E, schematic illustrations of portions of an infant car seat 1300 in accordance with an embodiment of the present disclosure. The infant car seat 1300 may be similar to that shown and described above, and particularly may be similar to the configurations shown in FIGS. 11A-11C and/or FIGS. 12A-12D. That is, the infant car seat 1300 includes a recline actuation handle 1302 that is configured to operate an incline/recline functionality of the infant car seat 1300. The infant car seat 1300 includes a seat shell 1304 and an anchor system 1306 (FIG. 13C). The anchor system 1306 may be configured similar to one or more of the embodiments shown and described above, although only a driving ramp hub 1308 is illustratively shown for simplicity and clarity of description and illustration. Further, the driving ramp hub 1308 includes at least one ramp on a side opposite that shown, with the ramp configured to engage and/or urge a recline gear of the anchor system 1306 along a shaft 1310 (e.g., linking shaft and/or hub shaft).

The recline actuation handle 1302 is operably connected to the anchor system 1306, and specifically the driving ramp hub 1308 thereof. For example, as shown, at least one recline actuation connector 1312 (two show, one for each of two anchor systems 1306 of the infant car seat 1300). The recline actuation connector(s) 1312 may be wires, cables, straps, or other flexible or semi-flexible elements or may be configured as fixed or rigid elements, such as rods, shafts, or the like. FIGS. 13A-13B illustrate a first end connection of the recline actuation connectors 1312, which are connected to the recline actuation handle 1302 by a connector element 1314. In this illustrative, non-limiting configuration, the connector element 1314 is a carriage or moving body that is configured to travel within a slot or track 1316. In this specific configuration, the connector element 1314 is configured to move substantially vertically (e.g., upward/downward motion) when a user operates or actuates a recline actuation mechanism, such as the actuation handle 1302. FIG. 13A illustrates the normal state of the actuation handle 1302 and FIG. 13B illustrates the actuated state of the actuation handle 1302. As shown, when comparing FIG. 13A and FIG. 13B, the actuation handle 1302 is moved upward in the actuated state, and this causes the connector element 1314 to move upward along the track 1316. As the connector element 1314 moves upward, it will apply force to and pull on the recline actuation connectors 1312 in an upward direction (e.g., relative to the seat shell 1304 and on the page of FIGS. 13A-13B). In some embodiments, and as shown, the actuation handle 1302 may perform a pivoting operation such that one end or side of the actuation handle 1302 is moved upward (e.g., the portion connected to the connector element 1314). In this configuration, a handle pivot 1318 is provided to ensure the desired pivoting motion. The handle pivot 1318 may be a pin, rod, boss, or the like, that is configured to rotate relative to the seat shell 1304.

Referring to FIG. 13C, an opposite end of one recline actuation connector 1312 is shown (e.g., opposite the connection to the connector element 1314), illustrating a connection with the driving ramp hub 1308. As shown, the recline actuation connector 1312 engages with and securely attaches to or connects to the driving ramp hub 1308. For example, a securing mechanism 1320 provides a connection between an end of the recline actuation connector 1312 and the driving ramp hub 1308. The securing mechanism 1320, in this illustrative embodiment, comprises a clamp or compression configuration that captures the end of the recline actuation connector 1312. In other embodiments, the recline actuation connector 1312 may be attached to the driving ramp hub 1308 by other means or mechanisms, such as fasteners, pin-and-loop, bonding, adhesives, threaded connection, or the like, without departing from the scope of the present disclosure. Further, it will be appreciated that other mechanisms that can convert a linear motion (e.g., of the actuation handle 1302) may cause a rotational motion (e.g., of the driving ramp hub 1308) may be employed without departing from the scope of the present disclosure. Moreover, in other configurations, the actuation handle may be configured as a knob or dial that may be turned or rotated to cause the recline actuation connector 1312 to in turn cause rotation of the driving ramp hub 1308.

Referring to FIGS. 13D-13E, schematic illustrations of one configuration of the connection between the recline actuation connector 1312 and the driving ramp hub 1308 are shown. FIG. 13D illustrates a first side view of the driving ramp hub 1308 and FIG. 13E illustrates a second, opposite side view of the driving ramp hub 1308. At an end of the recline actuation connector 1312 is a locking element 1322 that is configured to provide a secured engagement between the recline actuation connector 1312 and the driving ramp hub 1308. As shown in FIG. 13D, the first side of the driving ramp hub 1308 includes at least one ramp 1324 configured to be rotated into engagement and urge a buffer ramp hub along a shaft or the like (e.g., as shown in FIGS. 12C-12D).

During operation of the actuation handle 1302, the connector element 1314 is moved upward in the track 1316 and the recline actuation connector 1312 is pulled upward. As the recline actuation connector 1312 is pulled upward, it will apply force to the driving ramp hub 1308, causing the driving ramp hub 1308 to rotate about the shaft 1310. As the driving ramp hub 1308 is rotated, the ramps of the driving ramp hub 1308 will interact with a buffer ramp hub to cause an associated anchor system to be changed from a recline locked state (e.g., as shown in FIG. 12C) to a recline unlocked state (e.g., as shown in FIG. 12D). Accordingly, operation of the actuation handle 1302 enables adjustment of the incline/recline of the infant car seat 1300.

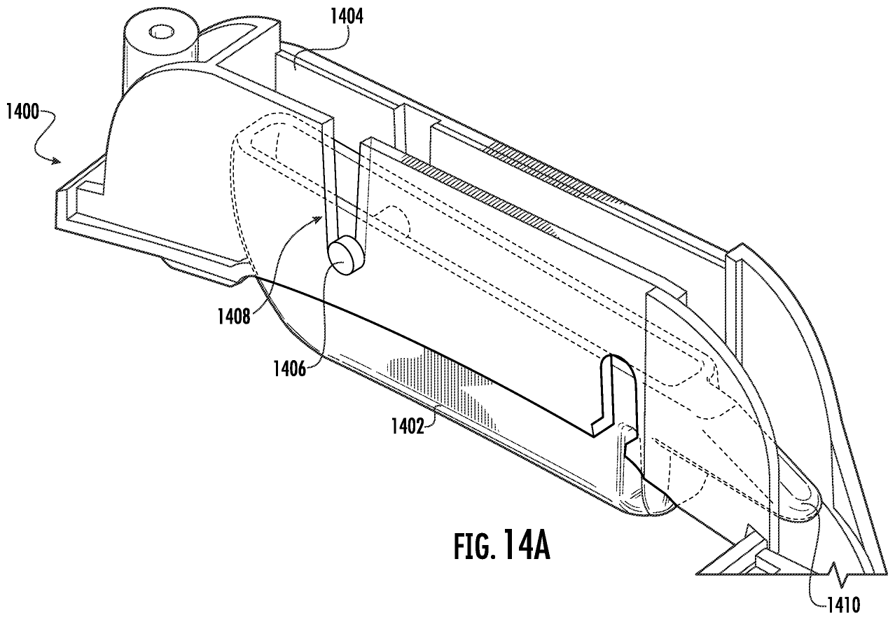

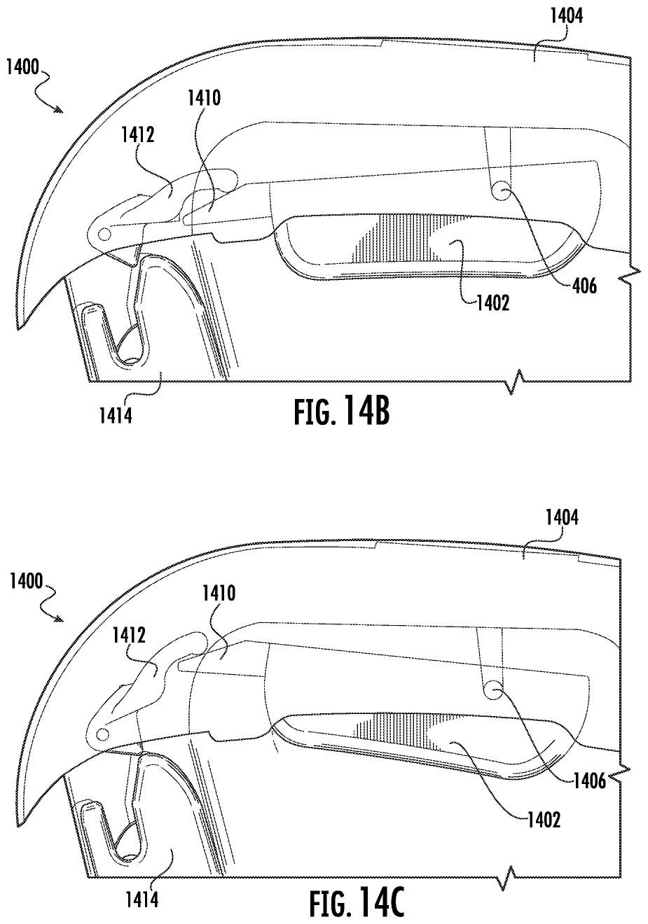

Referring now to FIGS. 14A-14C, schematic illustrates of a portion of a structure of an infant car seat 1400 having an actuation handle 1402 are shown. The actuation handle 1402 may be similar to that shown and described with respect to FIGS. 13A-13B. As shown, the actuation handle 1402 may be housed within a part of a seat shell 1404 of the infant car seat 1400. The actuation handle 1402 is pivotable about a handle pivot 1406. The handle pivot 1406 may define a pivot axis about which the actuation handle 1402 may be rotated during manual operation. In some embodiments, and as shown in FIG. 14A, the handle pivot 1406 may sit within a slot 1408 (e.g., a slot, channel, depression, saddle, or the like), that is part of the seat shell 1404 or other fixed housing within or part of the seat shell 1404. As described above, the actuation handle 1402 may be operably connected to a connector element (not shown) to cause motion thereof by actuation or operation of the actuation handle 1402.

In this configuration, the actuation handle 1402 also includes a stowing lock extension 1410. The stowing lock extension 1410, in this non-limiting embodiment, is arranged at an end of the actuation handle 1402 from the handle pivot 1406. The stowing lock extension 1410 is an optional feature that is configured to provide additional functionality. For example, as shown in FIGS. 14B-14C, the stowing lock extension 1410 may be configured to interact with a stowing lock 1412. The stowing lock 1412 is pivotably arranged within or on the seat shell 1404 and arranged to be rotated or pivoted as the actuation handle 1402 is operated. In a locked state of the stowing lock 1412 (FIG. 14B), the stowing lock 1412 is arranged to secure a latch arm 1414 of an anchor system in a stowed state. When the actuation handle 1402 is operated, the stowing lock extension 1410 will interact with the stowing lock 1412 and cause the stowing lock 1412 to transition from a locked state (FIG. 14B) to an unlocked state (FIG. 14C). In the unlocked state of the stowing lock 1412 (FIG. 14C), the latch arm 1414 is free to be removed from the stowed state and thus deployed for supporting the infant car seat 1400 at a desired angle and/or for engagement with a vehicle seat, as described herein.

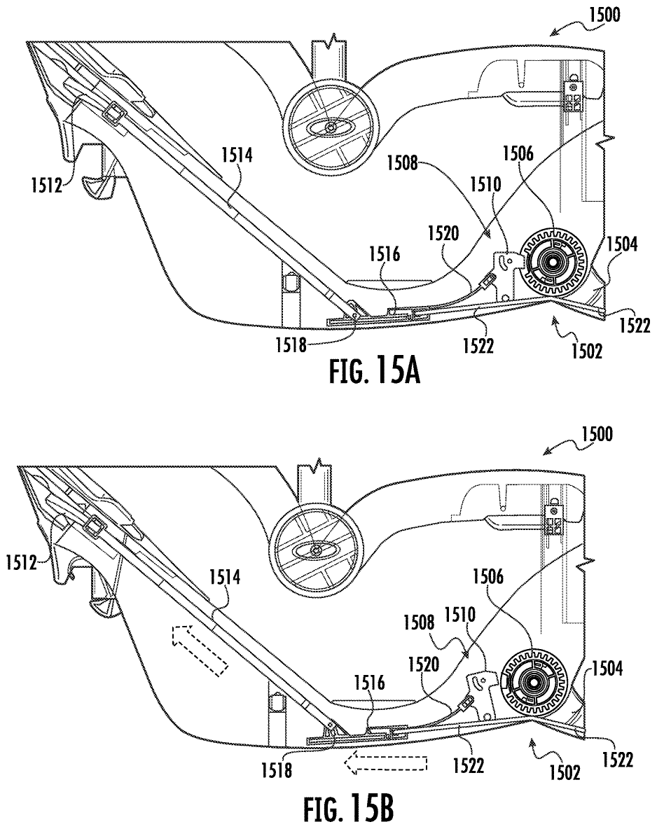

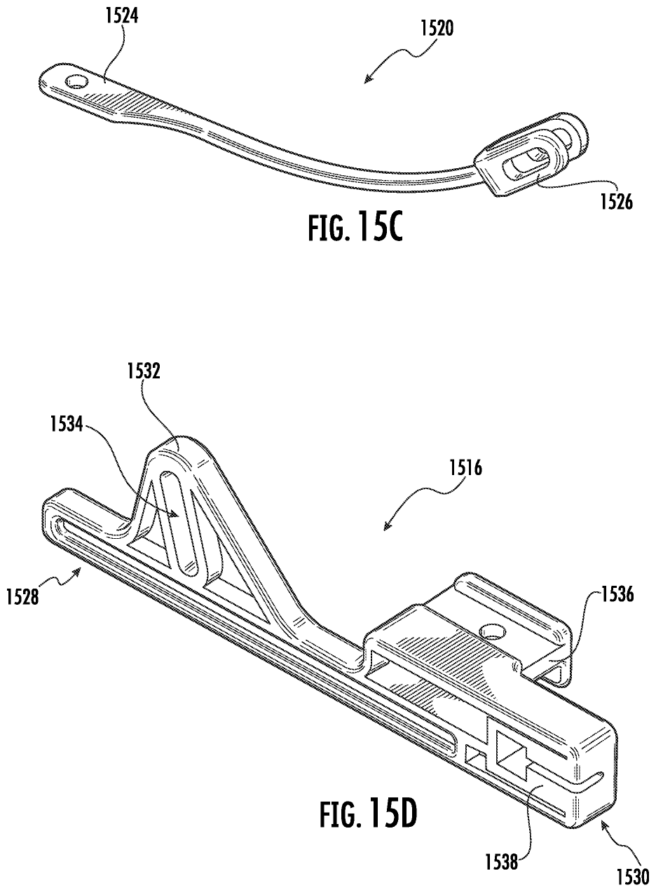

Referring now to FIGS. 15A-15D, schematic illustrations of an infant car seat 1500 in accordance with an embodiment of the present disclosure are shown. The infant car seat 1500 of FIGS. 15A-15B is configured with a mechanism for operating latches of an anchor system 1502 and/or for operating or transitioning a latch arm 1504 of the anchor system 1502 between stowed and use positions. The anchor system 1502 of this embodiment includes the latch arm 1504 with a latch at an end thereof, such as shown and described above (e.g., FIGS. 1B, 4, 9A-9D, etc.), and a memory hub 1506 (and other associated components, such as, for example, shown and described in FIGS. 12C-12D or other embodiments described herein). The memory hub 1506 may be selectively fixable in a given position by a locking mechanism 1508 includes a locking plate 1510, such as, for example, shown and described in FIGS. 8A-8C. The locking plate 1510 is configured to pivot on an axis and engage with an opening in the memory hub 1506 to lock the memory hub 1506 into a use position. The locking plate 1510 is biased toward a locked position with a spring or other biasing mechanism. FIG. 15A illustrates the locked position and FIG. 15B illustrates the unlocked position.

In this configuration, at the rear of the infant car seat 1500, a release handle 1512 is provided to enable disengaging the latch(es) at the ends of the latch arm 1504 from a vehicle seat. As show, the release handle 1512 is connected to a first release connector 1514. The first release connector 1514 may be configured as a rigid strap, a cable, a wire, or other flexible or semi-flexible element, or may be a rigid element, such as a rod, shaft, or the like. The first release connector 1514 is engaged with a sliding connector 1516 via a sliding pin connection 1518. The sliding connector 1516 may be a rigid structure, such as a carriage, cartridge, or structural beam or the like, and is configured to slide in a direction between a forward end and a back end of the infant car seat 1500. The sliding connector 1516 is connected to a locking plate connector 1520 and a second release connector 1522. The second release connector 1522 may be configured as a cable, flexible strap, or the like, and extends from the sliding connector 1516 at one end to a latch at an end of the latch arm 1504. The locking plate connector 1520 is connected to the locking plate 1510. When the handle 1512 is pulled, the first release connector 1514 will be pulled in a direction toward the back of the infant car seat 1500. In some configurations, and as shown in FIG. 15B, the first release connector 1514 may be pulled along a plane or line that is angled relative to a line or plane defined by the sliding connector 1516.

In accordance with this embodiment and configuration, the sliding connector 1516 is constrained to slide along a different plane than the first release connector 1514. When the first release connector 1514 is pulled by operation of the handle 1512, the first release connector 1514 forces the sliding connector 1516 to slide along the associated line/plane. The sliding connector 1516 will then pull the second release connector 1522, thereby releasing the latch at the end of the latch arm 1504 from the vehicle seat. The sliding connector 1516 is also configured to pull on the locking plate connector 1520 that is connected to the locking plate 1510. This movement of the locking plate connector 1520 forces the locking plate 1510 to pivot to an unlocked position (e.g., shown in FIG. 15B). This allows the latch arm(s) 1504 to freely pivot up to a storage position.

FIG. 15C illustrates the structure of the locking plate connector 1520. The locking plate connector 1520 may be a rigid, semi-rigid/semi-flexible, or flexible member. At a first end of the locking plate connector 1520 is a first connection end 1524 configured to connect to the sliding connector 1516. At a second, opposite end of the locking plate connector 1520 is a second connection end 1526 configured to connect to the locking plate 1510.

FIG. 15D illustrates the structure of the sliding connector 1516. The sliding connector 1516 is a rigid body structure that at a first end 1528 connects to the first release connector 1514 and at a second, opposite end 1530 connects to the locking plate connector 1520 and the second release connector 1522. As shown, at the first end 1528, the sliding connector 1516 includes a pin connector 1532 having an aperture 1534 defined thereby. The aperture 1534 of the pin connector 1533 is configured to receive a pin or other structure of the first release connector 1514. As such, the first release connector 1514 may be configured to moveably connect to the sliding connector 1516 at the first end 1528 of the sliding connector 1516. At the second end 1530, the sliding connector 1516 includes a locking plate connection 1536 that attaches to the first connection end 1524 of the locking plate connector 1520 (e.g., shown in FIG. 15C). Further, at the second end 1530, the sliding connector 1516 includes a latch release connection 1538 that engages with and attaches to the second release connector 1522. As such, a sliding movement of the sliding connector 1516, such as caused by a force applied by the first release connector 1514 at the first end 1528 will cause both the locking plate connector 1520 and the second release connector 1522 to be pulled backward or operated, such as to allow for unlocking of the locking plate 1510 and unlocking of a latch at the end of the latch arm 1504.

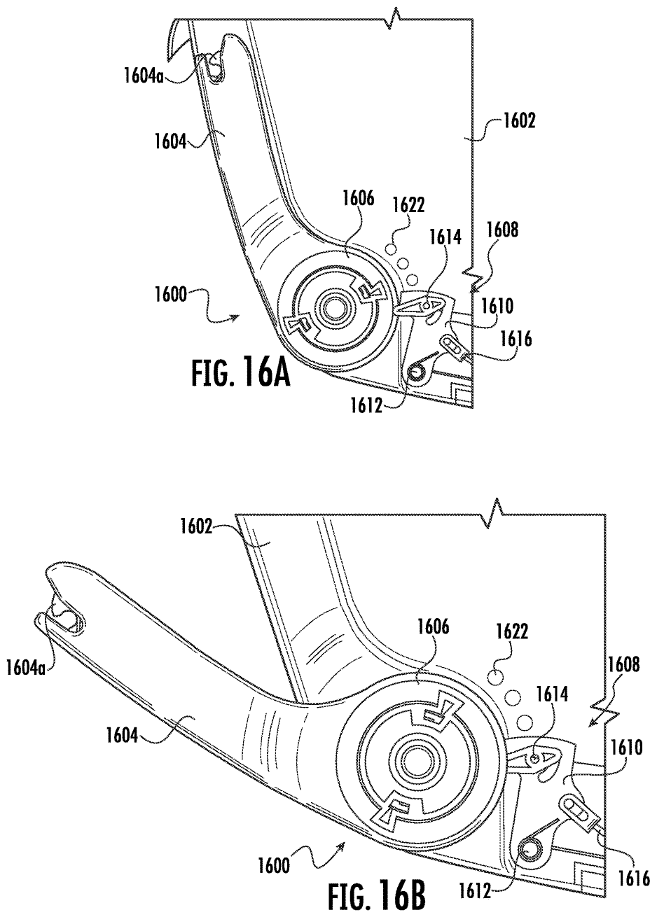

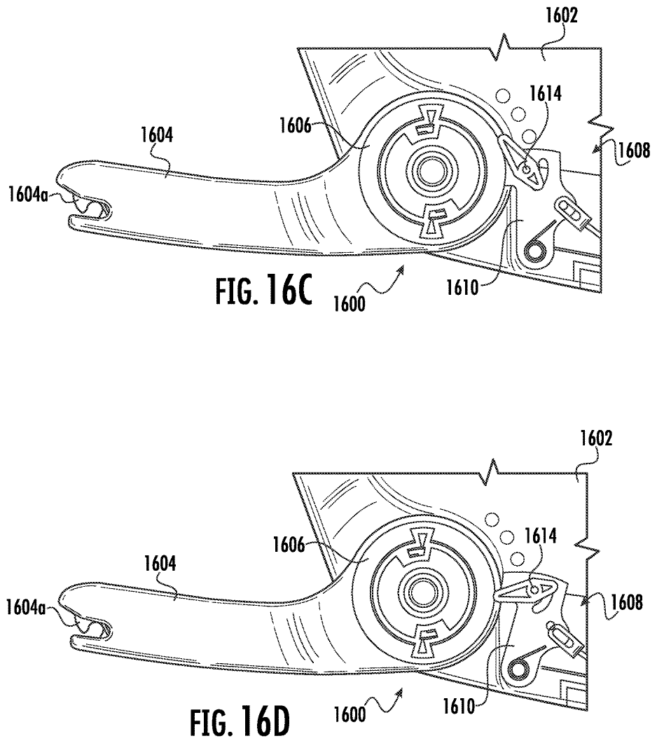

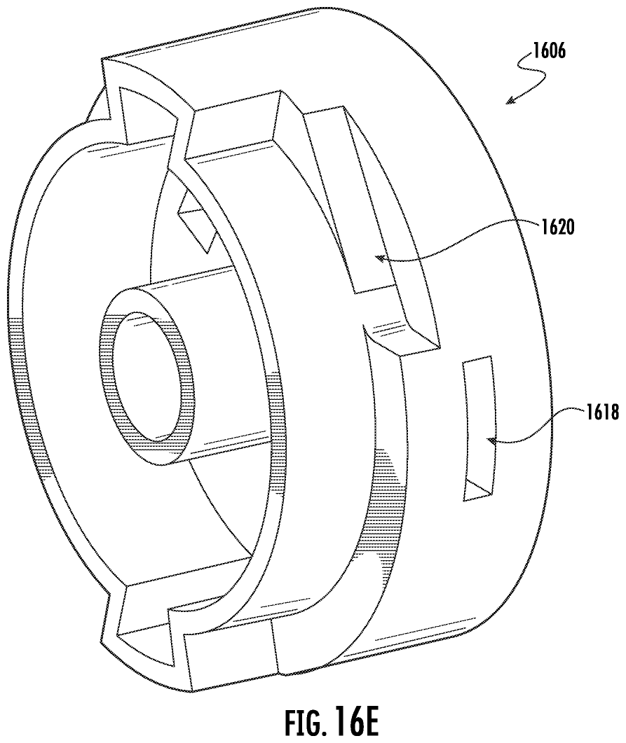

Referring now to FIGS. 16A-16E, schematic illustrations of an anchor system 1600 in accordance with an embodiment of the present disclosure are shown. The anchor system 1600 may be similar to that shown and described above. For example, the anchor system 1600 is installed to a seat shell 1602 and includes a latch arm 1604 extending from a latch arm hub and having a latch 1604a at an end thereof for selectively engaging with a vehicle seat. Similar to the above-described embodiments, the anchor system 1600 includes a memory hub 1606 (shown in FIG. 16E), along with other components as shown and described above but not shown for clarity in FIGS. 16A-16E. In this configuration, the memory hub 1606 is arranged to be rotatable relative to the seat shell 1602. The anchor system 1600 may further include various elements not shown, such as ramp hubs, actuators, switches, connectors, links, and the like. As shown, a locking mechanism 1608 is provided to operate with the anchor system 1600.

The locking mechanism 1608 includes a locking plate 1610 having a locking tooth and a locking biasing element 1612. The locking plate 1610 is pivotably coupled to the seat shell 1602. The locking plate 1610 is operably connected between a release handle and the anchor system 1600. In some configurations, activation of the release handle causes the locking plate 1610 to pivot and release engagement between the locking plate 1610 and the memory hub 1606. The activation of the release handle may also provide a mechanism to release the latch arm 1604 to move between a stowed position (FIG. 16A) and a use position (FIG. 16C). When the latch arm 1604 is moved between the stowed position and the use position, the memory hub 1606 may be configured to move with the latch arm 1604. The memory hub 1606 is configured to enable setting an angle of inclination of the latch arm 1604 relative to the seat shell 1602, as shown and described above. The locking mechanism 1608 further includes a toggle 1614, similar to that shown and described above with respect to FIGS. 8A-8C. The locking mechanism 1608 may be operable through a locking plate connector 1616, which may be configured similar to, for example, that shown in FIGS. 8A-8C or FIGS. 15A-15B, or variations thereon.

The locking biasing element 1612 is configured to bias the locking plate 1610 toward a locking position (shown in FIG. 16C). In the locking position, a locking tooth of the locking plate 1610 engages with a part of the memory hub 1606 to rotationally fix the position of the memory hub 1606, as described above. As shown in FIG. 16E, the memory hub 1606 includes a locking feature 1618 and a switching feature 1620. The locking feature 1618 is configured to receive a part of the locking plate 1610 (e.g., locking tooth) and the switching feature 1620 is configured to receive and/or interact with the toggle 1614. In operation, when the locking plate 1610 is disengaged by operation of the locking plate connector 1616, the toggle 1614 will pivot to an active position. In accordance with some embodiments of the present disclosure, the toggle 1614 is biased by a spring or other biasing element toward the active position. With the toggle 1614 in the active position (FIG. 16A), the locking plate 1610 is prevented from engaging with the locking feature 1618 on the memory hub 1606. In the active position, the toggle 1614 extends into contact with a surface of the memory hub 1606 and prevents the locking tooth of the locking plate 1610 for seating within the locking feature 1618. In such a state, the latch arm 1604 is free to pivot to a stored or stowed position (FIG. 16A).

In the locked state (FIG. 16C), the locking tooth of the locking plate 1640 will engage the locking feature 1618 and lock the memory hub 1606 to the seat shell 1602, such as in the use or deployed position as shown in FIG. 16C. When it is desired to move the latch arm 1604 from the deployed state (e.g., FIG. 16C) to a stowed state (e.g., FIG. 16A), the locking mechanism 1608 may be operated to disengage the locking tooth from the locking feature 1618 of the memory hub 1606. The actuation or operation of the locking mechanism 1608 may be performed by pulling on the locking plate connector 1616 (e.g., by a handle, sliding connector, or the like, as described above).

When the locking mechanism 1608 is operated, and the locking tooth disengages from the memory hub 1606, the latch arm 1604 will be free to rotate (e.g., between the deployed state and the stowed state). In this embodiment, to prevent the locking mechanism 1608 from automatically re-engaging with the memory hub 1606, the locking mechanism 1608 includes the toggle 1614. For example, after a release handle is activated to operate the locking mechanism 1608, the toggle 1614 may rotate and block the locking plate 1610 from re-engaging with the memory hub 1606, allowing the latch arms 1604 to pivot to the stowed position without re-activating the release handle. When the latch arm 1604 is rotated to the desired position (e.g., stowed position shown in FIG. 16A), a user may operate release handle and/or the toggle 1614 to re-engage the locking tooth of the locking plate 1610 with the locking feature 1618 of the memory hub 1606 to lock the latch arm 1604 in the stowed state. A similar operation may be performed to release the latch arm 1604 from the stowed state and allow for transitioning to the deployed state. The memory hub 1606 may be configured such that the specific orientation of the latch arm 1604, in the deployed state, may be set and not adjusted during the transition from the deployed state to the stowed state, and thus the memory hub 1606 may provide a memory or ability to return to the specific angle of the deployed state, without requiring adjustment each time the latch arms 1604 are deployed. For example, as shown, one or more indicators 1622 may be provided on the seat shell 1602 to indicate various angles of inclination or recline of the infant car seat.

As shown in FIGS. 16B-16D, the anchor system 1600 is shown in various possible use positions, where the latch arm 1604 and associated latch 1604a of the anchor system 1600 is moveable and/or operable for engagement with a vehicle seat anchor or the like. In contrast, FIG. 16A, for example, illustrates the anchor system 1600 in a stowed position. The anchor system 1600 is configured to be locked or fixed into the use or stowed positions, based on a user preference and the specific state or use of the infant car seat, as will be appreciated by those of skill in the art. A release handle maybe operably coupled to the locking mechanism 1608, such as by means of the locking plate connector 1616 for selective operation of the anchor system 1600, such as for locking the anchor system 1600 in a use position (FIGS. 16B-16D) and/or a stowed position (FIG. 16A). In the use position of the latch arm 1604, the latch arm 1604 is selectively fixable in two or more angles relative to the seat shell 1602, such as designated or indicated by the one or more indicators 1622. The anchor system 1600 includes the memory hub 1606 that is configured to enable setting of an angle of recline of the infant car seat based on two or more angles in which the memory hub 1606 may be set.

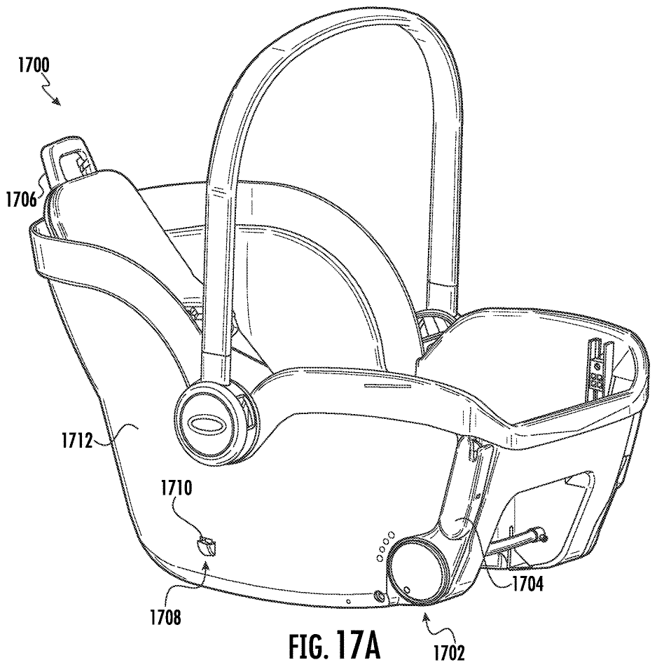

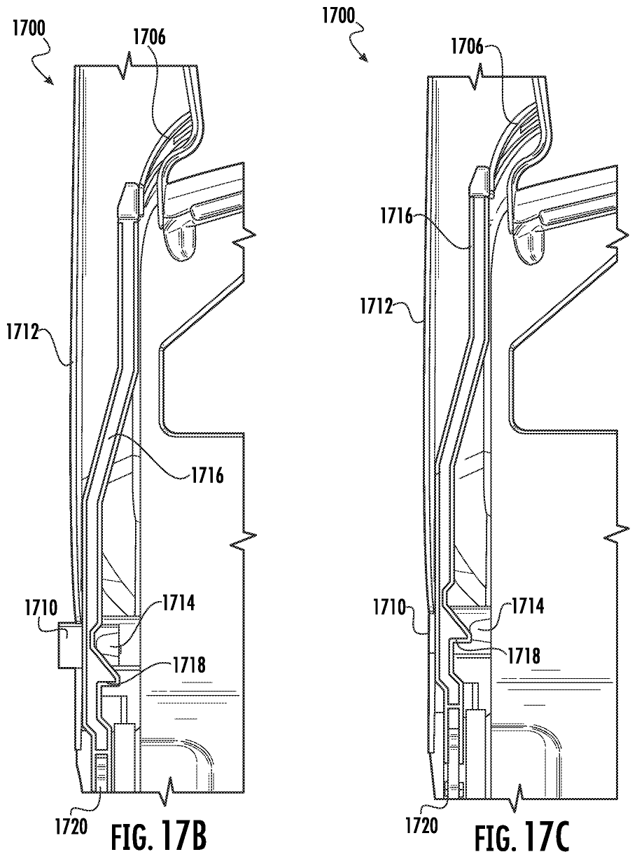

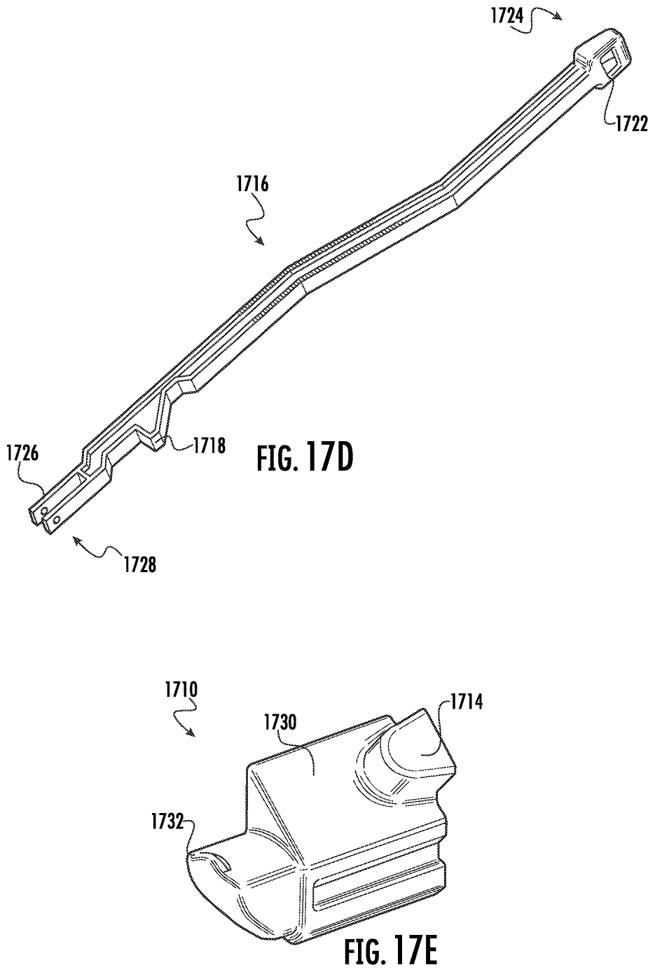

Referring now to FIGS. 17A-17E, schematic illustrations of an infant car seat 1700, and components thereof, in accordance with an embodiment of the present disclosure are shown. The infant car seat 1700 may incorporate features as shown and described above. In this illustrative embodiment, the infant car seat 1700 includes an anchor system 1702 that includes a latch arm 1704 having a latch at an end thereof for engaging with a vehicle seat. The anchor system 1702 may be configured similar to one or more of the above-described embodiments. For example, and without limitation, the anchor system 1702 may be similar to that shown and described with respect to FIGS. 15A-15D, although other configurations are possible without departing from the scope of the present disclosure. The anchor system 1702 may be operable, at least in part, by operation of a release handle 1706.

In this embodiment, the infant car seat 1700 also includes a stroller attachment mechanism 1708. The stroller attachment mechanism 1708 includes a connection element 1710, such as a tab or protrusion that can extend outward from a side of a seat shell 1712 of the infant car seat 1700. The connection element 1710 may be configured to extend from the seat shell and may be, in some configurations, selectively retracted into the seat shell 1712. FIG. 17B illustrates the connection element 1710 in an extended or use state where the connection element 1710 may engage with a lip, rim, or other structure of a stroller and thus hold the infant car seat 1700 in position relative to the stroller. To remove the infant car seat 1700 from the stroller, the connection element 1710 must be retracted and thus disengage from the structure of the stroller.

The connection element 1710 is configured to be biased toward a locked position or extended position (FIG. 17A-17B). In the locked or extended position, the connection element 1710 protrudes from an outer surface of the seat shell 1712 and can engage with one or more features on a stroller or other device, structure, system, or assembly. The connection element 1710 includes or is attached to a first actuation tab 1714. The first actuation tab 1714 is configured to be acted upon to cause the connection element 1710 to be pulled into the seat shell 1712 and disengage from a structure of the stroller or other system. In this configuration, the first actuation tab 1714 is configured to interact with a part of a release connector 1717 (e.g., similar to first release connector 1514 of FIGS. 15A-15B). In this configuration, the release connector 1716 includes a second actuation tab 1718 arranged along the length of the release connector 1716. The position of the second actuation tab 1718 is arranged such that it aligns with the first actuation tab 1714 and movement of the second actuation tab 1718 by operation or movement of the release connector 1716 will cause the second actuation tab 1718 to interact with the first actuation tab 1714. The movement of the release connector 1716 may be caused by manual operation of the release handle 1706. For example, as the release handle 1706 is pulled backward (e.g., outward from a back of the infant car seat 1700), the release connector 1716 will move backward and cause the second actuation tab 1718 to contact and urge the first actuation tab 1714 inward (against a normal biasing force) and thus allow release of the infant car seat from a stroller or the like (FIG. 17C).

As shown in FIGS. 17B-17C, and as noted above, the configuration of the infant car seat 1700 may be similar to other embodiments described herein. For example, the release handle 1706 may be operably coupled to a sliding connector 1720 which in turn is connected to one or more additional components (e.g., as shown and described in FIGS. 15A-15D).

Referring to FIG. 17D, a schematic illustration of the release connector 1716 is shown. The release connector 1716 shown in FIG. 17D may be representative of one configuration of the first release connector 1514 shown in FIGS. 15A-15B, although such embodiments may have a first release connector having a different arrangement and/or construction. As shown in FIG. 17D, the release connector 1716 includes a first connection end 1722 at a first end 1724 and a second connection end 1726 at a second end 1728 opposite the first end 1724. The first connection end 1722 of the release connector 1716 may be configured to attach to the handle 1706 or may be configured to operably connect to the handle 1706. The second connection end 1726 may be configured to attach to the sliding connector 1720. Between the first end 1724 and the second end 1728 is the second actuation tab 1718. As noted above, the position of the second actuation tab 1718 is selected to ensure alignment and engagement with the first actuation tab 1714 of the connection element 1710 during movement of the release connector 1716.

FIG. 17E illustrates the connection element 1710. As shown, the connection element 1710 includes a body 1730 that is arranged to fit within a respective aperture formed in the seat shell 1712 and is configured to slide along such an aperture between an extended position (FIGS. 17A-17B) and a retracted position (FIG. 17C). Extending from the body 1730 is a locking protrusion 1732, which is configured for engagement with or contact with a part of a stroller or other device, assembly, system, or the like. The body 1730 also includes the first actuation tab 1714 extending from a surface of the body 1730. The arrangement of the first actuation tab 1714 is provided to ensure operation with the second actuation tab 1718 of the release connector 1716. When the second actuation tab 1718 contacts the first actuation tab 1714, the body 1730 will be urged from the extended state (FIGS. 17A-17B) to the retracted state (FIG. 17C).

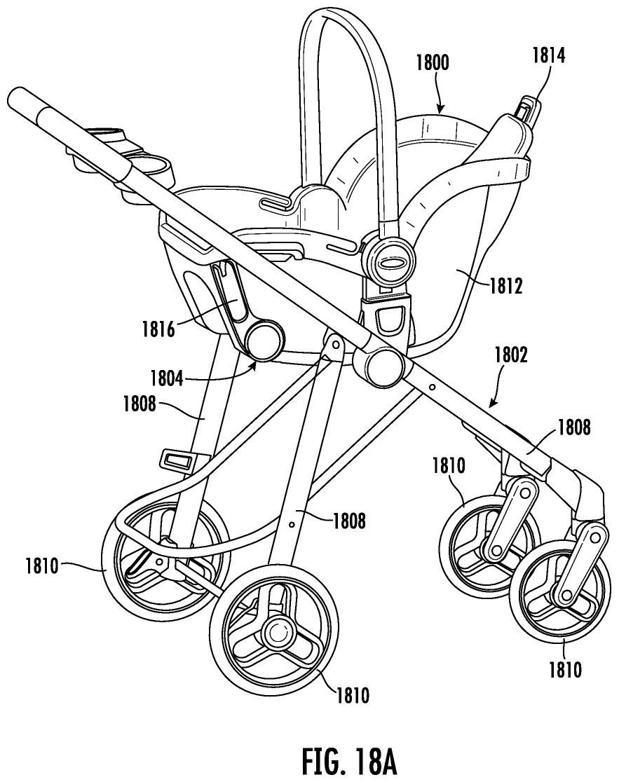

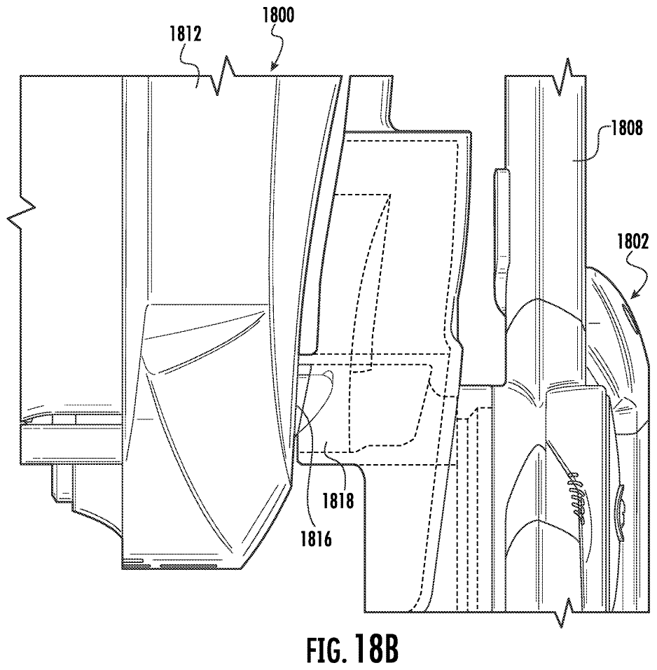

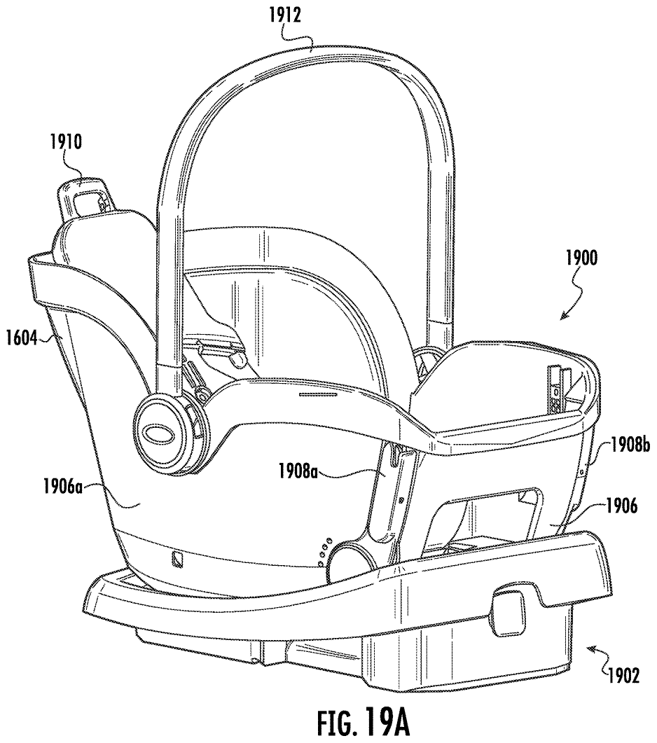

Referring now to FIGS. 18A-18B, schematic illustrations of an infant car seat 1800 and a stroller frame 1802 in accordance with an embodiment of the present disclosure are shown. The infant car seat 1800 may be similar to one or more of the above-described embodiments and includes one or more anchor systems 1804 for securing the infant car seat 1800 to a vehicle seat, as shown and described above. The stroller frame 1802 is a structural configuration having a stroller handle 1806, one or more frame body elements 1808, and associated wheels 1810.

As shown in FIG. 18B, the infant car seat 1800 includes a seat shell 1812, such as similar to that shown and described above. In this configuration, the infant car seat 1800 and anchor system 1804 are configured to releasably attach or mount to the stroller frame 1802. The anchor system 1804 includes a structure and arrangement similar to that shown and described with respect to FIGS. 17A-17D, having a handle 1814 that is operably connected to a latch arm 1816 by means of, at least, release connector (e.g., release connector 1716) having an actuation tab (e.g., second actuation tab 1718) that is configured to interact with a connection element 1816 (e.g., connection element 1710). As shown in FIG. 18B, the connection element 1816 extends outward from the seat shell 1812 and engages with a stroller stop structure 1818. The stroller stop structure 1818 is configured to receive the connection element 1816 (or similar structures) to securely attach the infant car seat 1800 to the stroller frame 1802. The handle 1814 may be actuated or operated by a user to retract the connection element 1816 (or multiple connection elements) to allow for the infant car seat 1800 to be removed from the stroller frame 1802, such as for carrying and/or installation in a vehicle.

In accordance with some embodiments of the present disclosure, the infant car seats may be capable of secure installation directly to a vehicle seat, to a stroller frame, and to a base or similar structure. In the above described and illustrated configurations, the disclosed configurations were directed to having the seat shell or rails thereof that rest directly upon a vehicle seat. Although this may provide ease of use and operation and reduce or limit the number of components of an infant car seat system, it may be advantageous to use a base or similar structure with the infant car seats described herein. In such a configuration, the base may be installed to a vehicle seat, and the infant car seat may be arranged to releasably be installed on and support on the base.

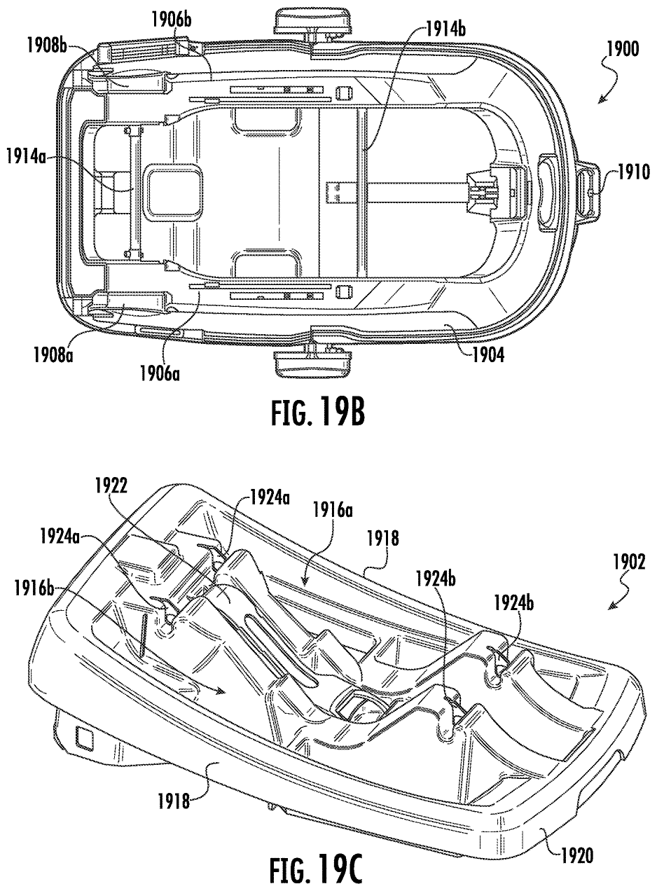

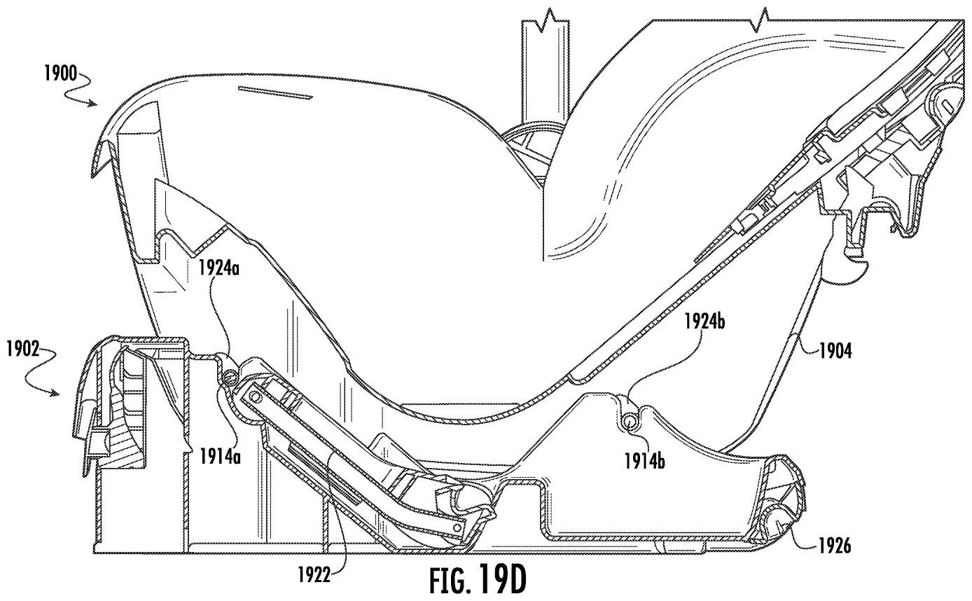

For example, referring now to FIGS. 19A-19D, schematic illustrations of an infant car seat 1900 and associated base 1902 are shown. The infant car seat 1900 may be similar to one or more of the above-described embodiments or variations thereon. The infant car seat 1900 includes a seat shell 1904 having rails 1906a, 1906b, anchor systems 1908a, 1908b, an associated actuation handle 1910, and a carry handle 1912. The actuation handle 1910 and/or the carry handle 1912 may be configured to enable operation of the anchor systems 1908a, 1908b, as shown and described above. The infant car seat 1900 may include various features, structures, and components as shown and described above, variations thereon, and/or other components, features, and the like, as will be appreciated by those of skill in the art.

FIG. 19B illustrates an underside of the infant car seat 1900. As shown, the infant car seat 1900 includes one or more seat connectors 1914a, 1914b. The seat connectors 1914a, 1914b are configured to engage with or be received by locking mechanisms of the base 1902. One of the seat connectors 1914a, 1914b (e.g., a forward seat connector 1914a) may be configured as part of the anchor systems 1908a, 1908b. For example, the forward seat connector 1914a may be arranged to operate as a hub shaft and/or linking shaft (e.g., shafts 508, 536 of FIGS. 5A-5F). The seat connectors 1914a, 1914b may be rods, tubes, shafts, axles, or other structures that may be structural support elements or may be arranged for the purpose of connection to the base 1902 or similar types of connections. In some configurations, the seat connectors 1914a, 1914b may provide structural support to the structure of the infant car seat 1900 (e.g., support side rails, resist compression from an external source, etc.). Further, although shown with two seat connectors, it will be appreciated that other infant car seats in accordance with the present disclosure may have a single seat connector or more than two, without departing from the scope of the present disclosure.

FIG. 19C illustrates a view of the base 1902 that is configured to receive and securely attach to the infant car seat 1900. The base 1902 may be configured to be installable on a vehicle seat or to other structures, vehicles, or the like, or may be attached to the infant car seat 1900 to provide a flat base/surface thereto. The base 1902 includes a first rail channel 1916a and a second rail channel 1916b. The rail channels 1916a, 1916b are sized, shaped, contoured, and/or otherwise configured to receive the rails 1906a, 1906b of the infant car seat 1900. The rail channels 1916a, 1916b are defined, in part, by a rim 1918 of a base body 1920. The rail channels 1916a, 1916b are also separated by an internal structure of the base 1902, which includes a seatbelt lock mechanism 1922 and one or more sets or pairs of base connectors 1924a, 1924b. Although shown as pairs, in other configurations, the base connectors maybe configured as single base connectors, or more than two may be provided in a given set, and/or combinations of one or more base connectors may be provided to releasably receive the seat connectors 1914a, 1914b of the infant car seat 1900. The base connectors may be arranged as plates, hooks, latches, or other structures that provide the functionality described herein, and thus the illustrative configurations and structures are not intended to be limiting, but rather is for illustrative and explanatory purposes. The operation of the base connectors 1924a, 1924b are described in more detail herein.

As shown in FIG. 19D, a side, cross-sectional illustration shows the infant car seat 1900 as seated and attached to the base 1902. As shown, the forward seat connector 1914a is captured by one or more respective forward base connectors 1924a. Similarly, the rear seat connector 1914b is captured by one or more respective rear base connectors 1924b. The base connectors 1924a, 1924b may be simultaneously operated by a single base handle 1926. That is, the base handle 1926 may be configured to release a connection or coupling between the base 1902 and the infant car seat 1900 at multiple points of attachment in a single operation.

As shown in FIGS. 19A-19D, the infant car seat 1900 is connected to the base 1902 through two seat connectors 1914a, 1914b and two sets of base connectors 1924a, 1924b. The seat connectors 1914a, 1914b may be rigidly fixed to the seat shell 1904 of the infant car seat 1900 and the base connectors 1924a, 1924b are connected to or part of the base 1902. The base connectors 1924a, 1924b can each pivot about an axis and are biased toward a latched position (e.g., as shown in FIG. 19D). When the infant car seat 1900 is placed on the base 1902, the base connectors 1924a, 1924b engage with the seat connectors 1914a, 1914b and hold the infant car seat 1900 to the base 1902. The base 1902 includes the base handle 1926 that operates as a release mechanism that forces the base connectors 1924a, 1924b to an unlatched position, thus releasing the seat connectors 1914a, 1914b and allowing the infant car seat 1900 to be removed from the base 1902.

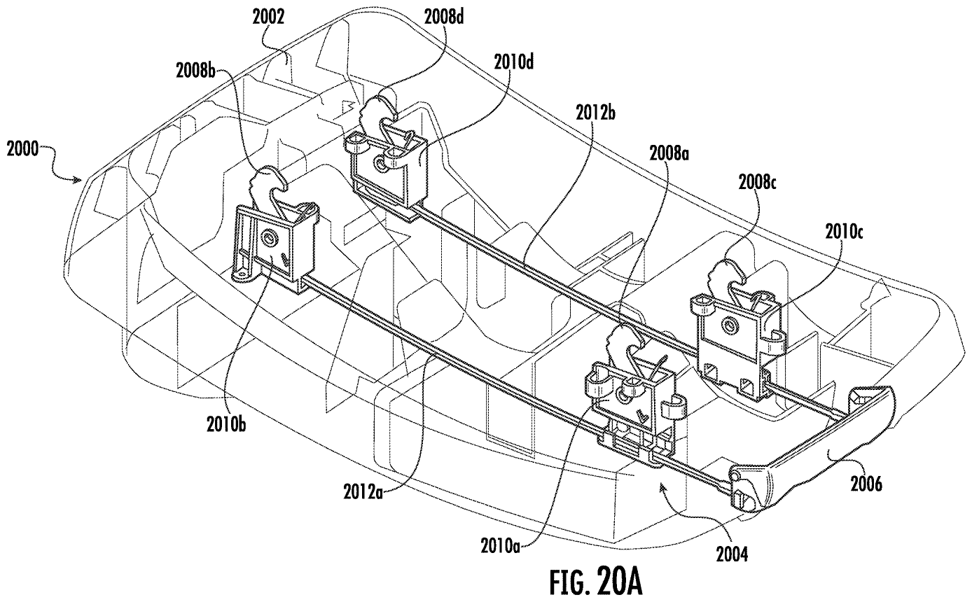

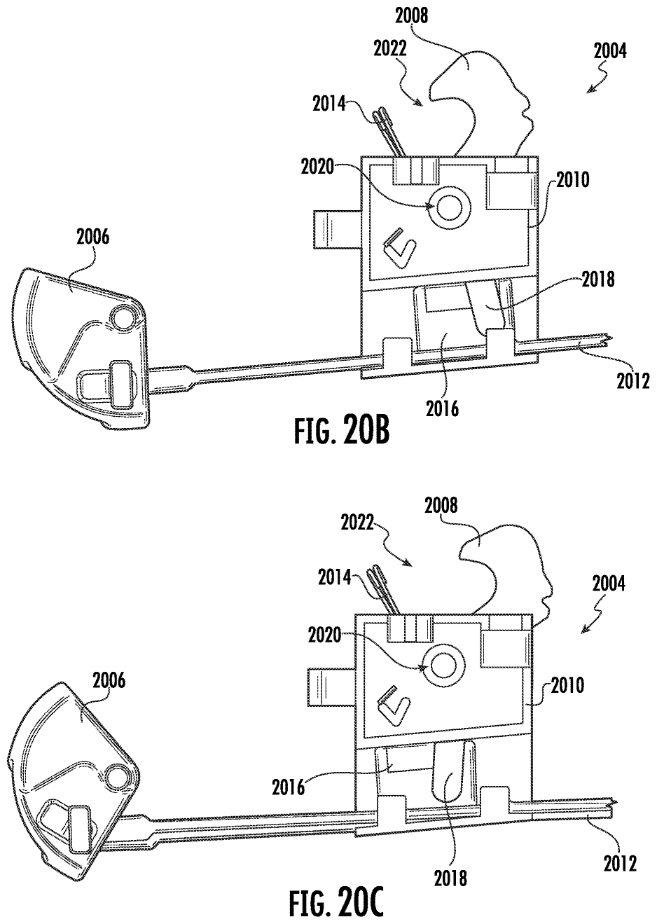

Referring now to FIGS. 20A-20C, schematic illustrations of a base 2000, and features thereof, for use with an infant car seat in accordance with an embodiment of the present disclosure. The base 2000 may be similar to the base shown in FIGS. 19A-19D and may be configured to receive and securely attach to an infant car seat in accordance with one or more of the embodiments described herein and/or variations thereon. In FIG. 20A, the base 2000 is shown in mostly phantom and structural features of a base body 2002 of the base 2000 may be omitted in the present discussion. However, the base body 2002 of the base 2000 may have a substantially similar structure or configuration as the base body 1920 of the base 1902 shown in FIG. 19C (e.g., including, for example, rail channels for receiving rails of an infant car seat).

The base body 2002 may be a structural shell or assembly that includes a seat retention assembly 2004. The seat retention assembly 2004 is configured to allow a user to selectively secure and/or release an infant car seat from the base 2000. The seat retention assembly 2004, in this illustrative configuration, includes a release handle 2006, four base connectors 2008a-d, four base connector housings 2010a-d associated with each base connector 2008a-d, and two base connector actuators 2012a-b, with two base connector housings 2010a-d associated with each base connector actuator 2012a-b. Each base connector 2008a-d is connected to or installed within a respective base connector housing 2010a-d and the base connector housings 2010a-d are rigidly or fixedly connected to the base body 2002. The release handle 2006 is moveably connected to the base body 2002 and is arranged to pivot about an axis and/or relative to the base body 2002. The base connector actuators 2012a-b are connected to the release handle 2006. The base connector actuators 2012a-b extend from the release handle 2006 and extend through the base body 2002 and through respective base connector housings 2010a-d. In accordance with some embodiments, the base connector actuators 2012a-b may be slidably constrained by an opening in each of the respective base connector housings 2010a-d. The base connector actuators 2012a-b may include features that engage with the base connectors 2008a-d. When the release handle 2006 is actuated, the release handle 2006 will pull on the base connector actuators 2012a-b. The base connector actuators 2012a-b will slide through the base connector housings 2010a-d and force the base connectors 2008a-d to pivot to an unlatched position.

Referring to FIGS. 20B-20C, schematic illustrations of a portion of the seat retention assembly 2004 are shown. In FIGS. 20B-20C, the release handle 2006 is shown connected to a base connector actuator 2012 (representative of the base connector actuators 2012a-b). The base connector actuator 2012 may be configured as a rod, shaft, or other rigid structure, or may be a strap, band, cable, or other flexible or semi-flexible structure. The base connector actuator 2012 extends from the release handle 2006 and extends through a base connector housing 2010 (representative of the base connector housings 2010a-d) and is configured to cause actuation or operation of a base connector 2008 (representative of the base connectors 2008a-d). FIG. 20B illustrates the base connector 2008 in a lock state and FIG. 20C illustrates the base connector 2008 in the release state. The base connector 2008 is normally biased into the lock state (FIG. 20B). For example, a base connector biasing element 2014 may be provided within or as part of the base connector housing 2010 and arranged to normally bias the base connector 2008 into the lock state. By operation of the release handle 2006, the biasing force of the base connector biasing element 2014 may be overcome and thus transition the base connector 2008 from the lock state to the release state.

In this non-limiting example configuration, the opening of the base connector 2008 from the lock position may be achieved through an interaction between the base connector actuator 2012 and the base connector 2008. For example, as shown, the base connector actuator 2012 may include a base connector actuation member 2016 that is integrally formed or fixedly attached to the base connector actuator 2012. The base connector actuation member 2016 may be a housing or structure extending from the base connector actuator 2012. The base connector actuation member 2016 may be arranged within and relative to the base connector housing 2010 and may be configured to receive a base connector extension 2018 of the base connector 2008. The base connector 2008 and the base connector extension 2018 may be part of an integral or single piece (e.g., a flat, shaped plate) and may be pivotable about a pivot axis 2020. Accordingly, as the release handle 2006 is operated, the base connector actuator 2012 will be moved (e.g., to the left on the page of the figures), and the base connector actuation member 2016 will interact with the base connector extension 2018 to cause rotation of the base connector 2008 from the lock state to the release state.

The base connector 2008 is shaped to capture and securely retain a connecting tube of an infant car seat (e.g., as shown and described with respect to FIGS. 19A-19D). Because the base connector 2008 is normally biased into the lock state, when installing an infant car seat, the user will push downward such that the seat connectors of the infant car seat will overcome the biasing force of the base connector biasing elements 2014 and force the seat connectors to be captured and secured by the base connectors 2008. That is, as the biasing force is overcome, the base connectors 2008 will be rotated out of the way to permit the seat connectors to drop or fit into a latch capture region 2022. When the connecting tube sits within the latch capture region 2022, the base connector 2008 will be urged back to the lock state by the biasing force of the base connector biasing element 2014, and thus capture the connecting tube in the latch capture region 2022. To release the infant car seat from engagement with the base 2000, the user will operate the release handle 2006 which will operate the base connectors 2008 and cause them to transition from the lock state to the release state and the infant car seat may be removed. In some embodiments, the base connector housings 2010 may include an assistive release mechanism, such as a spring-loaded element to apply an upward force such that when the base connectors 2008 are moved into the release state by operation of the release handle 2006, the assistive release mechanism may apply an upward force to the seat connectors and push upward to aid a user in separating an infant car seat from the base 2000. Although shown with base connector actuation members 2016 that are integrally formed with or attached to the base connector actuators 2012, such configuration is not to be limiting. For example, in other embodiments, the base connector extensions may be directly coupled to the base connector actuators.

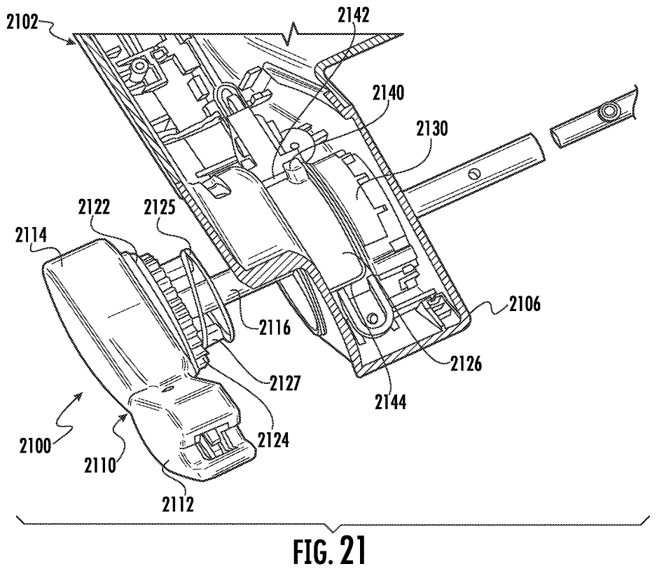

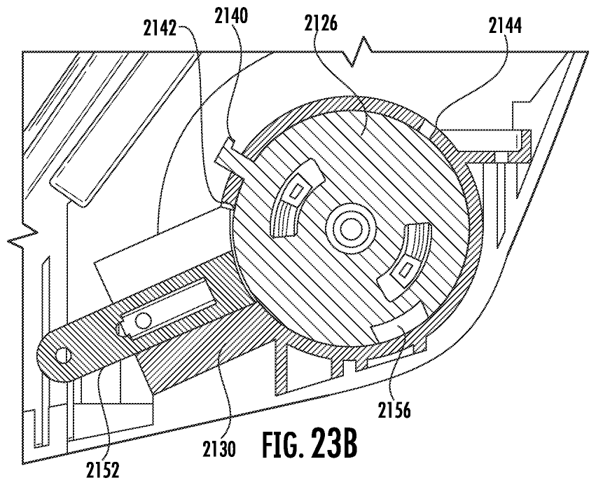

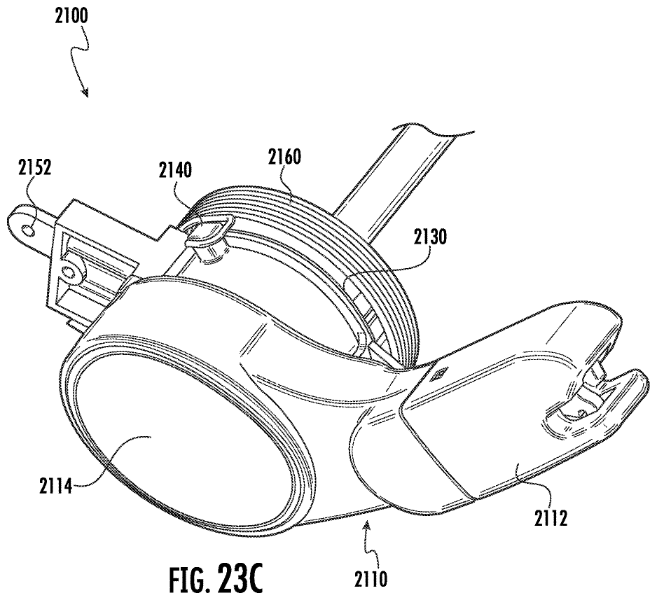

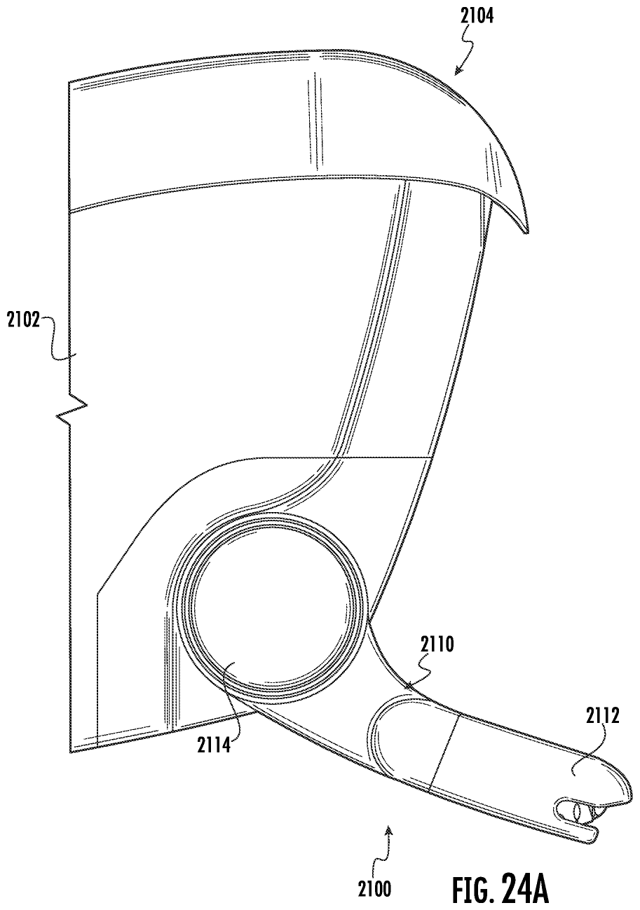

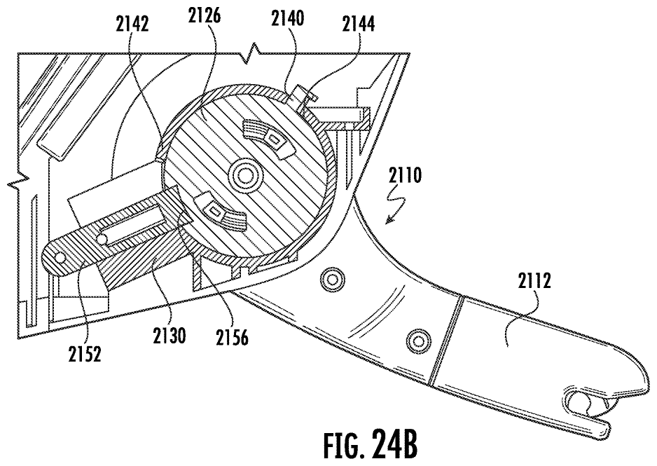

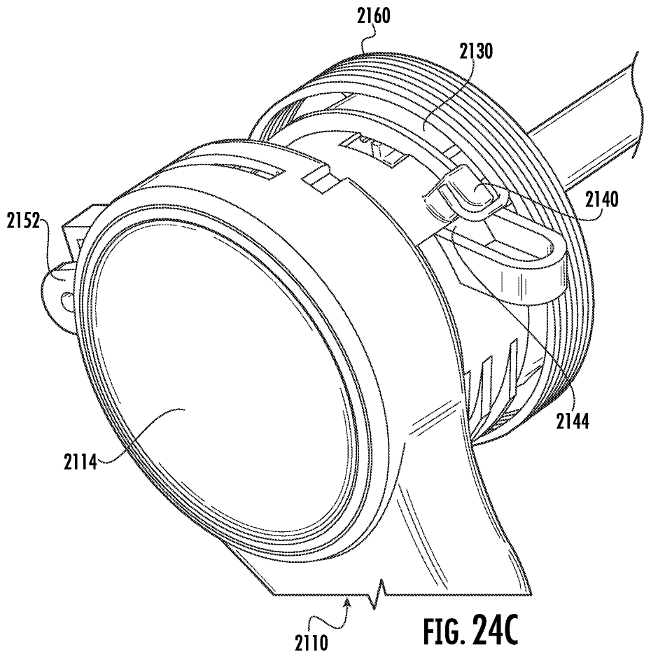

Referring now to FIGS. 21-24C, schematic illustrations of an anchor system 2100 in accordance with an embodiment of the present disclosure are shown. FIGS. 23A-23C illustrate the anchor system 2100 in an unlocked state (e.g., stowed position) and FIGS. 24A-24C illustrate the anchor system 2100 in a locked state (e.g., use position). It should be understood that the term “use position” as used herein is intended to describe any position of the latch arm 2110 where the latch 2112 is connectable to a vehicle anchor system while the infant car seat is positioned relative to a vehicle seat in any suitable manner to receive a child.

The anchor system 2100 may be similar to that shown and described with respect to FIGS. 3, 4, and 5A-5F, with additional or alternative features and/or operation as described herein. The anchor system 2100 is arranged within and is operably coupled to a seat shell 2102 of an infant car seat 2104. The infant car seat 2104 may be arranged and configured as shown and described above or may take other shapes, configurations, or arrangements, without departing from the scope of the present disclosure.

The anchor system 2100 includes a latch arm 2110 having a latch 2112 or connection end arranged at a distal end thereof. The latch 2112 may be configured to releasably connect or attach to a vehicle anchor system, such as described above. The latch arm 2110 includes a latch arm hub 2114 that is rotatably mounted to a hub shaft 2116. In some embodiments, the hub shaft 2116 may be integrally formed with the latch arm hub 2114. The anchor system 2100 may further include a latch attachment mechanism 2120 having a recline hub 2122, a recline gear 2124, a memory hub 2126, and one or more ramp hubs 2128. The recline gear 2124 may be arranged within and/or between the recline hub 2122 and the memory hub 2126. As will be described in more detail below, in this configuration, the memory hub 2126 is arranged to be rotatable relative to the seat shell 2102 between a first retracted position and a second extended position. The anchor system 2100 may further include various elements not shown, such as ramp hubs, actuators, switches, connectors, links, and the like.

Each of the recline hub 2122, the recline gear 2124, the memory hub 2126, and the one or more ramp hubs 2128 may have a central aperture or through hole through which the hub shaft 126 may extend. As such, in some embodiments, the recline hub 2122, the recline gear 2124, the memory hub 2126, and the one or more ramp hubs 2128 may be mounted to or supported on the hub shaft 2116. In other embodiments, one or more of these components may be arranged to permit the hub shaft 2116 to pass therethrough, without direct contact or engagement, and in some such configurations, the hub shaft 2116 may operate to secure alignment of components but may not provide other operationally functionality.

The anchor system 2100 is configured such that the latch arm 2110 is rotatable or pivotable about an axis (e.g., defined by the hub shaft 2116). Similarly, as previously described, the recline gear 2124 may be configurated as a sliding gear that locks the position of the latch arm 2110 in one or more positions. In accordance with some embodiments of the present disclosure, the anchor system 24 may be split into two layers of freedom. For example, a first degree of freedom is formed by the axial movement of the recline gear mechanism (e.g., recline gear 2124) within the anchor system 2100 to lock the angular position of the recline hub 2122 and latch arm 2110 relative to the memory hub 2126. In an embodiment, the second degree of freedom is formed by the memory hub 2126 which is rotatably mounted relative to the seat shell 2102. Because the recline hub 2122 can be positionally locked to the memory hub 2126 by the recline gear 2124, when the memory hub 2126 rotates, the recline hub 2122 rotates therewith.

The latch attachment mechanism 2120 of the illustrated, non-limiting embodiment includes a memory hub 2126, a first ramp hub 2128a, and a second ramp hub 2128b as previously described. Similar to one or more of the embodiments previously described herein, the rotation of the second ramp hub 2128b causes actuation or operation of the anchor system 2100. The rotation of the second ramp hub 2128b may be caused by a recline actuator (not shown). The recline gear 2124 may be biased toward the locked state by means of a hub biasing element 2125 positioned between the recline gear 2124 and the memory hub 2126. When the recline actuator is operated, the rotation of the second ramp hub 2128b will urge the first ramp hub 2128a axially toward the recline hub 2122 and cause the recline gear 2124 by means of the posts 2127 out of engagement with the memory hub 2126 and into full engagement with the recline hub 2122. During this transition, the hub biasing element 2125 is compressed between the recline gear 2124 and the recline hub 2122. As such, the latch arm 2110 is freely rotatable relative to the memory hub 2126 and therefore the seat shell 2102. When the latch arm 2110 is positioned as desired, the hub biasing element 2125 may urge the recline gear 2124 back into engagement with the memory hub 2126, thus locking the latch arm 2110 in the desired position.

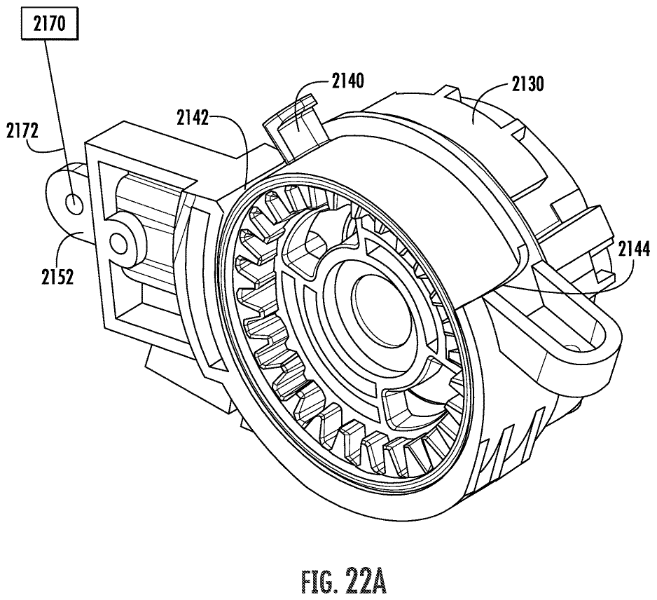

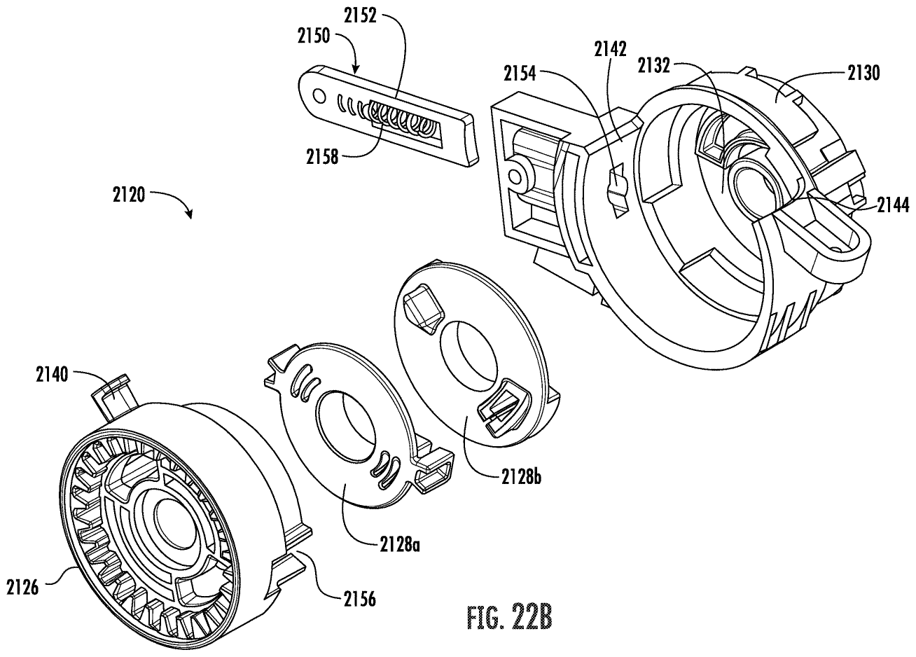

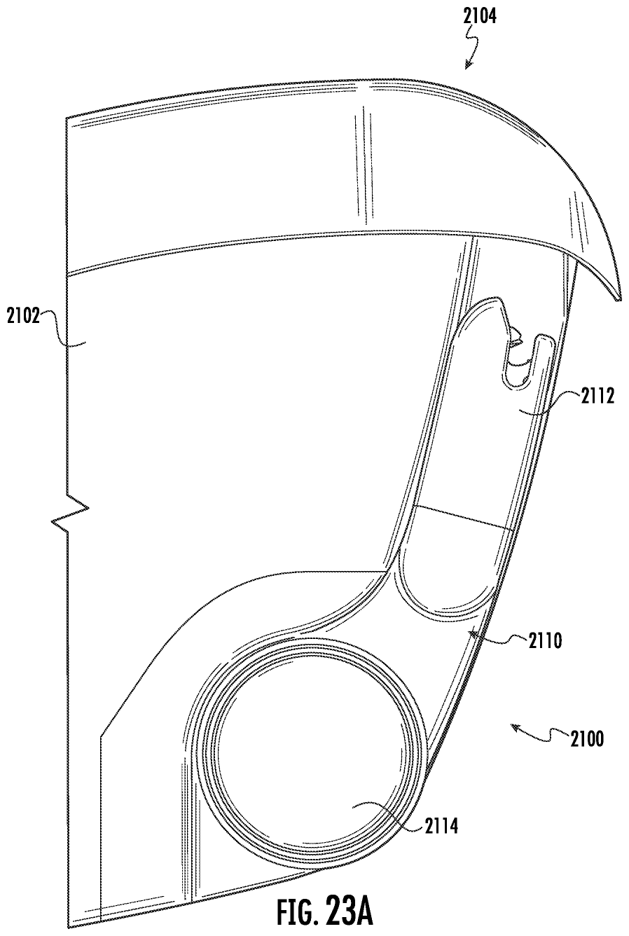

A cartridge or housing 2130 having a cavity 2132 formed therein may be mounted within the infant car seat 2104, such as within a seat shell rail 2106 for example. A portion of the latch attachment mechanism 2120, such as the memory hub 2126, the first ramp hub 2128a, and a second ramp hub 2128b for example, are arranged within the cavity 2132 (see FIGS. 21 and 22). In an embodiment, the memory hub 2126 is rotatable relative to the cartridge 2130, and therefore relative to the seat shell 2102, between a first, retracted or stowed position (FIG. 23A-23C) and a second, extended or use position (FIG. 24A-24C). As shown, a protrusion 2140, such as a tab for example, may extend radially outwardly from a periphery of the memory hub 2126. In such embodiments, when the memory hub 2126 is in the retracted position, the protrusion 2140 may abut a first sidewall 2142 of the cartridge 2130 and when the memory hub 2126 is in the extended position, the protrusion 2140 may abut a second sidewall 2144 of the cartridge 2130.

In accordance with some embodiments of the present disclosure, during a transition of the memory hub 212 from the retracted position to the extended position, the angular position of the recline hub 2122 relative to the memory hub 2126 remains generally constant. Once the memory hub 2126 locks into the extended position (FIGS. 24B-C), for example, the recline hub 2122, the latch arm hub 2114, and the latch arm 2110 may be in the same recline position as during a previous or last use. Accordingly, because the recline hub 2122 and therefore the latch arm 2110 can be positionally locked to the memory hub 2126 by the recline gear 2124, when the memory hub 2126 rotates, the recline hub 2122 and latch arm 2110 rotate with it, and when the memory hub 2126 is locked, the recline hub 2122 and latch arm 2110 are locked therewith.

Similarly, in an embodiment, the first ramp hub 2128a and the second ramp hub 2128b may be rotatable with the memory hub 2126 about the axis of the hub shaft 2116 relative to the cartridge 2130. However, the first and second ramp hubs 2128a, 2128b may also be rotatable independently from the memory hub 2126 about the hub axis to transform the recline gear 2124 between an engaged state and a disengaged state as previously described.

The memory hub 2126 may be rotationally locked to the cartridge 2130 and the seat shell 2102 in the extended position by a locking mechanism 2150. In the illustrated, non-limiting embodiment, the locking mechanism 2150 includes a locking plate 2152 movably mounted to the cartridge 2130. As shown, the locking plate 2152 may be axially aligned with a corresponding opening 2154 formed in the cartridge 2130. The body of the memory hub 2126 may have a locking groove or recess 2156 formed therein within which at least a portion of the locking plate 2152 is receivable. In an embodiment, when the memory hub 2126 is in the extended position, the locking recess 2156 is aligned with the opening 2154, and a biasing force of the locking plate biasing mechanism 2158 operably coupled to the locking plate 2152 biases the locking plate 2152 into engagement with the locking recess 2156 of the memory hub 2126 via the opening 2154. This engagement restricts rotation of the memory hub 2126 about its axis, thereby locking the memory hub 2126 in the extended position.

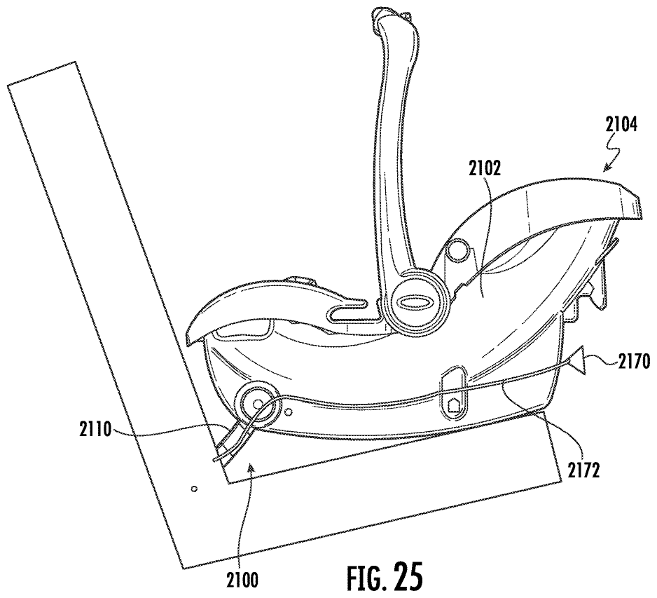

The locking plate 2152 may be connected to a release actuator, such as release handle 2170 (FIGS. 23C and 25), such as located at a rear of the seat shell 2102 (e.g., for manual operation). In some configurations, such a release handle 2170 may also be linked to a mechanism to release the anchor engagement of the latch arms 2110 from a vehicle anchor. When such a release handle 2170 is actuated, the release handle 2170 pulls the locking plate 2152, such as via a tension member or cable 2172 for example, against the bias of the locking plate biasing mechanism 2158 and out of the locking recess 2156 formed in the memory hub 2126. With the locking plate 2152 disengaged from the memory hub 2126, the memory hub is free to rotate (e.g., from one position to another). Accordingly, operation of the release actuator unlocks the memory hub 2126.

In an embodiment, best shown in FIGS. 23C and 24C, a biasing mechanism 2160, such as a coil spring for example, is operably coupled to the memory hub 2126. As shown, a portion of the biasing mechanism 2160, such as an end thereof for example, may be connected to the protrusion 2140 such that as the memory hub 2126 is rotated about the hub axis from the retracted position to the extended position, a load is applied to the biasing mechanism 2160. The biasing force of the biasing mechanism 2160 opposes the load applied thereto by rotation of the memory hub 2126 to the extended position.

A user or caregiver may release the latch arm 2110 from engagement with a vehicle anchor by actuating the release handle. Alternatively, or in addition, operation of the release handle will apply a force to the locking plate 2152, thereby moving the locking plate 2152 against the biasing force of the locking plate biasing mechanism 2158 out of engagement with the memory hub 2126. Once the locking plate 2152 is disengaged from the memory hub 2126, the memory hub 2126, recline hub 2122, recline gear 2124, latch arm hub 2114, and latch arm 2110 are rotatable, in combination, to a desired angular position, such as to a stowed and/or retracted position.

The engagement between the locking plate 2152 and the memory hub 2126 holds the memory hub in the extended position against the biasing force of the biasing mechanism 2160. Upon separation of the locking plate 2152 from the memory hub 2126, the memory hub 2126, and therefore the recline hub 2122, latch arm hub 2114, and latch arm 2110 coupled to the memory hub 2126 by the recline gear 2124 are automatically biased from an extended position to the retracted position. Accordingly, operation of the release handle not only causes the locking plate 2152 to disengage the memory hub 2126, but also causes the memory hub 2126 and the remainder of the anchor system 2100 to automatically rotate from an extended position to the retracted position.

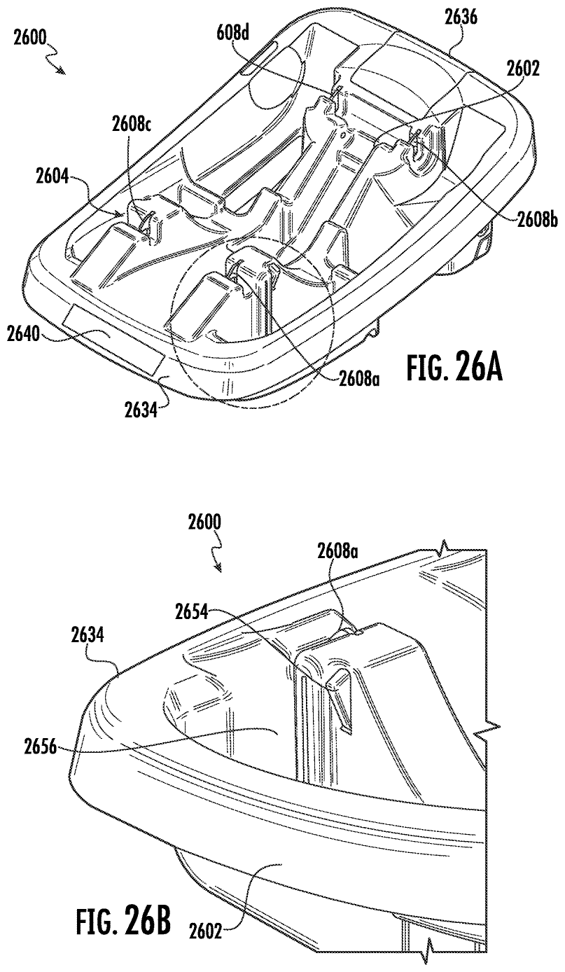

Referring now to FIGS. 26-31B, a base 2600 according to another embodiment of the present disclosure is illustrated. The base 2600 may be similar to the base shown in FIGS. 19A-19D and FIGS. 20A-20D and may be configured to receive and securely attach to an infant car seat in accordance with one or more of the embodiments described herein and/or variations thereon. The base body 2602 of the base 2600 may have a substantially similar structure or configuration as the base body 1920 of the base 1902 shown in FIG. 19C (e.g., including, for example, rail channels for receiving rails of an infant car seat).

The base body 2602 may be a structural shell or assembly that includes a seat retention assembly 2604. The seat retention assembly 2604 is configured to allow a user to selectively secure and/or release an infant car seat from the base 2600. The seat retention assembly 2604 includes at least one base connector 2608, and in this illustrative, non-limiting configuration, includes four base connectors 2608a-d, each having a corresponding base connector housing 2610. Each base connector 2608 is connected to or installed within a respective base connector housing 2610 and the base connector housings 2610 are rigidly or fixedly connected to the base body 2602. When in a locked state, the base connectors 2608 are configured to secure and retain a corresponding seat connector 2616 of an infant car seat 2614 to the base 2600. The seat retention assembly 2604 may additionally include two base connector actuators 2612, with two base connector housings 2010 associated with each respective base connector actuator 2012.

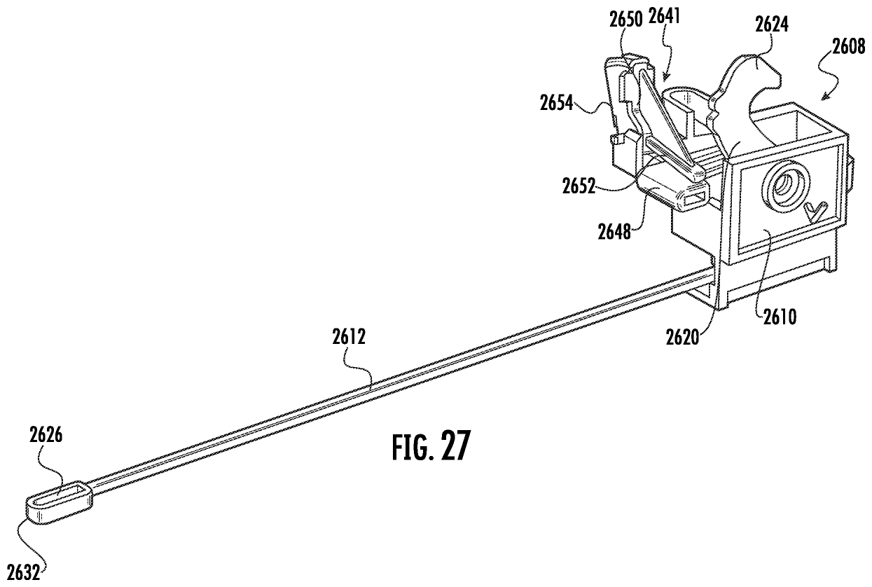

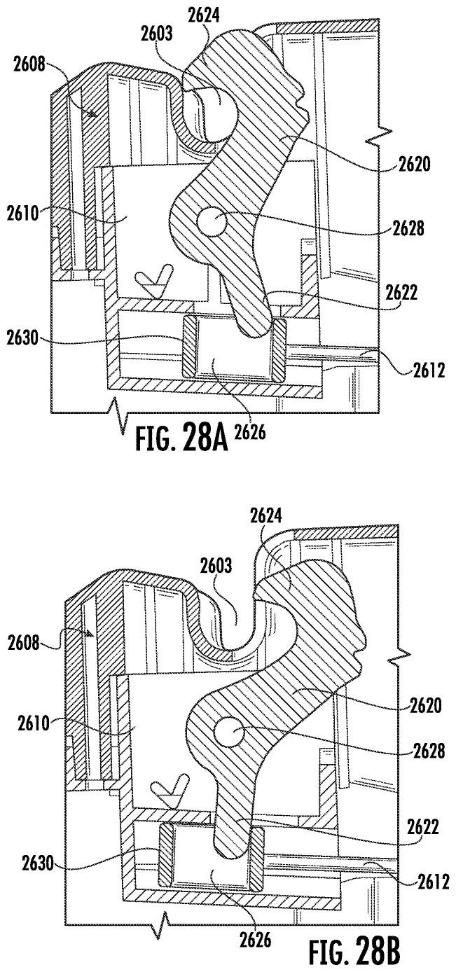

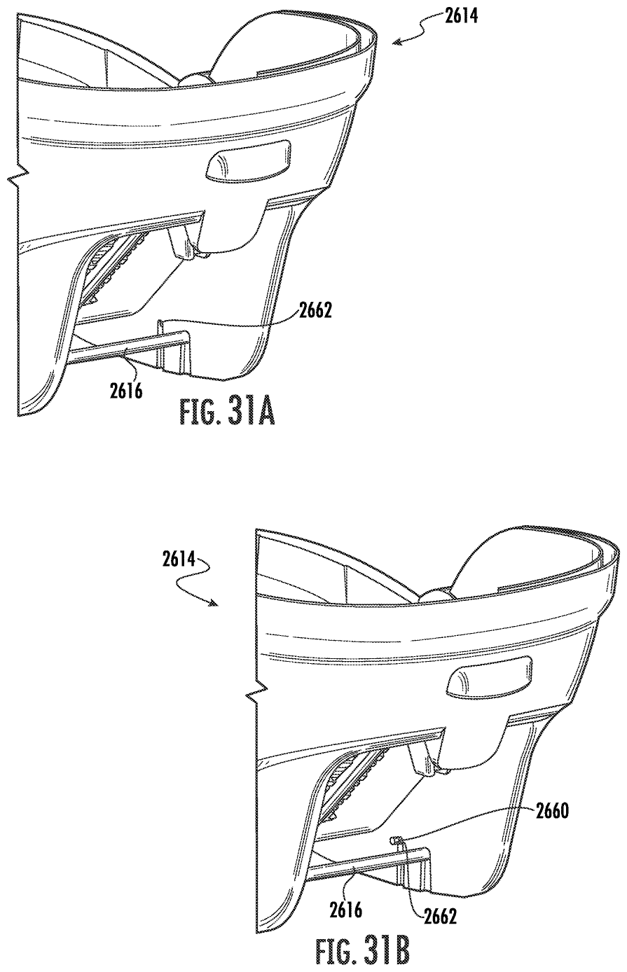

With reference now to FIG. 27, an example of a base connector 2608 is illustrated in more detail. As shown, each base connector 2608 includes a locking plate 2620 mounted to a corresponding base connector housing 2610 adjacent to a latch capture region 2603 formed in the base body 2602. The locking plate 2620 may have a first portion 2622 (see FIG. 28A), such as a first end for example, associated with a base connector actuator 2612 and a second portion 2624, such as a second end for example, engageable with at least one seat connector 2616 (FIG. 31A) of an infant car seat 2614. In an embodiment, the second portion 2624 is shaped to capture and securely retain a seat connector 2616 of an infant car seat 2614.

In the illustrated, non-limiting embodiment, the base connector actuator 2612 has an actuator slot 2626 formed therein and the first portion 2622 of the locking plate 2620 is arranged within the actuator slot 2626. The locking plate 2620 is pivotally mounted to the base connector housing 2610 via a pin 2628 and is rotatable between a locked position (FIG. 28A) and an unlocked position (FIG. 28B). Rotation of the locking plate 2620 from the locked position to the unlocked position may be driven by the engagement of the base connector actuator 2612 and the first portion 2622 of the locking plate 2620.

As noted above, two base connector housings 2610 may be associated with a respective base connector actuator 2612. For example, a first base connector, such as base connector 2608a for example, may be associated with a first actuator slot 2626, such as formed at a first end 2630 of a base connector actuator 2612, and a second base connector, such as base connector 2608b for example, (not shown in FIG. 27 for clarity) may be associated with a second actuator slot 2626, such as formed at a second opposite end 2632 of the base connector actuator 2612. The first base connector 2608a and the second base connector 2608b may be spaced along a longitudinal axis of the base body 2602 such as between a front end 2634 and a back end 2636 of the base body 2062. Accordingly, the first base connector 2608a is configured to cooperate with a first seat connector 2616, such as located near a rear 2618 of the infant car seat 2614, and the second base connector 2608 is configured to cooperate with a second seat connector 2616, such as located near a front 2619 of the infant car seat 2614. It should be appreciated that in some embodiments the seat retention assembly 2604 includes one or more additional base connector actuators 2612, each having at least one of a first and second base connector, such as base connectors 2608c and 2608d for example, associated therewith.

Each base connector actuator 2612 may be movable to unlock the base connectors 2608 associated therewith via operation of a release actuator 2640, such as a handle for example. In an embodiment, the release actuator 2640 is movably connected to the base body 2602 and the at least one base connector actuator 2612 is operably coupled to the release actuator 2640. For example, the base connector actuator 2612 may extend from the release actuator 2640 through the base body 2602 and the respective base connector housings 2610 of the first and second base connectors 2608a, 2608b. In accordance with some embodiments, the base connector actuator 2612 may be slidably constrained by each of the respective base connector housings 2610. When the release actuator 2640 is actuated such as via application of a force thereto, the release actuator 2640 will transmit the force to the base connector actuators 2612 causing the base connector actuators 2612 to slide or translate. As a result of the engagement of a locking plate 2620 with a corresponding base connector actuator 2612, this movement will cause the locking plate 2620 of the base connectors 2608 to pivot to an unlocked position.

The base connector 2608, and specifically the locking plate 2620 thereof, may be normally biased into the lock state. For example, a base connector biasing element (not shown) may be provided within or as part of the base connector housing 2610 and arranged to normally bias the locking plate 2620 into the locked state. By operation of the release actuator 2640, the biasing force of the base connector biasing element may be overcome and thus transition the locking plate 2620 of the base connector 2608 from the locked state to the unlocked state.

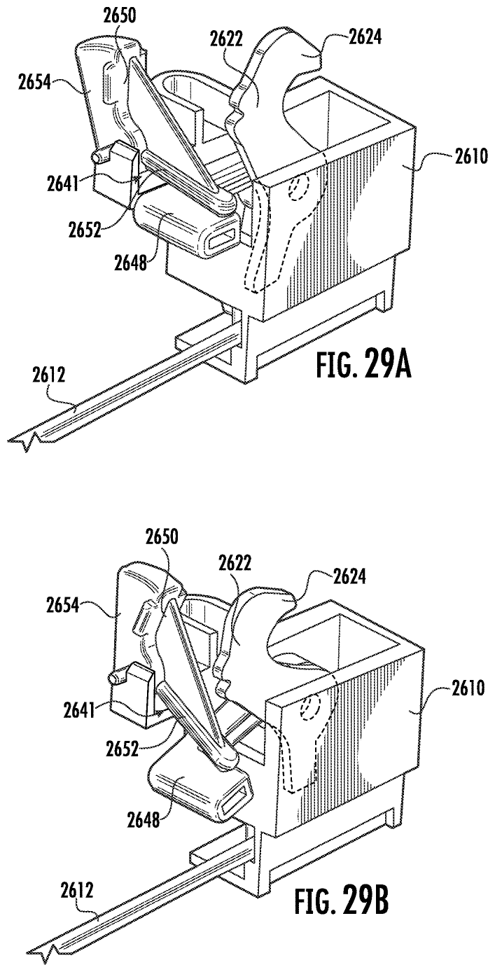

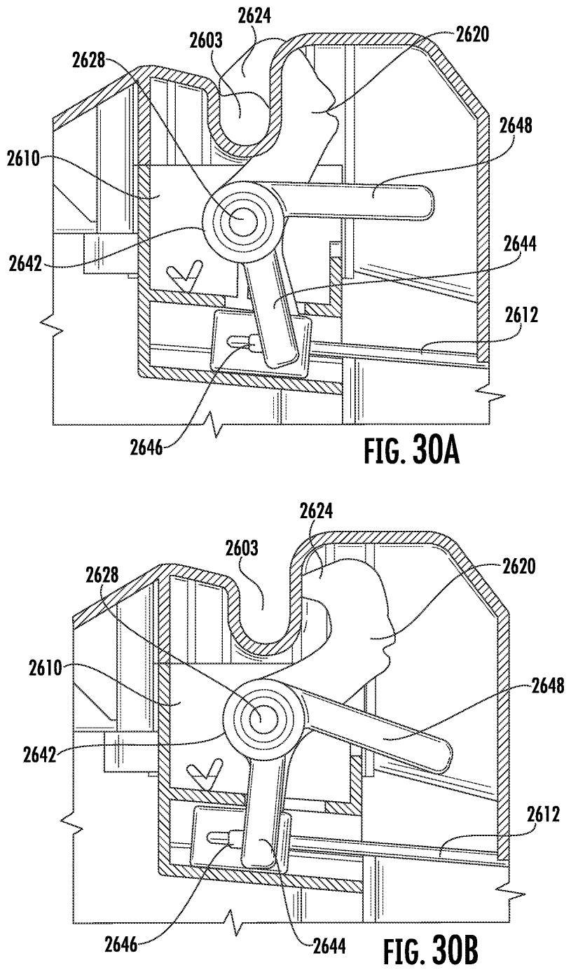

With continued reference to FIG. 27 and further reference to FIGS. 29-30B, in an embodiment, at least one base connector 2608 associated with each base connector actuator 2612 additionally includes an infant car seat release assembly 2641 operable to transform the locking plate 2620 to an unlocked position. As shown, the infant car seat release assembly 2641 has a driving toggle 2642 selectively operable to move the base connector actuator 2612 to unlock the locking plates 2620 of the base connectors 2608 associated therewith. In the illustrated non-limiting embodiment, the base connector 2608 positioned closest to the front end 2634 of the base body 2602 includes the driving toggle 2642.

The driving toggle 2642 may be mounted to the base connector housing 2610, such as an interior of the housing for example. As shown, the driving toggle 2642 includes a first portion 2644, such as a first leg for example, generally positioned adjacent to and movable to engage the base connector actuator 2612. In an embodiment, the base connector actuator 2612 has a rib or protrusion 2646 extending therefrom that the first portion 2644 is operable to engage to move the base connector actuator 2612. The driving toggle 2642 may additionally include a second portion 2648, such as a second leg for example, arranged at a non-parallel angle to the first portion 2644.

In an embodiment, the driving toggle 2642 is rotatably mounted to the base connector housing 2610 via the pin 2628 such that the driving toggle 2642 and the locking plate 2620 are coaxial. However, embodiments where the axis of rotation of the driving toggle 2642 is distinct from the axis of rotation of the locking plate 2620 are also within the scope of the disclosure. The driving toggle 2642 is rotatable about an axis between a first, unactuated position (FIGS. 29A and 30A) and a second, actuated position (FIGS. 29B and 30B). As the driving toggle 2642 rotates towards the second, actuated position, the first portion 2644 of the driving toggle 2642 contacts and applies a force to the base connector actuator 2612, causing the base connector actuator 2612 to translate within the base connector housing 2610. As noted above, movement of the base connector actuator 2612 will cause the locking plates 2620 of the base connectors 2608 associated with a corresponding base connector actuator 2612 to pivot to an unlocked position.

As shown, an actuation toggle 2650 of the infant car seat release assembly 2641 may be mounted to the base connector housing 2510 and operably coupled to the driving toggle 2642. The actuation toggle 2650 includes an engagement foot 2652 positionable in overlapping arrangement with the second portion 2648 of the driving toggle. The actuation toggle 2650 additionally includes an engagement head 2654 that is positionable at an exterior of the base body 2602. In the illustrated, non-limiting embodiment, the engagement head 2654 extends outwardly towards a rail channel 2656 formed in the base body 2602. The actuation toggle 2650 may be pivotable relative to the base connector housing 2610 between an extended position (FIGS. 29A and 30A) and a retracted position (FIGS. 29B and 30). In the illustrated, non-limiting embodiment, the axis of rotation of the actuation toggle 2650 is arranged at an angle to the axis of rotation of the driving toggle 2642 and/or the locking plate 2620. As shown, the axis of rotation of the actuation toggle 2650 may be generally perpendicular to the axis of rotation of the driving toggle 2642 and/or the locking plate 2620.

As the actuation toggle 2650 rotates about the axis to the retracted position, the engagement foot 2652 contacts and transmits a force to the second portion of the driving toggle 2642, causing the driving toggle to rotate into engagement with the base connector actuator 2612 and the locking plate 2620 to unlock. In an embodiment, a biasing mechanism (not shown) is operably coupled to the driving toggle 2642 and is operable to bias the driving toggle toward the unactuated position. Accordingly, once the force acting on the engagement head 2654 of the actuation toggle 2650 is removed, the biasing force of the biasing mechanism will bias the driving toggle 2642 toward the unactuated position. During this movement, the second portion 2648 will engage and apply a force to the engagement foot 2652, causing the actuation toggle 2650 to similarly rotate back to the extended position.

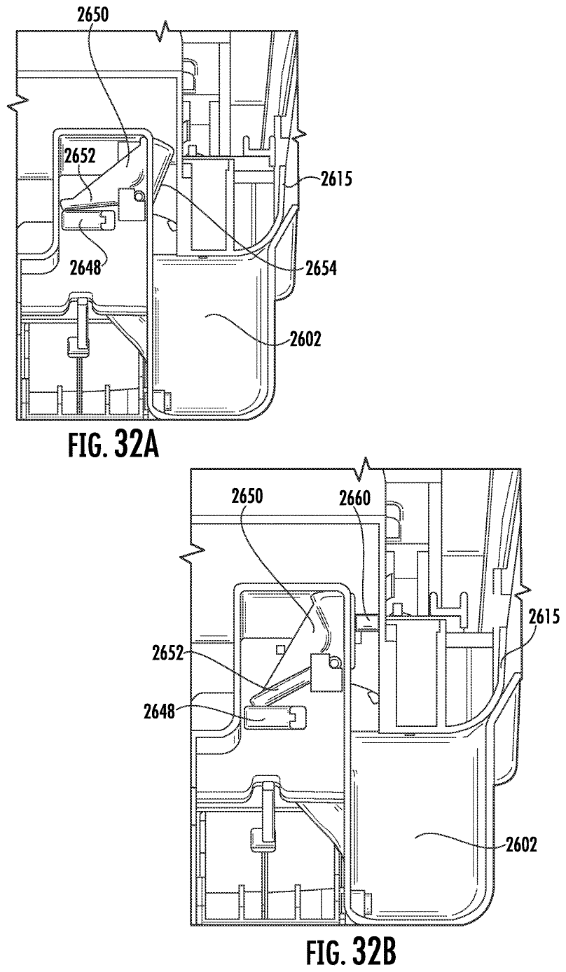

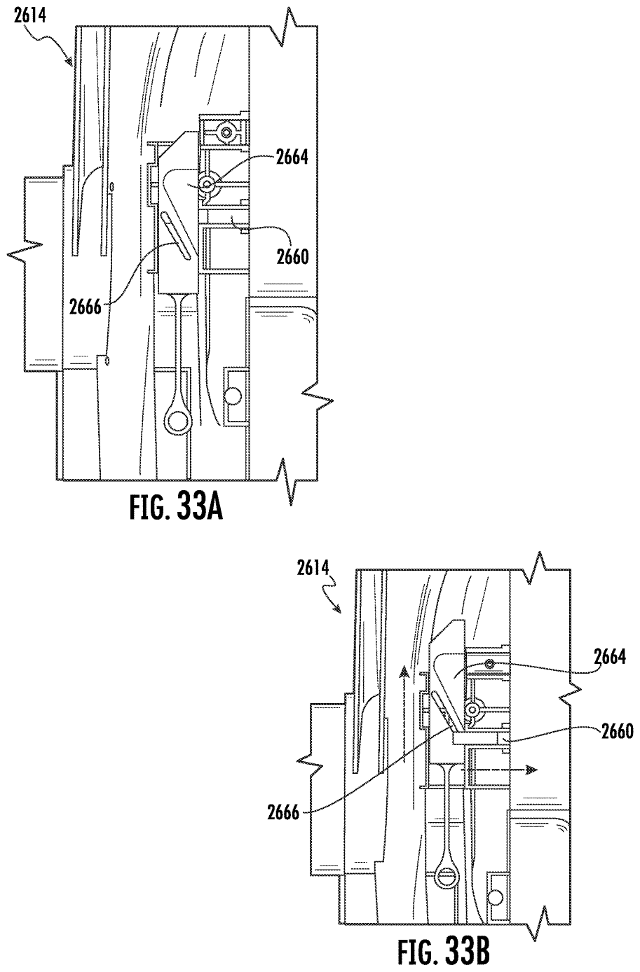

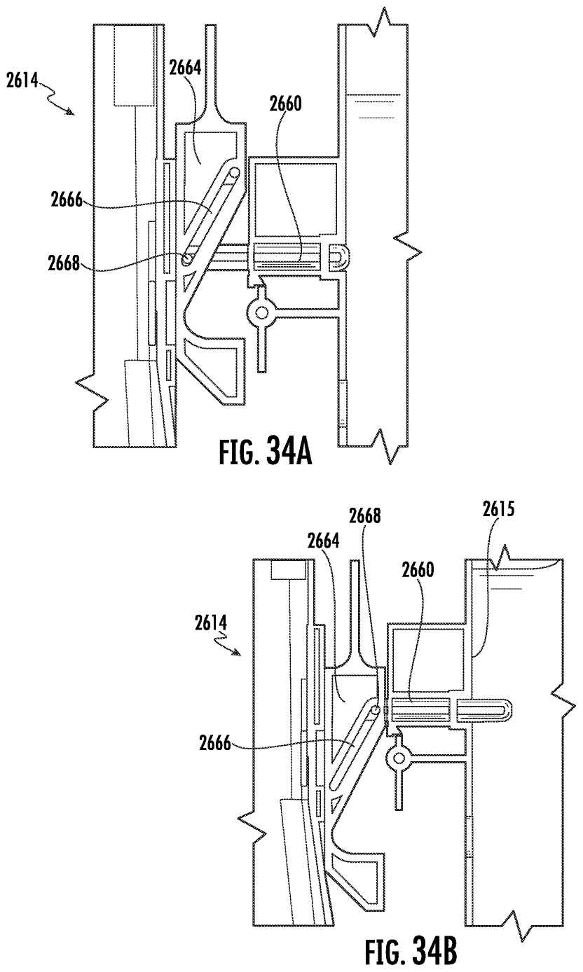

With reference to FIGS. 31A-31B, the infant car seat 2614 receivable on the base 2600 may include a driver 2660 movable to engage a portion of the infant car seat release assembly 2641, such as the actuation toggle 2650 for example, to unlock the base connector 2608 when the infant car seat 2614 is connected to the base 2600. As shown, the driver 2660 may be a pin or other component aligned with a corresponding opening 2662 formed in the seat shell 2615 of an infant car seat 2614. When the infant car seat 2614 is connected to the base 2600, the driver 2660 may be axially aligned with the engagement head 2654 of the actuation toggle 2650. The driver 2660 is movable relative to the seat shell between a stowed or retracted position (FIGS. 31A, 32A, 33A, 34A) and a deployed or extended position (FIGS. 31B, 32B, 33B, 34B). In the illustrated, non-limiting embodiment, the driver 2660 is movably mounted via a slider 2664 having a slot 2666 formed therein. As shown, the slot 2666 may be arranged at an angle relative to the opening 2662 and a boss 2668, such as a protrusion for example, extending from the driver 2660 is arranged within the slot 2666. When the driver 2660 is in the stowed position, the boss 2668 may be arranged adjacent to a first end of the slot 2666. When a force is applied to the driver 2660 causing the driver to move relative to the seat shell 2615, the boss 2668 will translate within the slot 2666 until contacting a second end thereof. Because of the angular configuration of the slot 2666, the movement of the slider 2664 in a first direction results in movement of the driver 2660 in a second direction, such as oriented substantially perpendicularly or normal to the first direction. Accordingly, when the boss 2668 is arranged in contact with the second end of the slot 2666, the driver 2660 protrudes through the opening 2662 formed in the seat shell 2615 to an exterior surface of the infant car seat 2614.

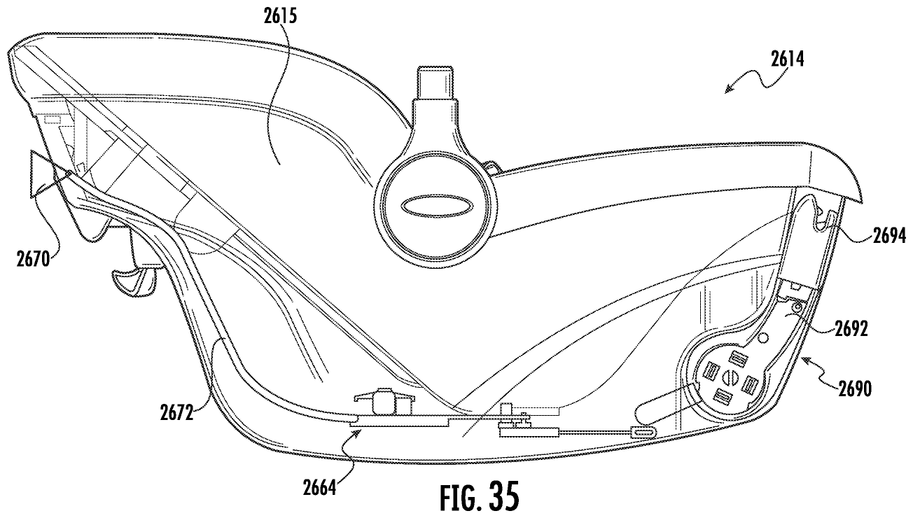

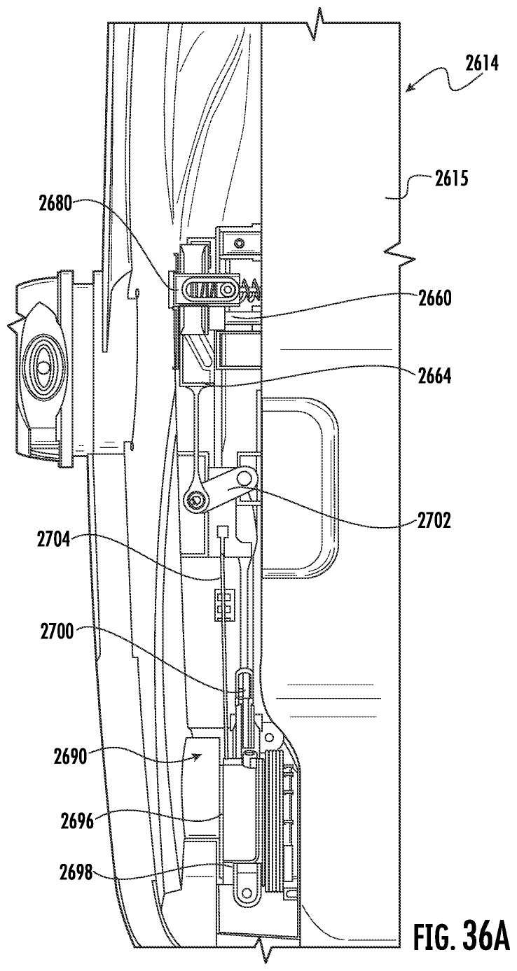

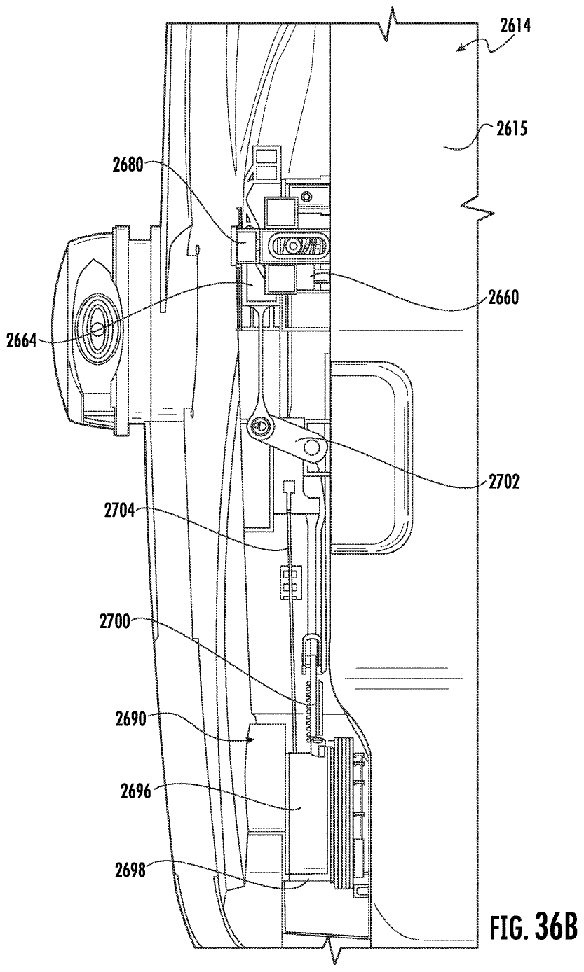

In an embodiment, the slider 2664 is operably coupled to a release actuator, illustrated schematically at 2670 (see FIG. 35) located at the infant car seat 2614. For example, the release actuator 2670 may be mounted at a seat back of the infant car seat 2614 and coupled to the slider 2664 via a connection member 2672. The connection member 2672 may include a wire, cable, strap, other flexible or semi-flexible element or may be configured as a fixed or rigid element, such as a rod, shaft, or the like. When the infant car seat 2614 is connected to the base 2600, a user may apply a force to the release actuator 2670, causing the slider 2664 to translate and the driver 2660 to move outwardly and into engagement with an adjacent engagement head 2654 of an actuation toggle 2650. As noted previously, this engagement will cause the actuation toggle 2650 to rotate the driving toggle 2642, resulting in rotation of the locking plate 2620 to the unlocked position. Once unlocked, a user can easily separate or disconnect the infant car seat 2614 from the seat retention assembly 2604 of the base 2600. Accordingly, the release actuator 2670 located at the infant car seat 2614 may provide an additional or alternative mechanism to the release actuator 2640 mounted to the base 2600 for unlocking the locking plates 2620 of the base connectors 2608.

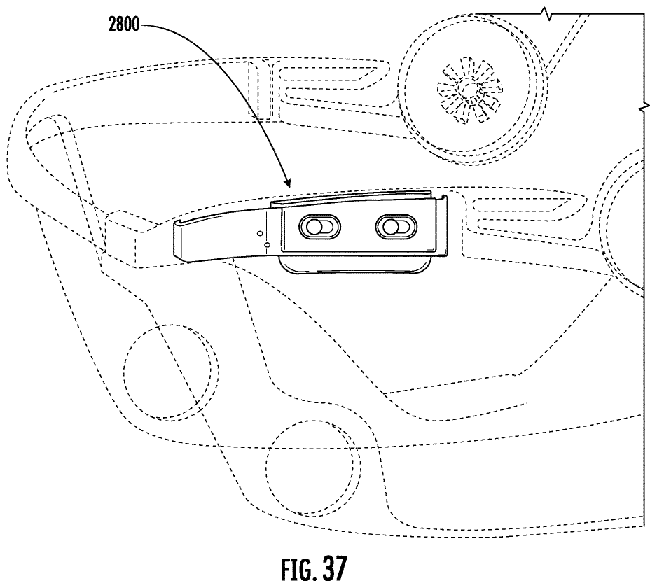

With reference now to FIGS. 36A and 36B, in an embodiment, the infant car seat 2614 additionally includes a stroller mechanism 2680, such as similar to that previously described relative to FIGS. 17A-17E. A portion of the stroller mechanism 2680 may be configured to extend from the seat shell 2615 (FIG. 36A) in a locked position and may be, in some configurations, selectively retracted into the seat shell 2615 (FIG. 36B) in an unlocked position. The stroller mechanism 2680 may be biased toward a locked or extended position in which a portion of the stroller mechanism 2680 protrudes from an outer surface of the seat shell 2615. When in the locked position, a portion of the stroller mechanism 2680 can engage with one or more features, such as a lip, rim, or other structure for example, of a stroller or other device, structure, system, or assembly, and thus hold the infant car seat 2614 in position relative to the stroller. To remove the infant car seat 2614 from the stroller, the stroller mechanism 2680 is retracted into the seat shell 2615, and thereby disengaged from the structure of the stroller. In an embodiment, the release actuator 2670 is operably coupled to the stroller mechanism. For example, the stroller mechanism 2680 may be movably mounted to the slider 2664 such that in response to operation of the release actuator 2670, movement of the slider 2664 causes the stroller mechanism to retract into the seat shell 2615.

With continued reference to FIGS. 36A and 36B, the infant car seat 2614 may in some embodiments additionally includes an anchor system operably coupled to the seat shell 2615. The anchor system 2690 may be similar to that shown and described with respect to FIGS. 21-25 with additional or alternative features and/or operation as described herein. For example, the anchor system 2690 includes at least one child seat anchor including a latch arm 2692 having a latch 2694 or connection end arranged at a distal end thereof. The latch 2694 may be configured to releasably connect or attach to a vehicle anchor system, such as described above. In an embodiment, the latch arm 2692 is coupled to a memory hub 2696 that is rotatable relative to a cartridge 2698 mounted to the seat shell 2615 between a first, retracted or stowed position and a second, extended or use position. The memory hub 2696 may be retained in the extended position against a biasing force acting thereon. In such embodiment, the release actuator 2670 may be operable to move a locking plate 2700 out of engagement with the memory hub 2696. This movement of the locking plate 2700 allows the memory hub 2696, and therefore the at least one latch arm 2692 operably coupled to the memory hub, to be automatically biased back to the stowed position. Accordingly, operation of the release actuator 2670 may be configured to automatically rotate the anchor system 2690 from an extended or use position to the retracted or stowed position.

In an embodiment, the slider 2664 is operably coupled to the locking plate 2700 of the anchor system 2690 via a linkage 2702, such as including a pivot arm for example. However, it should understand that any suitable interface for transferring the movement of the slider 2664 to the locking plate 2700 is within the scope of the disclosure. Further, in some embodiments, operation of the release actuator 2670 is also configured to release the latch 2694 from engagement with a vehicle anchor. In such embodiments, a secondary tension member 2704 may extend from the linkage 2702 to a component of the latch 2694 to transmit the movement of the linkage 2702 to the latch 2694. Accordingly, the release actuator 2670 associated with the infant car seat 2614 may be operable to release the infant car seat 2614 from the seat retention assembly 2604 of a base 2600, to release the infant car seat 2614 from a stroller, to open a latch connecting one or more anchors to a vehicle anchor, and/or to rotate the one or more anchors to a stowed position. Further, operation of the release actuator 2670 may be configured to perform each of these functions simultaneously, resulting in an enhanced ease of use by an operator.

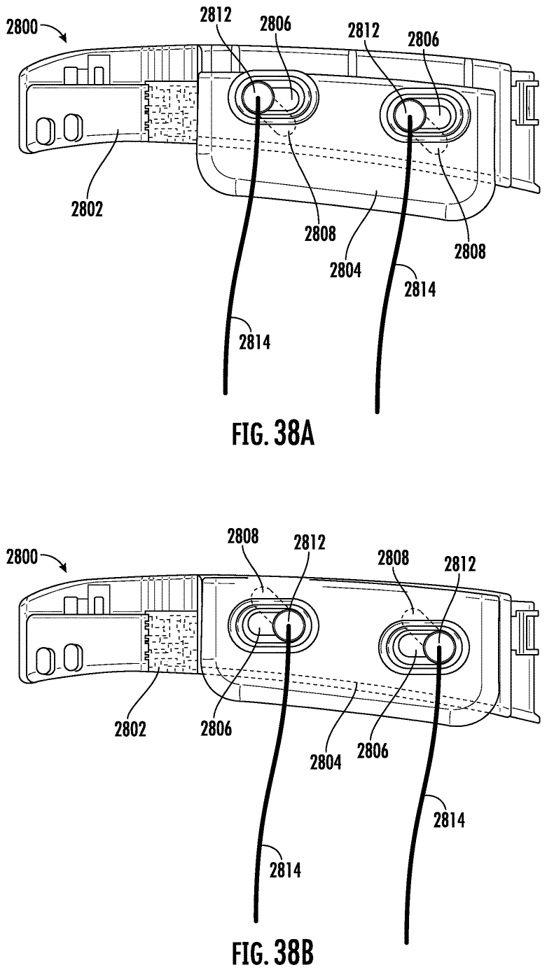

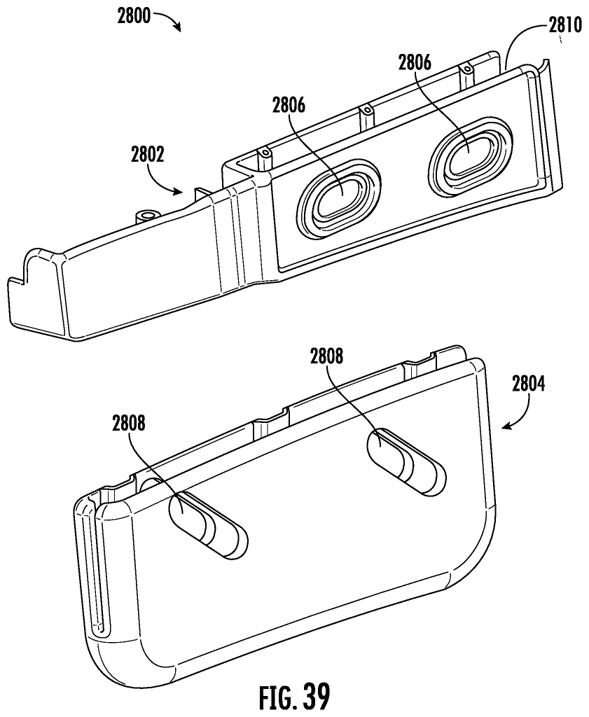

With reference now to FIGS. 37-39, an example of a recline actuator handle or mechanism 2800 integrated into an infant car seat, according to another aspect of this disclosure is illustrated. As shown, the recline actuator mechanism 2800 includes a housing 2802 and a corresponding actuator mechanism 2804. The housing 2802 may have at least one slot 2806 formed therein, and in some embodiments a plurality of slots. Although the housing 2802 is illustrated in the FIGS. as having two slots 2806, it should be appreciated that embodiments having a single slot and embodiments having more than two slots are also within the scope of the disclosure. In the illustrated, non-limiting embodiment, the plurality of slots 2806 are oriented substantially parallel to one another and are slightly offset from one another in one or more direction, such as along a horizontal axis for example.

The actuator 2804 of the recline actuator mechanism 2800 may also include one or more actuator slots 2808. In the illustrated, non-limiting embodiment, the actuator 2804 includes a plurality of actuator slots 2808, for example two actuator slots. However, embodiments having a single actuator slot and embodiments having more than two actuator slots are also within the scope of the disclosure. In an embodiment, the number of actuator slots 2808 formed in the actuator 2804 is equal to the number of slots 2806 formed in the housing 2802. The plurality of actuator slots 2808 may be oriented parallel to one another. Further, as shown, the actuator slots 2808 may be arranged at a non-parallel angle relative to the slots 2806 formed in the housing 2802.

The actuator 2804 may be positionable within an opening 2810 formed in the housing 2802. When the actuator 2804 is arranged within the opening 2810, at least a portion of an actuator slot 2808 is in overlapping arrangement with a corresponding slot 2806. In an embodiment, the actuator 2804 is slidable inside the opening 2810 relative to the housing 2802. As shown, a pin 2812 may extend through both a slot 2806 and a corresponding actuator slot 2808. Although the pins 2812 are illustrated as being generally connected to and extending from the housing 2802, embodiments where the one or more pins 2812 are generally connected to and extend from the actuator 2804 are also contemplated herein. By arranging the at least one actuator slot 2808 at an angle relative to the at least one slot 2806, the pin 2812 is configured to move within both the slot 2806 and the actuator slot 2808, simultaneously. When a user applies an upward force to the actuator 2804, the force in combination with the angle of the actuator slots 2808 causes the pins 2812 to translate within the slots 2806 in the housing 2802, such as from a first end thereof to a second end thereof for example. Cables 2814 may be connected to the pins 2812 such that as the pins 2812 move within the slots 2806 formed in the housing 2802, the pins 2812 apply a force to the cables 2814 connected thereto. As a result of this force, in an embodiment, the cables 2814 actuate a recline mechanism as previously described above. It should be understood that this recline actuator mechanism may be adapted to operate another suitable type of mechanism or system associated with an infant car seat as previously described, such as a latch or anchor system for example.

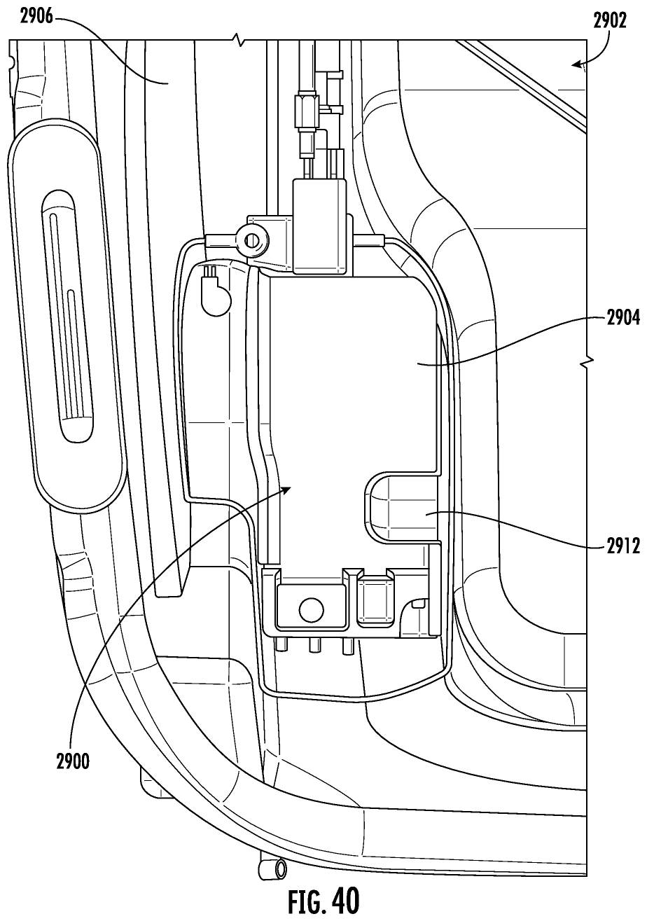

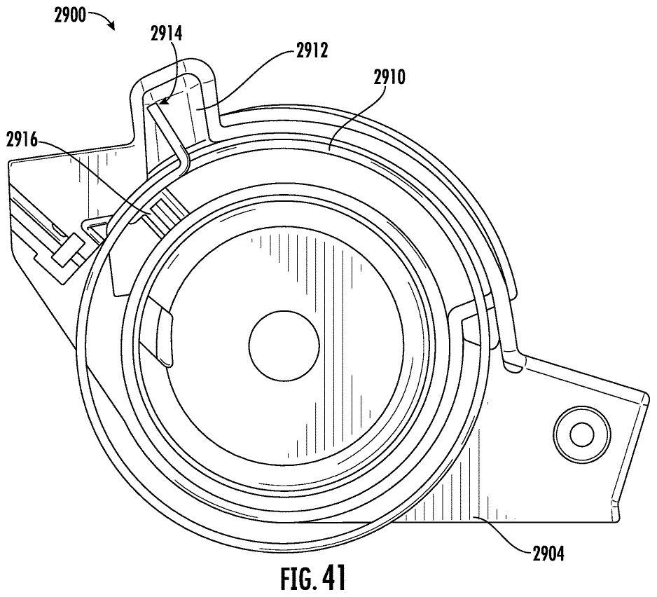

With reference now to FIGS. 40-42B, an example of a portion of an anchor system 2900 operable to automatically store a seat anchor relative to an infant car seat 2902, is illustrated. An anchor system 2900, such as previously described herein, may include a housing 2904, such as rigidly fixed to the seat shell 2906 of the infant car seat 2902 for example. In an embodiment, the housing 2904 has one or more walls that interact with the seat shell 2906 to prevent a recline and/or memory mechanism of the infant car seat 2902 from being exposed to contaminants or users.

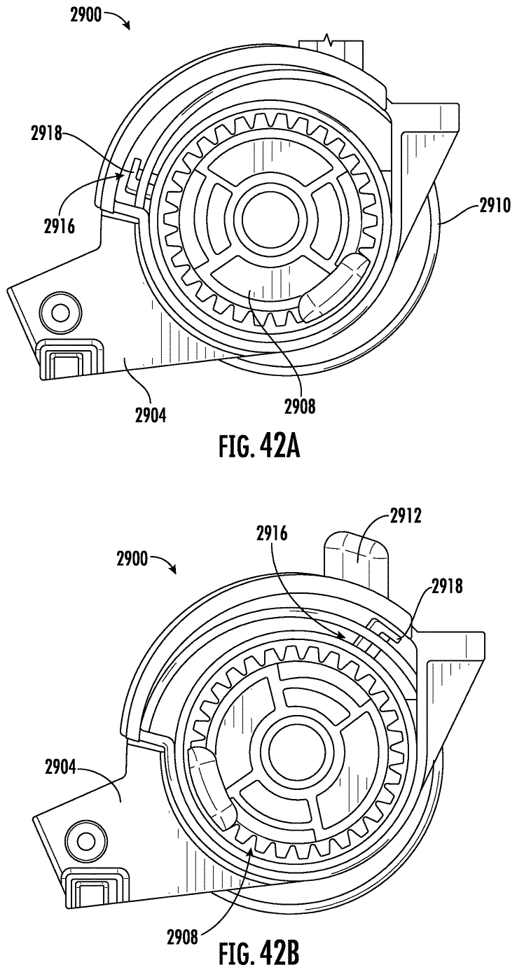

A memory hub 2908 positioned within the housing 2904 is rotatable between a first, stored position (FIG. 42A), and a second use position (FIG. 42B). In an embodiment, a biasing mechanism 2910, such as a spring for example, is operably coupled to the memory hub 2908. The spring 2910 may be positioned between the memory hub 2908 and the housing 2904, and the biasing force of the spring 2910 is operable to bias the memory hub 2908 toward the stored position. In an embodiment, a housing feature 2912 formed in the housing 2904 is operable to receive a first end or leg 2914 of the spring 2910 therein. The housing feature 2912 may be contoured to restrict movement of the first leg 2914 of the spring 2910 relative to the housing 2904. Accordingly, the first leg 2914 may be considered generally fixedly mounted relative to the housing 2904 via the housing feature 2912.

Alternatively, or in addition, the memory hub 2908 may include a hub feature 2916 operable to cooperate with or capture a portion of the spring 2910. In the illustrated, non-limiting embodiment, the hub feature 2916 includes a protrusion operable to capture and engage a second end or leg 2918 of the spring 2910. The hub feature 2916 may be fixedly or movably coupled to the second leg 2918. When a rotational force is applied to the memory hub 2908 in a first direction, toward a use position, the first leg 2914 of the spring 2910 remains at a fixed position via engagement with the housing feature 2912. However, the rotation of the memory hub 2908 toward the use position will apply a force to the second end 2918 of the spring 2910 opposing the biasing force thereof. As a result, the spring 2910 will compress, allowing rotation of the memory hub 2908 to the use position. When the force is removed from the memory hub 2908, the force opposing the bias of the spring 2910 is eliminated. As a result, the biasing force will act on the hub feature 2916, causing the memory hub 2901 to rotate in a second direction toward the stored position.

Advantageously, embodiments described herein provide for improved infant car seats having adjustable features, and particularly the ability to adjust and set an angle of incline/recline of the infant car seat relative to a vehicle seat. Rigid anchor system connections are provided on a seat shell and provide for a simple and strong connection between the infant car seat and the vehicle seat (e.g., as compared to a belt configuration). The rigid connection and/or integration of the anchor system into the seat shell also allows for presetting of an angle of inclination/recline of the infant car seat relative to the vehicle seat, and such angles may be set such that they do not need to be reset each time a caregiver uses the infant car seat in a vehicle. For example, various mechanisms, as described herein, may be used to provide for preset or set angles of inclination of the infant car seat relative to the vehicle seat, and such presetting or setting of the angle may be retained between uses. Such configurations may also provide additional securing by enabling pulling the infant car seat closer to a vehicle seat during installation and thus can ensure a snug fit and secure setting of the infant car seat within a vehicle. Other advantages and functionality are provided as shown and described herein.

The use of the terms “a”, “an”, “the”, and similar references in the context of description (especially in the context of the following claims) are to be construed to cover both the singular and the plural, unless otherwise indicated herein or specifically contradicted by context. The modifier “about” or “substantially” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. As used herein, the terms “about” and “substantially” are intended to include the degree of error associated with measurement of the particular quantity based upon the equipment available at the time of filing the application. For example, the terms may include a range of ±8% of a given value or other percentage change as will be appreciated by those of skill in the art for the particular measurement and/or dimensions referred to herein. When used with respect to non-numerical descriptions, these terms include variations relative to the absolute term as would be understood by those of skill in the art. For example, a substantially flat plane may have some deviations from purely flat with no such variances, as such a flat plane may not be physically achievable, and thus the terms substantially and about are used to refer to a description being that of what one of ordinary skill in the art would understand the term to mean.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

1. An infant car seat system for installation on a vehicle seat, comprising:
an infant car seat having a seat shell; and
an anchor system connected to the seat shell, the anchor system comprising:
a latch arm having a latch on an end thereof, the latch configured to releasably engage with a vehicle anchor system, wherein the latch arm is movably mounted to the seat shell and selectively fixable in two or more angles relative to the seat shell.

2. The infant car seat system of claim 1, wherein the latch arm is rotatably mounted to the seat shell.

3. The infant car seat system of claim 1, wherein the latch arm is configured to be locked at the two or more angles and to hold and support the infant car seat at a respective one of the two or more angles when locked at such respective one of the two or more angles.

4. The infant car seat system of claim 1, wherein the anchor system comprises:
a memory hub configured to set an angle of recline of the infant car seat based on each of the two or more angles, wherein the latch arm is operably coupled to the memory hub.

5. The infant car seat system of claim 4, wherein the anchor system comprises:
a latch arm hub, the latch arm extending from the latch arm hub;
a recline hub;
a recline gear; and
one or more ramp hubs,
wherein a hub shaft extends from the latch arm hub and through the recline hub, the recline gear, and the one or more ramp hubs, and defining a rotational axis therethrough.

6. The infant car seat system of claim 5, wherein the one or more ramp hubs comprises a first ramp hub and a second ramp hub, wherein rotation of the first ramp hub relative to the second ramp hub causes axial movement of the recline gear to selectively engage or disengage from the memory hub.

7. The infant car seat system of claim 6, wherein, in response to the recline gear being engaged with the recline hub and disengaged from the memory hub, the latch arm is free to rotate relative to the memory hub.

8. The infant car seat system of claim 6, wherein, in response to the recline gear being engaged with the recline hub and engaged with the memory hub, the latch arm is locked in rotational relationship with the memory hub.

9. The infant car seat system of claim 6, further comprising an incline switch arranged on the seat shell and operably coupled to the first ramp hub, wherein operation of the incline switch cases rotation of the first ramp hub and urge the second ramp hub axially along the hub shaft.

10. The infant car seat system of claim 4, further comprising a locking plate pivotably coupled to the seat shell and selectively operable to engage with the memory hub to lock the memory hub at one of the two or more angles.

11. The infant car seat system of claim 10, wherein the locking plate comprises a locking tooth and the memory hub comprises a first locking recess associated with a first angle of the two or more angles and a second locking recess associated with a second angle of the two or more angles, wherein the locking tooth is configured to selectively engage with the first locking recess and the second locking recess.

12. The infant car seat system of claim 11, further comprising a first release connector operably coupled to the locking plate and configured to selectively operate the locking plate.

13. The infant car seat system of claim 12, further comprising a second release connector operably coupled to the latch and configured to selectively operate the latch.

14. The infant car seat system of claim 1, further comprising:
a carry handle rotatably coupled to the seat shell by an attachment mechanism,
wherein the anchor system is operably coupled to the attachment mechanism, and
wherein rotation of the carry handle is configured to cause operation of the anchor system.

15. The infant car seat system of claim 14, wherein the anchor system comprises a handle linkage, a connecting linkage, and a locking linkage, wherein:
the handle linkage is coupled to the attachment mechanism at one end and the connecting linkage at an opposite end,
the connecting linkage is coupled between the handle linkage and the locking linkage,
the locking linkage is coupled to the latch arm, and
wherein rotation of the carry handle locks the latch arm in at least one of two or more angles.

16. The infant car seat system of claim 15, further comprising a rear linkage pivotably connected between the seat shell and a connection point between the connecting linkage and the locking linkage.

17. The infant car seat system of claim 15, wherein the locking linkage comprises a recline rack, the recline rack having a number of locking positions corresponding to the two or more angles.

18. The infant car seat system of claim 17, wherein a first locking position of the recline rack defines a maximum recline of the infant car seat and a second locking position of the recline rack defines an upright position of the infant car seat.

19. The infant car seat system of claim 15, further comprising a forward linkage pivotably connected between the seat shell and a connection point between the locking linkage and the latch arm.

20. The infant car seat system of claim 14, wherein in a carry position of the carry handle, the latch arm is free to be adjusted between the two or more angles, and in an anti-rebound position, the latch arm is pulled toward the seat shell and locked in position.

21. The infant car seat system of claim 1, wherein the anchor system defines a first locking position associated with a first angle of the two or more angles and defining a maximum recline of the infant car seat and a second locking position of the anchor system defines an upright position of the infant car seat.

22. The infant car seat system of claim 1, wherein at least a portion of the anchor system is housed within the seat shell.

23. The infant car seat system of claim 1, further comprising a recline actuation handle arranged on the seat shell, operably coupled to the anchor system, and configured to selectively release the latch arm to adjust an incline angle of the infant car seat.

24. The infant car seat system of claim 23, further comprising a recline actuation connector that operably connects the recline actuation handle to a portion of the anchor system.

25. The infant car seat system of claim 24, wherein the portion of the anchor system is a driving ramp hub.

26. The infant car seat system of claim 24, further comprising a connector element arranged to connect the recline actuation handle and the recline actuation connector.

27. The infant car seat system of claim 23, wherein the recline actuation handle comprises a stowing lock extension configured to selectively secure the latch arm in a stowed state.

28. The infant car seat system of claim 27, further comprising a stowing lock arranged between the stowing lock extension of the recline actuation handle and the latch arm, the stowing lock selectively operable to lock and release the latch arm from the stowed state.

29-121. (canceled)
